(19) United States
(12) Patent Application Publication
(10) Pub. No.: US 2025/0215257 A1
(43) Pub. Date: Jul. 3, 2025

(54) METHOD FOR FORMING MULTILAYER COATING FILM

(71) Applicant: KANSAI PAINT CO., LTD., Hyogo (JP)

(72) Inventor: Kenji Sakai, Hiratsuka-Shi (JP)

(21) Appl. No.: 18/833,721

(22) PCT Filed: Jan. 23, 2023
(86) PCT No.: PCT/JP2023/001926

§ 371 Date: Jul. 26, 2024

(30) Foreign Application Priority Data
Feb. 2, 2022 (JP) 2022-015253

(51) Int. Cl. C09D 175/04; C25D 13/12

(52) U.S. Cl. CPC C09D 175/04; C25D 13/12

(57) ABSTRACT

The purpose of the present invention is to provide a method for forming a multilayer coating film whereby it is possible to form a multilayer coating film that exhibits superior sag resistance, mirror finish, and luster. A first coating film of a first aqueous coating material (P1) capable of forming a coating film having a specific water swelling ratio, a second colored coating film of a second aqueous colored coating material (P2) that has a specific coating material solid component concentration (NV_{P2}) and contains a lustrous pigment (B_{P2}), and a clear-coat coating of a clear-coat coating material (P3) are formed on an object to be coated, and a multilayer coating film including the first coating film, the second colored coating film, and the clear-coat coating film is heated to cure the coating films simultaneously.

### TECHNICAL FIELD

The present invention relates to a method for forming a multilayer coating film, the method enabling the formation of a multilayer coating film having excellent dripping resistance, image clarity, and brightness.

### BACKGROUND ART

As a method for forming a coating film on an automobile body, a method of forming a multilayer coating film through a three-coating two-baking (3C2B) scheme is widely used, which includes applying an electrodeposition paint onto an object to be coated, then applying an intermediate coating paint thereon, baking and curing, applying a base paint, preheating, and then applying a clear coat paint thereon and baking and curing. However, in recent years, from the viewpoint of energy conservation, the process of baking and curing after application of the intermediate coating paint is omitted, and a three-coating one-baking (3C1B) scheme is being attempted in which the electrodeposition paint is applied onto the object to be coated, after which an intermediate coating paint is applied thereon, preheating is implemented, a base paint is then applied, preheating is again implemented, and then a clear coat paint is applied, and baking and curing are implemented.

Furthermore, multilayer coating films of light interference paint colors such as metallic paint colors, mica paint colors, and pearl paint colors are typically formed using, as top coating paints, a base paint that includes an effect pigment for providing a high level of brightness, and a transparent clear paint. Note that a coating film having high brightness generally has a significant change in lightness due to the angle of observation when the coating film is observed as the angle is changed, and further is a coating film in which the effect pigment is present relatively homogeneously in the coating film, and almost no metallic unevenness is observed. Furthermore, as described above, when the change in lightness due to the angle of observation is significant, the flip-flop property is generally high.

As effect pigments, ordinarily aluminum flake pigments with metallic luster are used in the case of metallic paint colors, and light interference pigments such as mica pigments coated with a metal oxide and aluminum oxide pigments coated with a metal oxide are used in the case of light interference paint colors. Ordinarily, multilayer coating films of these paint colors are formed by sequentially applying an effect pigment-containing base paint and a clear paint in a wet-on-wet manner onto an intermediate coating film that has been baked, and subsequently curing the resulting uncured coating film in a single baking process.

However, in a case in which a multilayer coating film of a metallic paint color or a light interference paint color is formed by wet-on-wet coating, the orientation of the effect pigment contained in the base paint becomes disordered, resulting in a problem of a decrease in brightness.

Also, in recent years, the use of water-based paints has been increasing from the viewpoint of reducing environmental burden. However, with water-based paints, the volatilization rate of water, which is the diluting solvent, is slow, and the volatilization rate is greatly impacted by the application environment conditions such as temperature and humidity. Therefore, in the case of wet-on-wet coating with a water-based paint, the orientation of the effect pigment is more easily disordered compared to a case in which an organic solvent-based paint is used, and as a result, the decrease in brightness becomes more pronounced.

Various methods have been proposed in the past to solve the above problems.

For example, Patent Document 1 and Patent Document 2 disclose methods for forming an effect coating film, the methods including applying a water-based first base effect paint onto an intermediate coating film to form an uncured first base coating film, applying a water-based second base effect paint onto the uncured first base coating film to form an uncured second base coating film, applying a clear paint onto the uncured second base coating film to form a clear coating film, and heating and curing the uncured first base coating film, second base coating film, and clear coating film all at once. These documents also describe that, in the methods described above, the paint solid content in the water-based first base effect paint and the water-based second base effect paint and the concentration of the effect pigment are adjusted, and thereby a metallic appearance free of brightness unevenness is exhibited with, for example, an aluminum flake pigment having metallic luster, and furthermore, an effect coating film that manifests an extremely high flip-flop property can be produced with, for example, a mica pigment having interference properties.

### CITATION LIST

### Patent Literature

Patent Document 1: JP 2004-351389 A
Patent Document 2: JP 2004-351390 A

### SUMMARY OF INVENTION

### Technical Problem

However, in a case in which an uncured first coating film is formed by applying a first water-based paint onto an object to be coated, and then a second colored water-based paint having a relatively low paint solid content is applied onto the uncured first coating film, problems occur including dripping in the formed multilayer coating film and the loss of image clarity. Among such methods, in the application of a base paint in the three-coating one-baking (3C1B) scheme, when two types of base paints including a water-based first base paint and a water-based second base paint are used, a first water-based paint is applied as the water-based first base paint to form an uncured first coating film, and then a second colored water-based paint having a relatively low paint solid content is applied as the water-based second base paint onto the uncured first coating film, problems occur, such as, in particular, dripping in the multilayer coating film that is formed and the loss of image clarity.

The present invention was developed in view of the above-described circumstances in the related art, and an object of the present invention is to provide a method for forming a multilayer coating film, the method adopting a scheme of simultaneously curing a multilayer coating film having three layers including a first coating film, a second colored coating film, and a clear coating film, and enabling the formation of a multilayer coating film with excellent dripping resistance, image clarity, and brightness.

In addition, in one aspect, the present invention provides a method for forming a multilayer coating film, the method adopting a scheme of simultaneously curing a multilayer coating film having four layers including an uncured intermediate coating film, a first coating film, a second colored coating film, and a clear coating film, and enabling the formation of a multilayer coating film with excellent dripping resistance, image clarity, and brightness.

### Solution to Problem

According to the present invention, a multilayer coating film formation method including the following aspects is provided.

### [Aspect 1]

A method for forming a multilayer coating film, the method including:
(1) applying a first water-based paint (P1) onto an object to be coated to form a first coating film having a cured film thickness (T_{P1}) in a range from 5 to 20 μm;
(2) applying a second water-based colored paint (P2) onto the first coating film formed in (1) to form a second colored coating film having a cured film thickness (T_{P2}) in a range from 0.5 to 7 μm, the second water-based colored paint (P2) including a binder component (A_{P2}) and an effect pigment (B_{P2}) and having a paint solid content concentration (NV_{P2}) in a range greater than or equal to 1 mass % and less than 20 mass %;
(3) applying a clear coat paint (P3) onto the second colored coating film formed in (2) to form a clear coating film; and
(4) heating a multilayer coating film including the first coating film formed in (1), the second colored coating film formed in (2), and the clear coating film formed in (3), and thereby simultaneously curing the multilayer coating film;
wherein
a water swelling percentage at a cured film thickness of 20 m of a coating film formed from the first water-based paint (P1) is less than or equal to 100%.

### [Aspect 2]

The method for forming the multilayer coating film according to aspect 1, wherein the object to be coated is a steel sheet on which a cured electrodeposited coating film is formed, on which an intermediate coating paint is applied to form an intermediate coating film.

### [Aspect 3]

The method for forming the multilayer coating film according to aspect 2, wherein the intermediate coating paint is a water-based paint.

### [Aspect 4]

The method for forming the multilayer coating film according to aspect 2 or 3, wherein a cured film thickness of the intermediate coating paint is in a range from 10 to 40 μm.

### [Aspect 5]

The method for forming the multilayer coating film according to any one of aspects 1 to 4, wherein the first water-based paint (P1) contains a hydroxyl group-containing acrylic resin (A), a crosslinking agent (B), and acrylic-urethane composite resin particles (C).

### [Aspect 6]

The method for forming the multilayer coating film according to aspect 5, wherein the hydroxyl group-containing acrylic resin (A) contains a water-dispersible hydroxyl group-containing acrylic resin (A1).

### [Aspect 7]

The method for forming the multilayer coating film according to aspect 6, wherein the water-dispersible hydroxyl group-containing acrylic resin (A1) contains a water-dispersible hydroxyl group-containing acrylic resin (A1′) having an acid value less than or equal to 20 mg KOH/g.

### [Aspect 8]

The method for forming the multilayer coating film according to any one of aspects 5 to 7, wherein an acrylic resin component of the acrylic-urethane composite resin particles (C) has an acid value less than or equal to 20 mg KOH/g.

### [Aspect 9]

The method for forming the multilayer coating film according to any one of aspects 5 to 8, wherein a polyisocyanate compound component contained in a urethane resin component of the acrylic-urethane composite resin particles (C) includes, as at least one type of the polyisocyanate compound component, an aliphatic polyisocyanate compound (c1-1).

### [Aspect 10]

The method for forming the multilayer coating film according to any one of aspects 5 to 9, wherein a monomer component contained in an acrylic resin component of the acrylic-urethane composite resin particles (C) includes, as at least one type of the monomer component, a polymerizable unsaturated monomer (c2-1) having one polymerizable unsaturated group per molecule and an alkyl group having from 4 to 22 carbons.

### [Aspect 11]

The method for forming the multilayer coating film according to any one of aspects 5 to 10, wherein a monomer component contained in an acrylic resin component of the acrylic-urethane composite resin particles (C) includes, as at least one type of the monomer component, a polymerizable unsaturated monomer (c2-2) having two or more polymerizable unsaturated groups per molecule.

### [Aspect 12]

The method for forming the multilayer coating film according to any one of aspects 1 to 11, wherein a content proportion of the binder component (A_{P2}) and the effect pigment (B_{P2}) in the second water-based colored paint (P2) is such that a content of the effect pigment (B_{P2}) is in a range from 5 to 550 parts by mass per 100 parts by mass of a solid content of the binder component (A_{P2}).

### [Aspect 13]

The method for forming the multilayer coating film according to any one of aspects 1 to 12, wherein a content proportion of the effect pigment (B_{P2}) in the second water-based colored paint (P2) is in a range from 4 to 85 mass % based on a paint solid content in the second water-based colored paint (P2).

### Advantageous Effects of Invention

According to the present invention, a method can be adopted in which a multilayer coating film containing three layers including a first coating film, a second colored coating film, and a clear coating film are simultaneously cured, and a multilayer coating film having excellent dripping resistance, image clarity, and brightness can be formed even when a water-based paint is used.

### DESCRIPTION OF EMBODIMENTS

The present invention is described in detail below through embodiments, but these embodiments are merely examples of preferred embodiments, and the present invention is not limited by the content of these embodiments.

### Object to be Coated

The object to be coated and to which the method for forming a multilayer coating film of the present invention is applied is not particularly limited. Examples of the object to be coated include outer panel parts of automobile bodies, such as those of passenger cars, trucks, motorcycles, and buses; automobile parts such as bumpers; outer panel parts of home electrical appliances, such as mobile phones and audio devices. Of these, outer panel parts of automobile bodies and automobile parts are preferable, and outer panel parts of automobile bodies are particularly preferable.

Materials of these objects to be coated are not particularly limited. Examples thereof include: metal materials, such as iron, aluminum, brass, copper, tin plates, stainless steel, galvanized steel, and zinc alloy (such as Zn—Al, Zn—Ni, and Zn—Fe)-plated steel; resins, such as polyethylene resins, polypropylene resins, acrylonitrile-butadiene-styrene (ABS) resins, polyamide resins, acrylic resins, vinylidene chloride resins, polycarbonate resins, polyurethane resins, and epoxy resins; mixtures of these resins; resin materials, such as various fiber-reinforced plastics (FRPs); inorganic materials, such as glass, cement, and concrete; wood materials; and fiber materials, such as paper and cloth. Of these, metal materials and resin materials are preferred. Moreover, the object to be coated may be a combination of a metal material and a resin material described above.

The object to be coated may be one that is produced by subjecting an abovementioned metal material or a metal surface of an automobile body formed from the metal material to a surface treatment such as a phosphate treatment, a chromate treatment, or a composite oxide treatment, and may be one that further includes a coating film formed thereon. In addition, the object to be coated may be one having a coating film formed on a resin material described above or on a resin surface of an automobile part or the like molded from the resin material.

Examples of the object to be coated on which a coating film is formed include an object produced by surface treating a substrate as necessary and then forming an undercoat film thereon. The undercoat film is usually formed for the purpose of imparting properties such as corrosion resistance, adhesion to the substrate, and a property of concealing irregularities on the substrate surface (sometimes referred to as a “base concealing property”). As the undercoat paint used for forming the undercoat film, those known as undercoat paints may be used.

As such an object to be coated, for example, an object to be coated that is produced by applying an electrodeposition paint onto a steel sheet as a substrate and then heating and curing to form a cured electrodeposited coating film may be used. Rust and corrosion on the steel sheet can be suppressed by coating the surface of the steel sheet serving as a base material with the electrodeposition paint. Therefore, an object to be coated that is produced by applying an electrodeposition paint onto a steel sheet serving as a substrate and then heating and curing to form a cured electrodeposited coating film is preferably used as the object to be coated.

Formation of Cured Electrodeposited Coating Film Examples of the steel sheet used as the base material include cold-rolled steel sheets, alloyed hot-dip galvanized steel sheets, electro-galvanized steel sheets, zinc-iron two-layer electro-plated steel sheets, organic composite plated steel sheets, Al materials, and Mg materials. As necessary, the surfaces of these metal sheets may be cleaned through alkaline degreasing or the like and then subjected to a surface treatment such as phosphate chemical treatment, a chromate treatment, or a composite oxide treatment.

The electrodeposition paint used in this step of forming an electrodeposited coating film is preferably a thermosetting water-based paint that is commonly used in the relevant field, and a cationic electrodeposition paint or anionic electrodeposition paint may be used. The electrodeposition paint is preferably a water-based paint containing a base resin and a crosslinking agent, and an aqueous medium including water and/or a hydrophilic organic solvent.

From the viewpoint of rust resistance, for example, an epoxy resin, an acrylic resin, a polyester resin, or the like is preferably used as the base resin. Of these, from the viewpoint of rust resistance, a resin having an aromatic ring is preferably used as at least one type of the base resin, and of such resins, an epoxy resin having an aromatic ring is preferably used. Also, for example, a blocked polyisocyanate compound, an amino resin, or the like is preferably used as the crosslinking agent. Here, examples of the hydrophilic organic solvent include methanol, ethanol, n-propyl alcohol, isopropyl alcohol, and ethylene glycol. A coating film having high rust resistance can be formed by applying the electrodeposition paint.

In this step, for applying the electrodeposition paint onto the steel sheet, an electrodeposition coating method that is commonly used in the relevant field may be used. According to this application method, a coating film having high rust resistance can be formed across substantially the entire surface of the object to be coated, even with an object that has been subjected to a molding process in advance.

In order to prevent the generation of a mixed layer between the electrodeposited coating film formed in this step and a coating film formed thereon and to improve the coated appearance of the resulting multilayer coating film, the thermosetting electrodeposition paint is applied, and then the uncured coating film is baked and cured by heating. Note that in the present specification, a “cured electrodeposited coating film” means a coating film produced by heating and curing the electrodeposited coating film formed on the steel sheet.

In general, when the baking treatment is implemented at a temperature higher than 190° C., the coating film becomes too hard and brittle, and conversely, when the baking treatment is implemented at a temperature lower than 110° C., the reaction of the above components is insufficient, neither of which is preferable. Therefore, in this step, the temperature of the baking treatment of the uncured electrodeposited coating film is generally in a range from 110 to 190° C., and particularly preferably in a range from 120 to 180° C. Furthermore, usually, the baking treatment time is preferably from 10 to 60 minutes. A cured electrodeposited coating film can be produced in a dry state by implementing the baking treatment under the conditions described above.

Furthermore, the dry film thickness of the cured electrodeposited coating film after the baking treatment under the conditions described above is usually preferably in a range from 5 to 40 μm and particularly preferably in a range from 10 to 30 μm.

Rust resistance of the coated steel sheet can be improved by forming the electrodeposited coating film in the manner described above.

As the object to be coated and to which the present invention is applied, an object on which an intermediate coating film is formed by further applying an intermediate coating paint onto a cured electrodeposited coating film formed in the electrodeposited coating film forming step described above may be used. By further forming an intermediate coating paint on the cured electrodeposited coating film, a multilayer coating film excelling in impact resistance, smoothness, and the like can be formed. For this reason, it is preferable to use an object to be coated in which an intermediate coating film is further formed on the cured electrodeposited coating film.

### Formation of Intermediate Coating Film

As the intermediate coating paint, a paint containing a binder component and a coloring pigment may be used. As the binder component used in the intermediate coating paint, a coating film-forming resin composition commonly used in an intermediate coating paint may be used. Examples of such resin compositions include resin compositions in which a crosslinking agent is used in combination with a base resin having a crosslinkable functional group such as a hydroxyl group. Examples of the base resin include an acrylic resin, a polyester resin, an alkyd resin, and a urethane resin. Examples of the crosslinking agent include amino resins such as melamine resin and urea resin, or polyisocyanate compounds (including a blocked polyisocyanate compound). A ratio of the base resin and the crosslinking agent in the resin composition is not particularly limited, but the crosslinking agent can usually be used in a range from 10 to 100 mass %, preferably from 20 to 80 mass %, and more preferably from 30 to 60 mass % relative to the total amount of the base resin solid content. The base resin and the crosslinking agent may be used by being dissolved or dispersed in a solvent such as an organic solvent and/or water.

The coloring pigment used in the intermediate coating paint is not particularly limited, and among known coloring pigments, one type may be used alone, or two or more types may be used in combination. Specific examples of the coloring pigments that may be used include composite metal oxide pigments, such as a titanium dioxide pigment, an iron oxide pigment, and titanium yellow, azo-based pigments, quinacridone-based pigments, diketopyrrolopyrrole-based pigments, perylene-based pigments, perinone-based pigments, benzimidazolone-based pigments, isoindoline-based pigments, isoindolinone-based pigments, azo metal chelate-based pigments, phthalocyanine-based pigments, indanthrone-based pigments, dioxane-based pigments, threne-based pigments, indigo-based pigments, and carbon black pigments. From the viewpoint of properties such as the weather resistance of the formed multilayer coating film, a titanium dioxide pigment or a carbon black pigment is preferably used as at least one of the coloring pigments used in the intermediate coating paint.

The content of the coloring pigment in the intermediate coating paint is preferably in a range from 0.01 to 150 parts by mass, more preferably in a range from 0.02 to 140 parts by mass, and particularly preferably in a range from 0.03 to 130 parts by mass, per 100 parts by mass of the total solid content of the binder component in the intermediate coating paint.

In a case in which the intermediate coating paint contains the titanium dioxide pigment described above, the content of the titanium dioxide pigment is preferably in a range from 5 to 150 parts by mass, more preferably in a range from 6 to 140 parts by mass, and particularly preferably in a range from 7 to 130 parts by mass, per 100 parts by mass of the total solid content of the binder component in the intermediate coating paint.

In a case in which the intermediate coating paint contains the carbon black pigment described above, the content of the carbon black pigment is preferably in a range from 0.01 to 3 parts by mass, more preferably in a range from 0.02 to 2.5 parts by mass, and particularly preferably in a range from 0.03 to 2.0 parts by mass, per 100 parts by mass of the total solid content of the binder component in the intermediate coating paint.

As necessary, a solvent such as water or an organic solvent, various additives such as a pigment dispersing agent, a curing catalyst, a defoaming agent, an antioxidant, a UV absorber, a light stabilizer, a thickener, and a surface conditioner, effect pigments such as an aluminum pigment, and extender pigments such as barium sulfate, barium carbonate, calcium carbonate, talc, and silica can be appropriately compounded in the intermediate coating paint.

The intermediate coating paint may be a water-based paint or an organic solvent-based paint, but from the viewpoint of reducing VOCs, the intermediate coating paint is preferably a water-based paint. Here, a water-based paint is a term that is used in contrast with an organic solvent-based paint, and ordinarily means a paint in which a binder component, a pigment, and the like are dispersed and/or dissolved in water or a medium (aqueous medium) containing water as a main component. In a case in which the intermediate coating paint is a water-based paint, the content of water in the intermediate coating paint is preferably approximately 20 to 80 mass %, and more preferably approximately 30 to 60 mass %.

The intermediate coating paint can be prepared by mixing and dispersing the aforementioned components. A paint solid content concentration (NV) of the intermediate coating paint is preferably adjusted to a range from 30 to 60 mass %, and more preferably a range from 40 to 55 mass %.

The intermediate coating paint can be adjusted to an appropriate viscosity for application by adding water, an organic solvent, or the like, and then applied, as necessary, by a known method such as rotary atomization coating, air spraying, and airless spraying. From viewpoints such as the dripping resistance and image clarity of the coating film, the intermediate coating paint is applied such that on the basis of the cured film thickness, the film thickness is in a range preferably from 10 to 40 μm, more preferably from 15 to 35 μm, and even more preferably from 20 to 30 μm.

The L* value of the lightness of the intermediate coating paint in the L*a*b* color system in a case in which a cured coating film having a thickness of 30 μm is formed is not particularly limited, but is usually from 1 to 95. In this range, the viewpoint of flip-flop properties of the multilayer coating film that is formed, the L* value of the lightness of the intermediate coating paint in the L*a*b* color system when a cured coating film having a thickness of 30 μm is formed is preferably from 1 to 90, more preferably from 2 to 85, and even more preferably from 3 to 80.

The L*a*b* color system is a color system that was standardized by the International Commission on Illumination (CIE) in 1976, and was adopted in Japan as well in JIS Z 8784-1. In the L*a*b* color system, the lightness is expressed as L*, and the chromaticity, which indicates hue and chroma, is expressed as a* and b*. A positive value of a* indicates a red direction (whereas a negative value of a* indicates a green direction), and a positive value of b* indicates a yellow direction (whereas a negative value of b* indicates a blue direction). In the present specification, L*, a* and b* are defined as numerical values calculated from the spectral reflectance of light received at 90 degrees in relation to the surface of the coating film when light irradiates the coating film at 45 degrees in relation to a vertical axis of the coating film, the spectral reflectance being measured using the CM-512m3 multi-angle spectrophotometer (trade name, available from Konica Minolta, Inc.).

In a case in which an object to be coated has an intermediate coating film formed thereon and is used as the object to be coated, the intermediate coating film may be heated and cured prior to formation of the first coating film in the next step, or may be subjected as is in the uncured state to formation of the first coating film, which is the next step (1), and then in a below-described (4), the first coating film formed in (1), the second colored coating film formed in (2), and the clear coating film formed in (3) may be heated and cured together. Of these options, from viewpoints such as reducing energy usage, preferably the intermediate coating film is left uncured and subjected to the formation of the first coating film in the next step (1), after which the first coating film formed in (1), the second colored coating film formed in (2), and the clear coating film formed in (3) are heated and cured together in (4) described below. In addition, as necessary, before the formation of the first coating film in the next step (1), the resulting uncured intermediate coating film may be dried to an extent of being substantially not cured by preheating, air blowing or the like, or the solid content percentage may be adjusted to such an extent that the uncured intermediate coating film is not dried. The preheating can be implemented by a known heating apparatus, and for example, a drying furnace, such as a hot air furnace, an electric furnace, or an infrared induction heating furnace, may be used.

The preheating can ordinarily be implemented by directly or indirectly heating the object coated with the intermediate coating paint in a drying furnace at a temperature of from 40 to 100° C., preferably from 50 to 90° C., and more preferably from 60 to 80° C. for 30 seconds to 20 minutes, preferably from 1 to 15 minutes, and more preferably from 2 to 10 minutes. In addition, the air blowing can be normally implemented by blowing air of room temperature or heated to a temperature of from approximately 25° C. to approximately 80° C. onto the coated surface of the coated object for 30 seconds to 15 minutes.

In the present invention, a cured coating film refers to a coating film in a “cured and dried” state as defined in JIS K 5600-1-1:1999, that is, a state in which when the center of a coating surface is strongly held between the thumb and the index finger, no indentation is formed on the coating surface by fingerprints, and no movement of the coating film is felt, and when the center of the coating surface is rapidly and repeatedly rubbed with a fingertip, no scratch marks are formed on the coating surface. On the other hand, an uncured coating film is a coating film in a state in which the coating film has not reached the above-mentioned cured and dried state, and includes a coating film in a dry to the touch state and a semi-cured dry state as defined in JIS K 5600-1-1:1999.

In a case in which a coated object on which an uncured intermediate coating film is formed is used as the object to be coated, the uncured intermediate coating film is preferably subjected to the preheating between the above-described intermediate coating film formation step and step (1) from viewpoints such as dripping resistance, image clarity, and brightness of the multilayer coating film that is formed. Meanwhile, from viewpoints such as reducing energy usage and shortening the application line, the uncured intermediate coating film is preferably not subjected to preheating between the above-described intermediate coating film formation step and step (1). A merit of the method for forming a multilayer coating film of the present invention is the ability to form a multilayer coating film excelling in dripping resistance, image clarity, and brightness even when the preheating is not implemented between the intermediate coating film formation step and step (1).

### Formation of First Coating Film

In step (1), a first water-based paint (P1) that is a water-based paint is applied onto the object to be coated, and a first coating film having a cured film thickness (T_{P1}) in a range from 5 to 20 μm is formed. Here, the first water-based paint (P1) is a water-based paint containing a binder component.

As the binder component used in the first water-based paint (P1), a resin composition containing a coating film-forming resin commonly used in paints may be used. As such a resin composition, a thermosetting resin composition can be suitably used, and specifically, for example, a thermosetting resin composition in which a base resin having a crosslinkable functional group such as a hydroxyl group is used in combination with a crosslinking agent may be used. Examples of the base resin having a crosslinkable functional group include an acrylic resin, a polyester resin, an alkyd resin, and a urethane resin, and examples of the crosslinking agent include a melamine resin, a urea resin, and a polyisocyanate compound (including a blocked polyisocyanate compound).

Of these, from viewpoints such as the dripping resistance, image clarity, and brightness of the multilayer coating film that is formed, the base resin preferably contains, as at least one type of the base resin, a hydroxyl group-containing acrylic resin (A).

### Hydroxyl Group-Containing Acrylic Resin (A)

The hydroxyl group-containing acrylic resin (A) is an acrylic resin having at least one hydroxyl group per molecule. The hydroxyl group-containing acrylic resin (A) can typically be produced by copolymerizing a hydroxyl group-containing polymerizable unsaturated monomer (a) and another polymerizable unsaturated monomer (b) that is copolymerizable with the hydroxyl group-containing polymerizable unsaturated monomer (a) by a known method, such as solution polymerization in an organic solvent or emulsion polymerization in an aqueous medium.

The hydroxyl group-containing polymerizable unsaturated monomer (a) is a compound having at least one hydroxyl group and at least one polymerizable unsaturated group per molecule, and examples thereof include monoesterified products of a dihydric alcohol having from 2 to 8 carbons and a (meth)acrylic acid, such as 2-hydroxyethyl (meth)acrylate, 2-hydroxypropyl (meth)acrylate, 3-hydroxypropyl (meth)acrylate, and 4-hydroxybutyl (meth)acrylate; ε-caprolactone modified products of these monoesterified products; N-hydroxymethyl (meth)acrylamides; allyl alcohols; and (meth)acrylates having a polyoxyethylene chain with a hydroxyl group at the molecular terminal.

However, in the present invention, the monomer corresponding to (xvii) a polymerizable unsaturated monomer having a UV absorbing functional group described below should be defined as the “another polymerizable unsaturated monomer (b) that is copolymerizable with the hydroxyl group-containing polymerizable unsaturated monomer (a)” and is excluded from the “hydroxyl group-containing polymerizable unsaturated monomer (a)”. For the hydroxyl group-containing polymerizable unsaturated monomer (a), one type may be used alone or two or more types may be used in combination.

In the present specification, a polymerizable unsaturated group means an unsaturated group that is radically polymerizable. Examples of such polymerizable unsaturated groups include a vinyl group, a (meth)acryloyl group, a (meth)acrylamide group, a vinyl ether group, an allyl group, a propenyl group, an isopropenyl group, and a maleimide group.

Note that in the present specification, “(meth)acrylate” means an acrylate or a methacrylate, and “(meth)acrylic acid” means acrylic acid or methacrylic acid. Also, “(meth)acryloyl” means acryloyl or methacryloyl. Furthermore, “(meth)acrylamide” means acrylamide or methacrylamide.

The another polymerizable unsaturated monomer (b) that is copolymerizable with the hydroxyl group-containing polymerizable unsaturated monomer (a) can be appropriately selected and used according to the desired properties of the hydroxyl group-containing acrylic resin (A). Specific examples of the monomer (b) include those described in (i) to (xix) below. One of these may be used alone, or two or more types may be used in combination.
(i) Alkyl or cycloalkyl (meth)acrylates: for example, methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-hexyl (meth)acrylate, n-octyl (meth)acrylate, 2-ethylhexyl (meth)acrylate, nonyl (meth)acrylate, dodecyl (meth)acrylate, tridecyl (meth)acrylate, stearyl (meth)acrylate, isostearyl (meth)acrylate (product name, available from Osaka Organic Chemical Industry, Ltd.), cyclohexyl (meth)acrylate, methylcyclohexyl (meth)acrylate, tert-butylcyclohexyl (meth)acrylate, cyclododecyl (meth)acrylate, and tricyclodecanyl (meth)acrylate.
(ii) Polymerizable unsaturated monomers having an isobornyl group: for example, isobornyl (meth)acrylate.
(iii) Polymerizable unsaturated monomers having an adamantyl group: for example, adamantyl (meth)acrylate.
(iv) Polymerizable unsaturated monomers having a tricyclodecenyl group: for example, tricyclodecenyl (meth)acrylate.
(v) Aromatic ring-containing polymerizable unsaturated monomers: for example, benzyl (meth)acrylate, styrene, α-methylstyrene, and vinyltoluene.
(vi) Polymerizable unsaturated monomers having an alkoxysilyl group: for example, vinyltrimethoxysilane, vinyltriethoxysilane, vinyltris(2-methoxyethoxy)silane, γ-(meth)acryloyloxypropyltrimethoxysilane, and γ-(meth)acryloyloxypropyltriethoxysilane.
(vii) Polymerizable unsaturated monomers having a fluorinated alkyl group: for example, perfluoroalkyl (meth)acrylates such as perfluorobutylethyl (meth)acrylate and perfluorooctylethyl (meth)acrylate; and fluoroolefins.
(viii) Polymerizable unsaturated monomers having a photopolymerizable functional group such as a maleimide group.
(ix) Vinyl compounds: for example, N-vinylpyrrolidone, ethylene, butadiene, chloroprene, vinyl propionate, and vinyl acetate.
(x) Carboxyl group-containing polymerizable unsaturated monomers: such as (meth)acrylic acid, maleic acid, crotonic acid, and β-carboxyethyl acrylate.
(xi) Nitrogen-containing polymerizable unsaturated monomers: for example, (meth)acrylonitrile, (meth)acrylamide, N,N-dimethylaminoethyl (meth)acrylate, N,N-diethylaminoethyl (meth)acrylate, N,N-dimethylaminopropyl (meth)acrylamide, methylene bis(meth)acrylamide, ethylene bis(meth)acrylamide, 2-(methacryloyloxy) ethyltrimethyl ammonium chloride, and adducts of glycidyl (meth)acrylate and amines.
(xii) Polymerizable unsaturated monomers having two or more polymerizable unsaturated groups per molecule: for example, allyl (meth)acrylate, ethylene glycol di(meth)acrylate, 1,4-butanediol di(meth)acrylate, neopentyl glycol di(meth)acrylate, and 1,6-hexanediol di(meth)acrylate.
(xiii) Epoxy group-containing polymerizable unsaturated monomers: for example, glycidyl (meth)acrylate, β-methylglycidyl (meth)acrylate, 3,4-epoxycyclohexyl methyl(meth)acrylate, 3,4-epoxycyclohexyl ethyl(meth)acrylate, 3,4-epoxycyclohexylpropyl (meth)acrylate, and allyl glycidyl ether.
(xiv) (Meth)acrylates having a polyoxyethylene chain with an alkoxy group at the molecular terminal.
(xv) Polymerizable unsaturated monomers having a sulfonic acid group: for example, 2-acrylamido-2-methylpropane sulfonic acid, 2-sulfoethyl (meth)acrylate, allyl sulfonic acid, 4-styrene sulfonic acid, and the like, and sodium salts and ammonium salts of these sulfonic acids.
(xvi) Polymerizable unsaturated monomers having a phosphate group: for example, acid phosphoxyethyl (meth)acrylate, acid phosphoxypropyl (meth)acrylate, acid phosphoxypoly(oxyethylene)glycol (meth)acrylate, and acid phosphoxypoly(oxypropylene)glycol (meth)acrylate.
(xvii) Polymerizable unsaturated monomers having a UV-absorbing functional group; for example, 2-hydroxy-4-(3-methacryloyloxy-2-hydroxypropoxy)benzophenone, 2-hydroxy-4-(3-acryloyloxy-2-hydroxypropoxy)benzophenone, 2,2′-dihydroxy-4-(3-methacryloyloxy-2-hydroxypropoxy)benzophenone, 2,2′-dihydroxy-4-(3-acryloyloxy-2-hydroxypropoxy)benzophenone, and 2-(2′-hydroxy-5′-methacryloyloxyethylphenyl)-2H-benzotriazole.
(xviii) Photostable polymerizable unsaturated monomers: for example, 4-(meth)acryloyloxy-1,2,2,6,6-pentamethylpiperidine, 4-(meth)acryloyloxy-2,2,6,6-tetramethylpiperidine, 4-cyano-4-(meth)acryloylamino-2,2,6,6-tetramethylpiperidine, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, 4-crotonoyloxy-2,2,6,6-tetramethylpiperidine, 4-crotonoylamino-2,2,6,6-tetramethylpiperidine, and 1-crotonoyl-4-crotonoyloxy-2,2,6,6-tetramethylpiperidine.
(xix) Polymerizable unsaturated monomers having a carbonyl group: for example, acrolein, diacetone acrylamide, diacetone methacrylamide, acetoacetoxyethyl methacrylate, formylstyrol, and vinyl alkyl ketones having from 4 to 7 carbons (for example, vinyl methyl ketone, vinyl ethyl ketone, and vinyl butyl ketone).

The hydroxyl group-containing polymerizable unsaturated monomer (a) can generally be used at an amount in a range from 1 to 50 mass %, preferably from 2 to 40 mass %, and more preferably from 3 to 30 mass %, based on the total amount of the monomer (a) and the monomer (b).

From viewpoints such as storage stability and water resistance of the multilayer coating film that is formed, the hydroxyl group-containing acrylic resin (A) generally has a hydroxyl value in a range preferably from 1 to 200 mg KOH/g, particularly preferably from 2 to 150 mg KOH/g, and even more particularly preferably from 5 to 100 mg KOH/g.

From the viewpoint of water resistance of the multilayer coating film that is formed, the water-dispersible hydroxyl group-containing acrylic resin (A) generally has an acid value in a range preferably from 1 to 200 mg KOH/g, particularly preferably from 2 to 150 mg KOH/g, and even more particularly preferably from 5 to 80 mg KOH/g.

In the present specification, the hydroxyl value of the hydroxyl group-containing acrylic resin (A) and the hydroxyl value of the acrylic resin component of the acrylic-urethane composite resin particles (C) are theoretical hydroxyl values. The theoretical hydroxyl value is the number of milligrams of potassium hydroxide when the amount of hydroxyl groups contained in 1 g of the resin component is converted to potassium hydroxide, and is a hydroxyl value calculated from the molar amount of hydroxyl groups contained in the constituent polymerizable unsaturated monomers and the total mass of the constituent polymerizable unsaturated monomers. Specifically, the theoretical hydroxyl value can be calculated on the basis of the following equation.

Theoretical hydroxyl value (mg KOH/g)=[number of moles (mmol) of hydroxyl groups derived from hydroxyl group-containing polymerizable unsaturated monomers]×56.1/[charged amount (g) of polymerizable unsaturated monomers]

Here, “56.1” is the molecular weight of KOH, and the above “charged amount of polymerizable unsaturated monomers” is the total mass of the polymerizable unsaturated monomers.

In the present specification, the acid value of the hydroxyl group-containing acrylic resin (A) and the acid value of the acrylic resin component of the acrylic-urethane composite resin particles (C) are theoretical acid values. The theoretical acid value is the number of milligrams of potassium hydroxide theoretically required to neutralize 1 g of the resin component, and is an acid value calculated from the molar amount of acidic groups contained in the constituent polymerizable unsaturated monomers and the total mass of the constituent polymerizable unsaturated monomers. Specifically, the theoretical acid value can be calculated on the basis of the following equation.

Theoretical acid value (mg KOH/g)=[number of moles (mmol) of acid groups derived from acid group-containing polymerizable unsaturated monomers]×56.1/[charged amount (g) of polymerizable unsaturated monomers]

Here, “56.1” is the molecular weight of KOH, and the above “charged amount of polymerizable unsaturated monomers” is the total mass of the polymerizable unsaturated monomers.

As the hydroxyl group-containing acrylic resin (A), a water-soluble or water-dispersible hydroxyl group-containing acrylic resin can be suitably used, but from viewpoints such as the dripping resistance, image clarity, and brightness of the formed multilayer coating film, the hydroxyl group-containing acrylic resin (A) preferably contains a water-dispersible hydroxyl group-containing acrylic resin (A1). The water-dispersible hydroxyl group-containing acrylic resin (A1) can be produced by copolymerizing by a known method such as emulsion polymerization in an aqueous medium, a hydroxyl group-containing polymerizable unsaturated monomer (a) and another polymerizable unsaturated monomer (b) that is copolymerizable with the hydroxyl group-containing polymerizable unsaturated monomer (a).

Among these, the water-dispersible hydroxyl group-containing resin (A1) preferably includes a water-dispersible hydroxyl group-containing acrylic resin (A1′) having an acid value less than or equal to 20 mg KOH/g from viewpoints such as dripping resistance, image clarity and brightness of the multilayer coating film to be formed. In particular, from viewpoints such as dripping resistance, image clarity, and brightness of the multilayer coating film to be formed, the acid value of the water-dispersible hydroxyl group-containing acrylic resin (A1′) having an acid value less than or equal to 20 mg KOH/g is more preferably less than or equal to 18 mg KOH/g, and even more preferably less than or equal to 15 mg KOH/g. Moreover, from viewpoints such as the stability of the water-dispersible hydroxyl group-containing acrylic resin (A1′) in paint, the acid value of the water-dispersible hydroxyl group-containing acrylic resin (A1′) is preferably greater than or equal to 3 mg KOH/g, more preferably greater than or equal to 5 mg KOH/g, and particularly preferably greater than or equal to 8 mg KOH/g. The acid value of the water-dispersible hydroxyl group-containing acrylic resin (A1) can be adjusted, for example, by adjusting the proportion of a below-described carboxyl group-containing polymerizable unsaturated monomer (e2) in the polymerizable unsaturated monomers used as raw materials.

From viewpoints such as the dripping resistance, image clarity, and brightness of the multilayer coating film that is formed, the water-dispersible hydroxyl group-containing acrylic resin (A1) preferably includes a water-dispersible hydroxyl group-containing acrylic resin (A11) having a core/shell multilayer structure with a crosslinked core portion, the core/shell multilayer structure including a copolymer (I) as the core portion and a copolymer (II) as a shell portion. The copolymer (I) is produced by copolymerizing from 0.1 to 30 mass % of a polymerizable unsaturated monomer (c) having at least two polymerizable unsaturated groups per molecule and from 70 to 99.9 mass % of a polymerizable unsaturated monomer (d) having one polymerizable unsaturated group per molecule. The copolymer (II) is produced by copolymerizing from 1 to 35 mass % of a hydroxyl group-containing polymerizable unsaturated monomer (a) and from 65 to 99 mass % of a polymerizable unsaturated monomer (e) other than the hydroxyl group-containing polymerizable unsaturated monomer (a).

Among these, from viewpoints such as dripping resistance, image clarity, and brightness of the multilayer coating film that is formed, the water-dispersible hydroxyl group-containing acrylic resin (A11) having a core/shell multilayer structure with a crosslinked core portion preferably contains a water-dispersible hydroxyl group-containing acrylic resin (A11′) having an acid value less than or equal to 20 mg KOH/g and having a crosslinked core portion. Among this acid value range, from viewpoints such as dripping resistance, image clarity, and brightness of the multilayer coating film that is formed, the acid value of the water-dispersible hydroxyl group-containing acrylic resin (A11′) is preferably less than or equal to 18 mg KOH/g, and more preferably less than or equal to 15 mg KOH/g. Moreover, from viewpoints such as the stability of the water-dispersible hydroxyl group-containing acrylic resin (A11′) in paint, the acid value of the water-dispersible hydroxyl group-containing acrylic resin (A11′) is preferably greater than or equal to 3 mg KOH/g, more preferably greater than equal to 5 mg KOH/g, and particularly preferably greater than or equal to 8 mg KOH/g.

Examples of the polymerizable unsaturated monomer (c) having at least two polymerizable unsaturated groups per molecule include allyl (meth)acrylate, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tetra(meth)acrylate, glycerol di(meth)acrylate, 1,1,1-tris(hydroxymethyl)ethane di(meth)acrylate, 1,1,1-tris(hydroxymethyl)ethane tri(meth)acrylate, 1,1,1-tris(hydroxymethyl)propane tri(meth)acrylate, triallylisocyanurate, diallyltetraphthalate, and divinylbenzene. Among these, one type may be used alone, or two or more types may be used in combination.

The polymerizable unsaturated monomer (c) having at least two polymerizable unsaturated groups per molecule can generally be used at an amount in a range from 0.1 to 30 mass %, preferably from 0.5 to 10 mass %, and even more preferably from 1 to 5 mass %, based on the total mass of the monomer (c) and monomer (d).

Furthermore, the polymerizable unsaturated monomer (d) having one polymerizable unsaturated group per molecule is a polymerizable unsaturated monomer that is copolymerizable with the polymerizable unsaturated monomer (c) having at least two polymerizable unsaturated groups per molecule, and includes compounds containing one polymerizable unsaturated group, such as a vinyl group, a (meth)acryloyl group, and an allyl group, per molecule.

Specific examples of the polymerizable unsaturated monomer (d) having one polymerizable unsaturated group per molecule include the hydroxyl group-containing polymerizable unsaturated monomers listed in the explanation of the “hydroxyl group-containing polymerizable unsaturated monomer (a)”, as well as (i) alkyl or cycloalkyl (meth)acrylates, (ii) polymerizable unsaturated monomers having an isobornyl group, (iii) polymerizable unsaturated monomers having an adamantyl group, (v) aromatic ring-containing unsaturated monomers, (x) carboxyl group-containing polymerizable unsaturated monomers, and (xi) nitrogen-containing polymerizable unsaturated monomers, which are described in the explanation of the “another polymerizable unsaturated monomer (b) that is copolymerizable with the hydroxyl group-containing polymerizable unsaturated monomer (a)”. One of these may be used alone or two or more types may be used in combination.

From viewpoints such as dripping resistance, image clarity, and brightness of the multilayer coating film that is formed, the polymerizable unsaturated monomer (d) having one polymerizable unsaturated group per molecule favorably includes, as at least a portion of the component thereof, a polymerizable unsaturated monomer (d1) having one polymerizable unsaturated group per molecule and having a hydrocarbon group having from 4 to 22 carbons.

Also, as the polymerizable unsaturated monomer (d1) having one polymerizable unsaturated group per molecule and having a hydrocarbon group having from 4 to 22 carbons, a polymerizable unsaturated monomer containing a saturated or unsaturated hydrocarbon group having from 4 to 22 carbons that is linear, branched, or cyclic may be used. Specific examples of the polymerizable unsaturated monomer (d1) include alkyl or cycloalkyl (meth)acrylates, such as n-butyl (meth)acrylate, isobutyl (meth)acrylate, tert-butyl (meth)acrylate, n-hexyl (meth)acrylate, n-octyl (meth)acrylate, 2-ethylhexyl (meth)acrylate, nonyl (meth)acrylate, tridecyl (meth)acrylate, lauryl (meth)acrylate, stearyl (meth)acrylate, “isostearyl acrylate” (trade name, available from Osaka Organic Chemical Industry Ltd.), cyclohexyl (meth)acrylate, methylcyclohexyl (meth)acrylate, tert-butyl cyclohexyl (meth)acrylate, and cyclododecyl (meth)acrylate; polymerizable unsaturated monomers having an isobornyl group, such as isobornyl (meth)acrylate; polymerizable unsaturated monomers having an adamantyl group, such as adamantyl (meth)acrylate; and vinyl aromatic compounds such as styrene, α-methylstyrene, and vinyl toluene. Among these, one type may be used alone, or two or more types may be used in combination.

Among the polymerizable unsaturated monomers (d1) having one polymerizable unsaturated group per molecule and having a hydrocarbon group having from 4 to 22 carbons, from viewpoints such as the dripping resistance, image clarity, and brightness of the multilayer coating film that is formed, the polymerizable unsaturated monomer (d1) is preferably a polymerizable unsaturated monomer having an alkyl group having from 4 to 8 carbons, and is more preferably a polymerizable unsaturated monomer having an alkyl group having from 4 to 6 carbons. Among these, at least one butyl (meth)acrylate selected from the group consisting of n-butyl (meth)acrylate, isobutyl (meth)acrylate and tert-butyl (meth)acrylate is preferable, n-butyl (meth)acrylate is more preferable, and n-butyl acrylate is particularly preferable.

From viewpoints such as the dripping resistance, image clarity, and brightness of the multilayer coating film that is formed, the polymerizable unsaturated monomer (d1) having one polymerizable unsaturated group per molecule and having a hydrocarbon group having from 4 to 22 carbons is preferably used at an amount in a range from 35 to 80 mass %, particularly preferably from 40 to 70 mass %, and even more particularly preferably from 45 to 65 mass %, based on the total mass of the monomer (c) and the monomer (d).

In addition, in a case in which at least one type of butyl (meth)acrylate selected from the group consisting of n-butyl (meth)acrylate, isobutyl (meth)acrylate, and tert-butyl (meth)acrylate is used as at least one type of the polymerizable unsaturated monomer (d1) having one polymerizable unsaturated group per molecule and having a hydrocarbon group having from 4 to 22 carbons, the total amount of the butyl (meth)acrylate is preferably in a range from 35 to 70 mass %, particularly preferably from 40 to 65 mass %, and even more particularly preferably from 45 to 60 mass %, based on the total amount of the monomer (c) and the monomer (d).

On the other hand, as described above, examples of the hydroxyl group-containing polymerizable unsaturated monomer (a), which is a monomer component contained in the shell, include monoesterified products of a dihydric alcohol having from 2 to 8 carbons and (meth)acrylic acid, such as 2-hydroxyethyl (meth)acrylate, 2-hydroxypropyl (meth)acrylate, 3-hydroxypropyl (meth)acrylate, and 4-hydroxybutyl (meth)acrylate; ε-caprolactone modified products of these monoesterified products of a dihydric alcohol having from 2 to 8 carbons and (meth)acrylic acid; allyl alcohols; and (meth)acrylates having a polyoxyethylene chain with a hydroxyl group at the molecular terminal. Among these, one type may be used alone, or two or more types may be used in combination.

The hydroxyl group-containing polymerizable unsaturated monomer (a) may be used at an amount in a range from 1 to 35 mass %, preferably from 5 to 25 mass %, and more preferably from 8 to 20 mass %, based on the total mass of the monomer (a) and the monomer (e).

The polymerizable unsaturated monomer (e) other than the hydroxyl group-containing polymerizable unsaturated monomer (a) contained in the shell can be appropriately selected from those exemplified as specific examples of the “polymerizable unsaturated monomer (b) that is copolymerizable with the hydroxyl group-containing polymerizable unsaturated monomer (a)”, and examples thereof include (i) alkyl or cycloalkyl (meth)acrylates, (ii) polymerizable unsaturated monomers having an isobornyl group, (iii) polymerizable unsaturated monomers having an adamantyl group, (iv) aromatic ring-containing polymerizable unsaturated monomers, and (x) carboxyl group-containing polymerizable unsaturated monomers. One of these may be used alone, or two or more types may be used in combination.

From viewpoints such as dripping resistance, image clarity, and brightness of the multilayer coating film that is formed, the polymerizable unsaturated monomer (e) other than the hydroxyl group-containing polymerizable unsaturated monomer (a) favorably includes, as at least a portion of the component thereof, a polymerizable unsaturated monomer (e1) having one polymerizable unsaturated group per molecule and having an alkyl group having one or two carbons.

From viewpoints such as the smoothness of the multilayer coating film that is formed, of the polymerizable unsaturated monomers (e1) having one polymerizable unsaturated group per molecule and having an alkyl group having one or two carbons, the polymerizable unsaturated monomer (e1) is preferably at least one type of polymerizable unsaturated monomer selected from the group consisting of methyl (meth)acrylate and ethyl (meth)acrylate, is more preferably at least one type of polymerizable unsaturated monomer selected from the group consisting of methyl methacrylate and ethyl acrylate, and is particularly preferably methyl methacrylate, and use of both methyl methacrylate and ethyl acrylate is even more particularly preferable.

The polymerizable unsaturated monomer (e1) having one polymerizable unsaturated group per molecule and having an alkyl group having one or two carbons is preferably used at an amount in a range from 10 to 99 mass % based on the total mass of the monomer (a) and monomer (e). Within this range, from viewpoints such as dripping resistance, image clarity, and brightness of the multilayer coating film that is formed, the usage proportion of the polymerizable unsaturated monomer (e1) having one polymerizable unsaturated group per molecule and having an alkyl group having one or two carbons is preferably in a range from 51 to 95 mass %, more preferably in a range from 55 to 90 mass %, and particularly preferably in a range from 60 to 80 mass % based on the total mass of the monomer (a) and monomer (e).

From the viewpoint of ensuring the smoothness of the multilayer coating film to be formed, at least a portion of the polymerizable unsaturated monomer (e) other than the hydroxyl group-containing polymerizable unsaturated monomer (a) preferably contains a carboxyl group-containing polymerizable unsaturated monomer (e2).

Examples of the carboxyl group-containing polymerizable unsaturated monomer (e2) include (meth)acrylic acid, maleic acid, crotonic acid, and β-carboxyethyl acrylate, and of these, (meth)acrylic acid is suitable.

From viewpoints such as the stability of the water-dispersible hydroxyl group-containing acrylic resin (A11) in an aqueous medium and the dripping resistance, image clarity, and brightness of the multilayer coating film that is formed, the carboxyl group-containing polymerizable unsaturated monomer (e2) is used at an amount preferably in a range from 1 to 25 mass %, more preferably in a range from 3 to 15 mass %, and particularly preferably in a range from 5 to 10 mass %, based on the total mass of the monomer (a) and the monomer (e).

From viewpoints such as dripping resistance, image clarity, and brightness of the multilayer coating film that is formed, the water-dispersible hydroxyl group-containing acrylic resin (A11) suitably has a hydroxyl value in a range preferably from 1 to 100 mg KOH/g, particularly preferably from 2 to 85 mg KOH/g, and more particularly preferably from 5 to 75 mg KOH/g.

From viewpoints such as dripping resistance, image clarity, and brightness of the multilayer coating film that is formed, a polymerizable unsaturated monomer having only one polymerizable unsaturated group per molecule is preferably used as the monomer (a) and the monomer (e), and the shell of the water-dispersible hydroxyl group-containing acrylic resin (A11) is preferably non-crosslinked.

The water-dispersible hydroxyl group-containing acrylic resin (A11) can be produced by, for example, adding a monomer mixture (II) into an emulsion and further polymerizing the contents thereof. The emulsion is produced by emulsion polymerization of a monomer mixture (I) containing from 0.1 to 30 mass % of the polymerizable unsaturated monomer (c) having at least two polymerizable unsaturated groups per molecule and 70 to 99.9 mass % of the polymerizable unsaturated monomer (d) having one polymerizable unsaturated group per molecule. The monomer mixture (II) contains from 1 to 35 mass % of the hydroxyl group-containing polymerizable unsaturated monomer (a) and from 65 to 99 mass % of the polymerizable unsaturated monomer (e) other than the hydroxyl group-containing polymerizable unsaturated monomer (a).

The emulsion polymerization of the above monomer mixture (I) can be carried by a known method, for example, using a polymerization initiator in the presence of an emulsifier.

As the emulsifier, anionic emulsifiers or nonionic emulsifiers are suitable. Examples of the anionic emulsifier include sodium salts and ammonium salts of organic acids such as alkyl sulfonic acid, alkylbenzene sulfonic acid, and alkylphosphoric acid. Examples of the nonionic emulsifier include polyoxyethylene oleyl ether, polyoxyethylene stearyl ether, polyoxyethylene lauryl ether, polyoxyethylene tridecyl ether, polyoxyethylene phenyl ether, polyoxyethylene nonylphenyl ether, polyoxyethylene octylphenyl ether, polyoxyethylene monolaurate, polyoxyethylene monostearate, polyoxyethylene monooleate, sorbitan monolaurate, sorbitan monostearate, sorbitan trioleate, and polyoxyethylene sorbitan monolaurate.

A polyoxyalkylene group-containing anionic emulsifier having, per molecule, an anionic group and a polyoxyalkylene group such as a polyoxyethylene group or a polyoxypropylene group, or a reactive anionic emulsifier having, per molecule, the anionic group and a radically polymerizable unsaturated group may be used, and of these, use of a reactive anionic emulsifier is suitable.

Examples of the reactive anionic emulsifier include sodium salts and ammonium salts of sulfonic acid compounds having a radically polymerizable unsaturated group such as a (meth)allyl group, a (meth)acryloyl group, a propenyl group, and a butenyl group. Of these, an ammonium salt of a sulfonic acid compound having a radically polymerizable unsaturated group is preferred because of the excellent water resistance of the multilayer coating film that is formed. Examples of the ammonium salt of a sulfonic acid compound include commercially available products such as “Latemul S-180A” (trade name, available from Kao Corporation).

Among the ammonium salts of sulfonic acid compounds having a radically polymerizable unsaturated group, an ammonium salt of a sulfonic acid compound having a radically polymerizable unsaturated group and a polyoxyalkylene group is more preferable. Examples of ammonium salts of sulfonic acid compounds having a radically polymerizable unsaturated group and a polyoxyalkylene group include commercially available products such as “Aqualon KH-10” (trade name, available from DKS Co., Ltd.) and “SR-1025A” (trade name, available from Adeka Corporation).

The emulsifier is usually used at an amount in a range from 0.1 to 15 mass %, preferably from 0.5 to 10 mass %, and more preferably from 1 to 5 mass %, based on the total amount of all monomers that are used.

The polymerization initiator may be oil-soluble or water-soluble, and examples thereof include organic peroxides, such as benzoyl peroxide, octanoyl peroxide, lauroyl peroxide, stearoyl peroxide, cumene hydroperoxide, tert-butyl peroxide, tert-butyl peroxylaurate, tert-butyl peroxyisopropyl carbonate, tert-butyl peroxyacetate, and diisopropyl benzene hydroperoxide; azo compounds such as azobis isobutyronitrile, azobis (2,4-dimethylvaleronitrile), azobis (2-methylpropionitrile), azobis (2-methylbutyronitrile), 4,4′-azobis (4-cyanobutanoic acid), dimethylazobis (2-methylproprionate), azobis [2-methyl-N-(2-hydroxyethyl)-propionamide], and azobis {2-methyl-N-[2-(1-hydroxybutyl)]-propionamide}; and persulfates such as potassium persulfate, ammonium persulfate, and sodium persulfate. Among these, one type may be used alone, or two or more types may be used in combination.

Furthermore, as necessary, a reducing agent such as a sugar, sodium formaldehyde sulfoxylate, and an iron complex may be used in combination with the polymerization initiator, and a redox polymerization system may be formed.

The polymerization initiator is ordinarily used at an amount in a range preferably from 0.1 to 5 mass %, and particularly preferably from 0.2 to 3 mass %, based on the total mass of all monomers that are used. The method of adding the polymerization initiator is not particularly limited, and can be appropriately selected according to the type, amount, and the like of the polymerization initiator. For example, the polymerization initiator may be contained in a monomer mixture or an aqueous medium in advance, or may be added all at once or added dropwise at the time of polymerization.

The water-dispersible hydroxyl group-containing acrylic resin (A11) can be produced by adding, to the emulsion produced as described above, the monomer mixture (II) containing the hydroxyl group-containing polymerizable unsaturated monomer (a) and the polymerizable unsaturated monomer (e) other than the hydroxyl group-containing polymerizable unsaturated monomer (a), and further performing polymerization.

As necessary, the monomer mixture (II) can contain, as appropriate, components such as a polymerization initiator like those listed above, a chain transfer agent, a reducing agent, and an emulsifier. In addition, while the monomer mixture (II) can be added dropwise as is, the monomer mixture (II) is desirably dispersed in an aqueous medium and added dropwise as a monomer emulsion. The particle size of the monomer emulsion in this case is not particularly limited. Polymerization of the monomer mixture (II) can be implemented by, for example, adding the monomer mixture (II), which may be emulsified, to the above-mentioned emulsion all at once or in a dropwise manner, and then heating to an appropriate temperature while stirring.

The water-dispersible hydroxyl group-containing acrylic resin (A11) produced as described above can have a core/shell multilayer structure including a copolymer (I) as a core and a copolymer (II) as a shell. The copolymer (I) is formed from the monomer mixture (I) containing the polymerizable unsaturated monomer (c) having at least two polymerizable unsaturated groups per molecule and the polymerizable unsaturated monomer (d) having one polymerizable unsaturated group per molecule, The copolymer (II) is formed from the monomer mixture (II) containing the hydroxyl group-containing polymerizable unsaturated monomer (a) and the polymerizable unsaturated monomer (e) other than the hydroxyl group-containing polymerizable unsaturated monomer (a).

Furthermore, the water-dispersible hydroxyl group-containing acrylic resin (A11) may be formed as resin particles having three or more layers by adding, between the step of producing the copolymer (I) and the step of producing the copolymer (II), a step of supplying a polymerizable unsaturated monomer (one type or a mixture of two or more types) that forms another resin layer, and implementing emulsion polymerization.

Note that, in the present invention, the “shell” of the water-dispersible hydroxyl group-containing acrylic resin (A11) refers to the polymer layer present in the outermost layer of the resin particle, the “core” means the polymer layer of the inner layer of the resin particle excluding the shell portion, and the “core/shell structure” means a structure having the core and the shell. The core/shell structure described above is typically a layer structure in which the core is completely covered by the shell, but depending on the mass ratio and the like of the core and shell, the amount of the monomer of the shell may be insufficient for forming a layer structure. In such a case, it is not necessary to have a complete layer structure as described above, and the structure may be a structure in which a portion of the core is covered by the shell, or a structure in which a polymerizable unsaturated monomer that is a constituent element of the shell is graft polymerized with a portion of the core. Furthermore, the concept of a multilayer structure with regard to the core/shell structure is also similarly applicable in a case in which a multilayer structure is formed in the core in the water-dispersible hydroxyl group-containing acrylic resin (A11).

From viewpoints such as smoothness of the multilayer coating film that is formed, the ratio of the copolymer (I) and the copolymer (II) in the water-dispersible hydroxyl group-containing acrylic resin (A11) having a core/shell multilayer structure is, in terms of a solid content mass ratio of the copolymer (I)/copolymer (II), preferably in a range from 10/90 to 90/10, particularly preferably from 50/50 to 85/15, and more particularly preferably from 65/35 to 80/20.

The water-dispersible hydroxyl group-containing acrylic resin (A1) can generally have an average particle size in a range from 10 to 1000 nm, and in particular from 20 to 500 nm. Within this range, from viewpoints such as dripping resistance, image clarity, and brightness of the multilayer coating film that is formed, the average particle size of the water-dispersible hydroxyl group-containing acrylic resin (A1) is preferably in a range from 30 to 180 nm, and more preferably in a range from 40 to 150 nm.

Note that, in the present specification, the average particle size of the water-dispersible hydroxyl group-containing acrylic resin (A1) is a value measured at 20° C. using a particle size distribution measurement device based on a dynamic light scattering method after dilution with deionized water by a common method. As the particle size distribution measurement device based on the dynamic light scattering method, for example, the “ELSZ-2000ZS” (trade name, available from Otsuka Electronics Co., Ltd.) can be used.

In the present invention, in a case in which the hydroxyl group-containing acrylic resin (A) includes the water-dispersible hydroxyl group-containing acrylic resin (A1), the acidic groups of the water-dispersible hydroxyl group-containing acrylic resin (A1), such as the carboxyl group, are desirably neutralized by a neutralizing agent in order to improve the mechanical stability of the water dispersion particles of the resulting water-dispersible hydroxyl group-containing acrylic resin (A1). The neutralizing agent can be used without any particular limitation as long as it can neutralize the acidic groups. Examples thereof include sodium hydroxide, potassium hydroxide, trimethylamine, 2-(dimethylamino)ethanol, 2-amino-2-methyl-1-propanol, triethylamine, and ammonia water. These neutralizing agents are preferably used at an amount such that the pH of the aqueous dispersion of the water-dispersible hydroxyl group-containing acrylic resin (A1) after neutralization is from approximately 6.5 to approximately 9.0.

From viewpoints such as dripping resistance, image clarity, and water resistance of the coating film that is formed, the content of the hydroxyl group-containing acrylic resin (A) in the first water-based paint (P1) is suitably in a range from 5 to 60 parts by mass, preferably from 10 to 50 parts by mass, and more preferably from 15 to 35 parts by mass per 100 parts by mass of the resin solid content in the first water-based paint (P1).

From viewpoints such as dripping resistance, image clarity, and water resistance of the coating film that is formed, the content of the water-dispersible hydroxyl group-containing acrylic resin (A1) in the first water-based paint (P1) is suitably in a range from 5 to 60 parts by mass, preferably from 10 to 50 parts by mass, and more preferably from 12 to 35 parts by mass per 100 parts by mass of the resin solid content in the first water-based paint (P1).

### Crosslinking Agent (B)

The first water-based paint (P1) can contain a crosslinking agent (B). As the crosslinking agent (B), a compound having a functional group that is reactive with the hydroxyl group in the hydroxyl group-containing acrylic resin (A) can be suitably used. Specific examples of the crosslinking agent (B) that can be suitably used include an amino resin, a polyisocyanate compound, a blocked polyisocyanate compound. Among these, from viewpoints such as scratch resistance and finished appearance of the coating film to be provided, the crosslinking agent (B) is preferably an amino resin.

As the amino resin that can be used as the crosslinking agent (B), a partially methylolated amino resin or a completely methylolated amino resin produced by reaction between an amino component and an aldehyde component can be used. Examples of the amino component include melamine, urea, benzoguanamine, acetoguanamine, steroguanamine, spiroguanamine, and dicyandiamide. Examples of the aldehyde component include formaldehyde, paraformaldehyde, acetaldehyde, and benzaldehyde.

Furthermore, it is possible to use one in which methylol groups of the methylolated amino resin are partially or completely etherified with an appropriate alcohol. Examples of the alcohol used for the etherification include methyl alcohol, ethyl alcohol, n-propyl alcohol, isopropyl alcohol, n-butyl alcohol, isobutyl alcohol, 2-ethylbutanol, and 2-ethylhexanol.

In a case in which the first water-based paint (P1) contains the abovementioned amino resin as the crosslinking agent (B), from viewpoints such as dripping resistance, image clarity, and water resistance of the coating film that is formed, the content proportion of the amino resin in the first water-based paint (P1) is suitably in a range from 5 to 60 parts by mass, preferably from 15 to 50 parts by mass, and more preferably from 20 to 45 parts by mass per 100 parts by mass of the resin solid content in the first water-based paint (P1).

A melamine resin (B1) is preferable as the amino resin. As the melamine resin (B1), for example, an alkyl-etherified melamine resin in which methylol groups of a partially or completely methylolated melamine resin are partially or completely etherified with the alcohol can be used.

Examples of the alkyl-etherified melamine resin suitably usable include a methyl-etherified melamine resin in which methylol groups of a partially or completely methylolated melamine resin are partially or completely etherified with methyl alcohol; a butyl-etherified melamine resin in which methylol groups of a partially or completely methylolated melamine resin are partially or completely etherified with butyl alcohol; and a methyl-butyl mixed etherified melamine resin in which methylol groups of a partially or completely methylolated melamine resin are partially or completely etherified with methyl alcohol and butyl alcohol.

Among these, from the viewpoint of the dripping resistance, image clarity, and the like of the formed multilayer coating film, the molar ratio of methyl groups to butyl groups, that is, the molar ratio of (methyl groups)/(butyl groups) in the alkyl-etherified melamine resin of the melamine resin (B1) is preferably in a range from 55/45 to 100/0, and more preferably in a range from 60/40 to 80/20.

In addition, from viewpoints such as dripping resistance and image clarity of the multilayer coating film that is formed, the melamine resin (B1) suitably has a weight average molecular weight in a range from 400 to 6000, preferably in a range from 500 to 3000, and more preferably in a range from 500 to 1500.

A commercially available melamine resin product can be used as the melamine resin (B1). Examples of commercially available products of the melamine resin (B1) include: “CYMEL 202”, “CYMEL 203”, “CYMEL 238”, “CYMEL 251”, “CYMEL 303”, “CYMEL 323”, “CYMEL 324”, “CYMEL 325”, “CYMEL 327”, “CYMEL 350”, “CYMEL 385”, “CYMEL 1156”, “CYMEL 1158”, “CYMEL 1116”, and “CYMEL 1130” (all available from Allnex Japan Inc.); and “U-VAN 120”, “U-VAN 20HS”, “U-VAN 20SE60”, “U-VAN 2021”, “U-VAN 2028”, and “U-VAN 28-60” (all available from Mitsui Chemicals, Inc.).

For the melamine resins (B1) described above, one type may be used alone or two or more types may be used in a combination.

In a case in which the first water-based paint (P1) contains the abovementioned melamine resin (B1) as the crosslinking agent (B), from viewpoints such as dripping resistance, image clarity and water resistance of the coating film that is formed, the content proportion of the melamine resin (B1) is suitably in a range from 5 to 60 parts by mass, preferably from 15 to 50 parts by mass, and more preferably from 20 to 45 parts by mass, per 100 parts by mass of the resin solid content in the first water-based paint (P1).

The polyisocyanate compound is a compound having at least two isocyanate groups per molecule, and examples thereof include aliphatic polyisocyanate compounds, alicyclic polyisocyanate compounds, aromatic-aliphatic polyisocyanate compounds, aromatic polyisocyanate compounds, and derivatives of the polyisocyanate compounds.

Examples of the aliphatic polyisocyanate compounds include: aliphatic diisocyanate compounds, such as trimethylene diisocyanate, tetramethylene diisocyanate, hexamethylene diisocyanate, pentamethylene diisocyanate, 1,2-propylene diisocyanate, 1,2-butylene diisocyanate, 2,3-butylene diisocyanate, 1,3-butylene diisocyanate, 2,4,4- or 2,2,4-trimethylhexamethylene diisocyanate, dimer acid diisocyanate, and methyl 2,6-diisocyanatohexanoate (common name: lysine diisocyanate); and aliphatic triisocyanate compounds, such as 2-isocyanatoethyl 2,6-diisocyanatohexanoate, 1,6-diisocyanato-3-isocyanatomethylhexane, 1,4,8-triisocyanatooctane, 1,6,11-triisocyanatoundecane, 1,8-diisocyanato-4-isocyanatomethyloctane, 1,3,6-triisocyanatohexane, and 2,5,7-trimethyl-1,8-diisocyanato-5-isocyanatomethyloctane.

Examples of the alicyclic polyisocyanate compounds include: alicyclic diisocyanate compounds, such as 1,3-cyclopentene diisocyanate, 1,4-cyclohexane diisocyanate, 1,3-cyclohexane diisocyanate, 3-isocyanatomethyl-3,5,5-trimethylcyclohexyl isocyanate (common name: isophorone diisocyanate), 4-methyl-1,3-cyclohexylene diisocyanate (common name: hydrogenated TDI), 2-methyl-1,3-cyclohexylene diisocyanate, 1,3- or 1,4-bis(isocyanatomethyl)cyclohexane (common name: hydrogenated xylylene diisocyanate) or its mixture, methylenebis(4,1-cyclohexanediyl) diisocyanate (common name: hydrogenated MDI), and norbornane diisocyanate; and alicyclic triisocyanate compounds, such as 1,3,5-triisocyanatocyclohexane, 1,3,5-trimethylisocyanatocyclohexane, 2-(3-isocyanatopropyl)-2,5-di(isocyanatomethyl)-bicyclo(2.2.1)heptane, 2-(3-isocyanatopropyl)-2,6-di(isocyanatomethyl)-bicyclo(2.2.1)heptane, 3-(3-isocyanatopropyl)-2,5-di(isocyanatomethyl)-bicyclo(2.2.1)heptane, 5-(2-isocyanatoethyl)-2-isocyanatomethyl-3-(3-isocyanatopropyl)-bicyclo(2.2.1)heptane, 6-(2-isocyanatoethyl)-2-isocyanatomethyl-3-(3-isocyanatopropyl)-bicyclo(2.2.1)heptane, 5-(2-isocyanatoethyl)-2-isocyanatomethyl-2-(3-isocyanatopropyl)-bicyclo(2.2.1)-heptane, and 6-(2-isocyanatoethyl)-2-isocyanatomethyl-2-(3-isocyanatopropyl)-bicyclo(2.2.1)heptane.

Examples of the aromatic-aliphatic polyisocyanate compounds include: aromatic-aliphatic diisocyanate compounds, such as methylenebis(4,1-phenylene) diisocyanate (common name: MDI), 1,3- or 1,4-xylylene diisocyanate or its mixture, ω,ω′-diisocyanato-1,4-diethylbenzene, and 1,3- or 1,4-bis(1-isocyanato-1-methylethyl)benzene (common name: tetramethylxylylene diisocyanate) or its mixture; and aromatic-aliphatic triisocyanate compounds, such as 1,3,5-triisocyanatomethylbenzene.

Examples of the aromatic polyisocyanate compounds include: aromatic diisocyanate compounds, such as m-phenylene diisocyanate, p-phenylene diisocyanate, 4,4′-diphenyl diisocyanate, 1,5-naphthalene diisocyanate, 2,4-tolylene diisocyanate (common name: 2,4-TDI) or 2,6-tolylene diisocyanate (common name: 2,6-TDI) or its mixture, 4,4′-toluidine diisocyanate, and 4,4′-diphenyl ether diisocyanate; aromatic triisocyanate compounds, such as triphenylmethane-4,4′,4″-triisocyanate, 1,3,5-triisocyanatobenzene, and 2,4,6-triisocyanatotoluene; and aromatic tetraisocyanate compounds, such as 4,4′-diphenylmethane-2,2′,5,5′-tetraisocyanate.

In addition, examples of the derivatives of the polyisocyanate compounds include dimers, trimers, biuret, allophanate, uretdione, uretoimine, isocyanurates, oxadiazinetrione, polymethylene polyphenyl polyisocyanates (crude MDI and polymeric MDI), and crude TDI of the polyisocyanate compounds described above.

Among the polyisocyanate compounds and their derivatives, one type may be used alone or two or more types may be used in combination.

As the polyisocyanate compound, at least one type selected from the group consisting of aliphatic polyisocyanate compounds, alicyclic polyisocyanate compounds, and derivatives thereof is preferably used from viewpoints such as weather resistance of the coating film that is formed, and an aliphatic polyisocyanate compound and/or a derivative thereof is more preferably used from viewpoints such as the finished appearance of the coating film that is formed.

From viewpoints such as the finished appearance of the coating film that is formed, as the aliphatic polyisocyanate compound and/or the derivative thereof, among these, an aliphatic diisocyanate compound and/or an isocyanurate thereof is preferably used, and hexamethylene diisocyanate and/or an isocyanurate thereof is more preferably used.

In a case in which the first water-based paint (P1) contains the abovementioned polyisocyanate compound as the crosslinking agent (B), from viewpoints such as dripping resistance, image clarity, and water resistance of the multilayer coating film that is formed, the content proportion of the polyisocyanate compound in the first water-based paint (P1) is suitably in a range from 2 to 60 parts by mass, preferably from 3 to 50 parts by mass, and more preferably from 5 to 45 parts by mass, per 100 parts by mass of the resin solid content in the first water-based paint (P1).

In addition, the blocked polyisocyanate compound that can be used as the crosslinking agent (B) is a compound formed by blocking an isocyanate group in the polyisocyanate compound with a blocking agent.

Examples of the blocking agent include: phenolic compounds, such as phenol, cresol, xylenol, nitrophenol, ethylphenol, hydroxydiphenyl, butylphenol, isopropylphenol, nonylphenol, octylphenol, and methyl hydroxybenzoate; lactam-based compounds, such as ε-caprolactam, δ-valerolactam, γ-butyrolactam, and β-propiolactam; aliphatic alcohol-based compounds, such as methanol, ethanol, propyl alcohol, butyl alcohol, amyl alcohol, and lauryl alcohol; ether-based compounds, such as ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and methoxymethanol; alcohol-based compounds, such as benzyl alcohol, glycolic acid, methyl glycolate, ethyl glycolate, butyl glycolate, lactic acid, methyl lactate, ethyl lactate, butyl lactate, methylol urea, methylol melamine, diacetone alcohol, 2-hydroxyethyl acrylate, and 2-hydroxyethyl methacrylate; oxime-based compounds, such as formamide oxime, acetoamide oxime, acetoxime, methyl ethyl ketoxime, diacetyl monoxime, benzophenone oxime, and cyclohexane oxime; active methylene-based compounds, such as dimethyl malonate, diethyl malonate, ethyl acetoacetate, methyl acetoacetate, and acetylacetone; mercaptan-based compounds, such as butyl mercaptan, t-butyl mercaptan, hexyl mercaptan, t-dodecyl mercaptan, 2-mercaptobenzothiazole, thiophenol, methylthiophenol, and ethylthiophenol; acid amide-based compounds, such as acetanilide, acetanisidide, acetotoluide, acrylamide, methacrylamide, acetic amide, stearic amide, and benzamide; imide-based compounds, such as succinimide, phthalimide, and maleimide; amine-based compounds, such as diphenylamine, phenylnaphthylamine, xylidine, N-phenylxylidine, carbazole, aniline, naphthylamine, butylamine, dibutylamine, and butylphenylamine; imidazole-based compounds, such as imidazole and 2-ethylimidazole; urea-based compounds, such as urea, thiourea, ethyleneurea, ethylenethiourea, and diphenylurea; carbamate ester-based compounds, such as phenyl N-phenylcarbamate; imine-based compounds, such as ethyleneimine and propyleneimine; sulfite-based compounds, such as sodium bisulfite and potassium bisulfite; and azole-based compounds. Examples of the azole-based compounds include pyrazole or pyrazole derivatives, such as pyrazole, 3,5-dimethylpyrazole, 3-methylpyrazole, 4-benzyl-3,5-dimethylpyrazole, 4-nitro-3,5-dimethylpyrazole, 4-bromo-3,5-dimethylpyrazole, and 3-methyl-5-phenylpyrazole; imidazole or imidazole derivatives, such as imidazole, benzimidazole, 2-methylimidazole, 2-ethylimidazole, and 2-phenylimidazole; and imidazoline derivatives, such as 2-methylimidazoline and 2-phenylimidazoline.

Particularly, preferred examples of the blocking agent include oxime-based blocking agents, active methylene-based blocking agents, and pyrazole or pyrazole derivatives.

When an isocyanate group of the polyisocyanate compound is blocked (the polyisocyanate compound is reacted with a blocking agent), a solvent can be added as necessary. The solvent used in the blocking reaction is preferably a solvent not reactive with an isocyanate group, and examples include ketones, such as acetone and methyl ethyl ketone; esters, such as ethyl acetate; and a solvent such as N-methyl-2-pyrrolidone (NMP).

In a case in which the first water-based paint (P1) contains the abovementioned blocked polyisocyanate compound as the crosslinking agent (B), from viewpoints such as dripping resistance, image clarity, and water resistance of the multilayer coating film that is formed, the content proportion of the blocked polyisocyanate compound in the first water-based paint (P1) is suitably in a range from 2 to 60 parts by mass, preferably from 3 to 50 parts by mass, and more preferably from 5 to 45 parts by mass, per 100 parts by mass of the resin solid content in the first water-based paint (P1).

In a case in which the first water-based paint (P1) contains the polyisocyanate compound and/or the blocked polyisocyanate compound as the crosslinking agent (B), the content proportion thereof is suitably a proportion such that an equivalent ratio (NCO/OH) of the total isocyanate groups (including blocked isocyanate groups) of the polyisocyanate compound and the blocked polyisocyanate compound to the hydroxyl groups of the hydroxyl group-containing acrylic resin (A) is typically in a range from 0.2 to 2.5, preferably from 0.5 to 2.0, and more preferably from 0.8 to 1.5, from viewpoints such as dripping resistance, image clarity, water resistance, and the like of the coating film to be formed.

In a case in which the first water-based paint (P1) contains the polyisocyanate compound and/or the blocked polyisocyanate compound as the crosslinking agent (B), the content proportion thereof is suitably a proportion such that an equivalent ratio (NCO/OH) of the total isocyanate groups (including blocked isocyanate groups) of the polyisocyanate compound and the blocked polyisocyanate compound to the total hydroxyl groups of the hydroxyl group-containing resin in the first water-based paint (P1) is typically in a range from 0.2 to 2.0, preferably from 0.5 to 1.8, and more preferably from 0.8 to 1.5, from viewpoints such as dripping resistance, image clarity, water resistance, and the like of the coating film to be formed.

For the crosslinking agents (B), one type may be used alone or two or more types may be used in combination.

### Acrylic-Urethane Composite Resin Particles (C)

The first water-based paint (P1) preferably contains acrylic-urethane composite resin particles (C). The acrylic-urethane composite resin particles (C) are resin composite particles in which a urethane resin component and an acrylic resin component are present in the same micelle. In the present invention, the form of the acrylic-urethane composite resin particles is not particularly limited as long as the particles are dispersed in water, but the particles are preferably dispersed in water as particles having a structure in which the acrylic resin component is positioned around the urethane resin component. In other words, the acrylic-urethane composite resin particles are preferably dispersed in water as micelles having a core-shell structure in which the acrylic resin component portion (hereinafter, also referred to as an acrylic portion) is located at the outer side, and the urethane resin component portion (hereinafter, also referred to as a urethane portion) is located at the inner side. Note that the core-shell structure referred to here specifically refers to a structure in which components having different resin compositions are present in the same micelle, and a central portion (core) and an outer shell portion (shell) have different resin compositions from each other.

From viewpoints such as dripping resistance and image clarity of the multilayer coating film that is formed, the constituent ratio (urethane resin):(acrylic resin) of the urethane resin component and the acrylic resin component in the acrylic-urethane composite resin particles is preferably from 5:95 to 90:10 (mass ratio), more preferably from 5:95 to 50:50 (mass ratio), and particularly preferably from 10:90 to 40:60.

Examples of methods for producing the acrylic-urethane composite resin particles (C) include:
a method in which a polyisocyanate compound, a polyol, and a compound having both an active hydrogen group and an ion-forming group are reacted in polymerizable unsaturated monomers having no reactivity with an isocyanate group, the polymerizable unsaturated monomers including, as at least one type of the polymerizable unsaturated monomers, a (meth)acrylic monomer having no reactivity with an isocyanate group, to thereby generate an isocyanate group-terminated urethane prepolymer, after which a polymerizable unsaturated monomer solution of the urethane prepolymer is dispersed in water, and then as necessary, the chain of the urethane prepolymer is extended, and the polymerizable unsaturated monomers are polymerized to thereby produce an aqueous dispersion of acrylic-urethane composite resin particles including a urethane resin component and an acrylic resin component;
a method in which a polyisocyanate compound, a polyol, and a compound having both an active hydrogen group and an ion-forming group are reacted in polymerizable unsaturated monomers having no reactivity with an isocyanate group, the polymerizable unsaturated monomers including, as at least one type of the polymerizable unsaturated monomers, a (meth)acrylic monomer having no reactivity with an isocyanate group, to thereby generate an isocyanate group-terminated urethane prepolymer, after which a polymerizable unsaturated monomer solution of the urethane prepolymer is dispersed in water, and then as necessary, the chain of the urethane prepolymer is extended, and the polymerizable unsaturated monomers are polymerized, after which an additional polymerizable unsaturated monomer is further added, and the polymerizable unsaturated monomers are polymerized to thereby produce an aqueous dispersion of acrylic-urethane composite resin particles including a urethane resin component and an acrylic resin component;
a method in which urethane resin particles in an aqueous dispersion of urethane resin particles are impregnated with polymerizable unsaturated monomers including a (meth)acrylic monomer as at least one type of the polymerizable unsaturated monomers, after which the polymerizable unsaturated monomers are polymerized to thereby produce an aqueous dispersion of acrylic-urethane composite resin particles including a urethane resin component and an acrylic resin component; and
a method in which urethane resin particles in an aqueous dispersion of urethane resin particles are impregnated with polymerizable unsaturated monomers including a (meth)acrylic monomer as at least one type of the polymerizable unsaturated monomers, after which the polymerizable unsaturated monomers are polymerized, and then an additional polymerizable unsaturated monomer is further added, and these polymerizable unsaturated monomers are polymerized to thereby produce an aqueous dispersion of acrylic-urethane composite resin particles including a urethane resin component and an acrylic resin component.

The urethane resin component can be synthesized using, for example, a polyisocyanate compound, a polyol, and a compound having both an active hydrogen group and an ion-forming group.

The urethane resin component can be synthesized, for example, as follows.

A polyisocyanate compound, a polyol, and a compound having both an active hydrogen group and an ion-forming group are reacted in polymerizable unsaturated monomers having no reactivity with an isocyanate group, the polymerizable unsaturated monomers including, as at least one type of the polymerizable unsaturated monomers, a (meth)acrylic monomer having no reactivity with an isocyanate group, and thereby a urethane prepolymer having an isocyanate group terminal is produced.

Here, the polyol component is preferably a polyol component having a polyester polyol and/or a polyether polyol from the viewpoint of cost and the like.

In this reaction, the ratio of the NCO groups of the polyisocyanate compound to the active hydrogen groups from the polyol and the compound having both an active hydrogen group and an ion-forming group is preferably in a range from 1.1:1 to 3.0:1 (molar ratio).

The pre-polymerization reaction is preferably carried out at a temperature in a range from 50 to 100° C., and in order to prevent polymerization by heat of the polymerizable unsaturated monomers having no reactivity with an isocyanate group, the polymerizable unsaturated monomers including, as at least one type thereof, a (meth)acrylic monomer having no reactivity with an isocyanate group, the pre-polymerization reaction is preferably carried out with the addition of a polymerization inhibitor such as p-methoxyphenol to the (meth)acrylic monomer at an amount in an approximate range from 20 to 3000 ppm in the presence of air.

In addition, at that time, as a catalyst of the urethanization reaction, an organotin compound such as dibutyltin dilaurate, dibutyltin dioctoate, or tin(II) octoate, or a tertiary amine compound such as triethylamine or triethylenediamine can be used as necessary. In this manner, a polymerizable unsaturated monomer solution of an isocyanate group-terminated urethane prepolymer can be produced.

The polyisocyanate compound is a compound having at least two isocyanate groups per molecule, and examples thereof include aliphatic polyisocyanates, alicyclic polyisocyanates, aromatic-aliphatic polyisocyanates, aromatic polyisocyanates, and derivatives of the polyisocyanates.

Examples of the polyisocyanate compound include polyisocyanate compounds and/or derivatives thereof exemplified in the description of the “crosslinking agent (B)” above, and among these, one type may be used alone or two or more types may be used in combination.

From viewpoints such as the dripping resistance and image clarity of the multilayer coating film that is formed, as the polyisocyanate compound, an aliphatic polyisocyanate compound, an alicyclic polyisocyanate compound, or a derivative thereof is preferably included, and an aliphatic polyisocyanate compound (c1-1) is more preferably included.

Examples of the polyol include the following compounds.

Diol compounds: for example, ethylene glycol, propylene glycol, diethylene glycol, triethylene glycol, 1,2-butylene glycol, 1,3-butylene glycol, 2,3-butylene glycol, 1,4-butylene glycol, 1,5-pentanediol, neopentyl glycol, 1,6-hexane glycol, 2,5-hexanediol, dipropylene glycol, 2,2,4-trimethyl-1,3-pentanediol, tricyclodecanedimethanol, and 1,4-cyclohexanedimethanol.

Polyether diols: for example, alkylene oxide adducts of the above diol compounds, ring-opening (co)polymers of alkylene oxides and cyclic ethers (tetrahydrofuran, etc.), such as polyethylene glycol, polypropylene glycol, (block or random) copolymers of ethylene glycol-propylene glycol, glycol, polytetramethylene glycol, polyhexamethylene glycol, and polyoctamethylene glycol.

Polyester diols: examples of the polyester diols include those produced by polycondensing, under a condition of excessive hydroxyl groups, a dicarboxylic acid (anhydride) such as adipic acid, succinic acid, sebacic acid, glutaric acid, maleic acid, fumaric acid, or phthalic acid with an above-described diol compound such as ethylene glycol, propylene glycol, 1,4-butanediol, 1,6-hexanediol, 1,8-octamethylendiol, or neopentyl glycol. Specific examples thereof include ethylene glycol-adipic acid condensate, 1,4-butanediol-adipic acid condensate, 1,6-hexanediol-adipic acid condensate, ethylene glycol-propylene glycol-adipic acid condensate, or a polylactone diol produced by ring-opening polymerization of lactone using glycol as an initiator.

Polyether ester diols: those produced by adding, to an (anhydrous) dicarboxylic acid like that exemplified with regard to the polyester diol, an ether group-containing diol (such as the polyether diol or diethylene glycol) or a mixture of the ether group-containing diol with another glycol, and reacting the alkylene oxide, examples of such polyether ester diols including a polytetramethylene glycol-adipic acid condensate.

Polycarbonate diols: for example, compounds represented by the general formula HO—R—(O—C(O)—O—R)x-OH where R represents a saturated fatty acid diol residue having from 1 to 12 carbons, and x represents the number of repeating units in the molecule and is usually an integer of from 5 to 50. These polycarbonate diols can be produced by a transesterification method in which a saturated aliphatic diol and a substituted carbonate (diethyl carbonate, diphenyl carbonate, or the like) are reacted under a condition of excess hydroxyl groups, a method in which the saturated aliphatic diol and phosgene are reacted, or as necessary, a saturated aliphatic diol is subsequently further reacted therewith, or the like.

From the viewpoint of water dispersibility and the ability to clean the water-based paint, the number average molecular weight of the polyol is preferably from 300 to 3000, and more preferably from 500 to 2500.

Examples of the compound having both an active hydrogen group and an ion-forming group include compounds having two or more hydroxyl groups and one or more carboxyl groups per molecule and compounds having two or more hydroxyl groups and one or more sulfonic acid groups per molecule. This compound acts as an ion-forming group in the urethane resin.

Examples of the compound having a carboxyl group include: alkanol carboxylic acids such as dimethylolpropionic acid, dimethylolacetic acid, dimethylolbutanoic acid, dimethylolheptanoic acid, dimethylolnonanoic acid, 1-carboxy-1,5-pentylenediamine, dihydroxybenzoic acid, and 3,5-diaminobenzoic acid; and half ester compounds of polyoxypropylenetriol with maleic anhydride or phthalic anhydride.

Examples of the compound having a sulfonic acid group include 2-sulfonic acid-1,4-butanediol, 5-sulfonic acid-di-p-hydroxyethyl isophthalate, and N,N-bis(2-hydroxyethyl) aminoethylsulfonic acid.

In a case in which a compound containing a carboxyl group or a sulfonic acid group is used as the compound having both an active hydrogen group and an ion-forming group, an amine such as trimethylamine, triethylamine, monoethanolamine, diethanolamine, triethanolamine, triethylenediamine, or dimethylaminoethanol, or an alkali metal compound such as sodium hydroxide or potassium hydroxide may be used as a neutralizing agent for forming a salt to impart hydrophilicity. The neutralization rate with respect to the carboxyl group or sulfonic acid group can normally be set to be in a range from 50 to 100 mol %. As the neutralizing agent, triethylamine is preferable from viewpoints of improving basicity and water resistance.

A usable example of the urethane resin component includes a water-dispersible urethane resin produced by reacting the polyisocyanate compound, the polyol, and the compound having both an active hydrogen group and an ion-forming group to prepare an isocyanate group-terminated urethane prepolymer, neutralizing the prepolymer with the neutralizing agent, emulsifying and dispersing the neutralized prepolymer in water, and then optionally adding a chain extender and reacting until the isocyanate groups are substantially eliminated.

A commercially available product may be used as the water-dispersible urethane resin. Examples of commercially available products of the water-dispersible urethane resin include products of the Ucoat series available from Sanyo Chemical Industries, Ltd., products of the Superflex series available from DKS Co., Ltd., products of the Impranil series available from Sumika Covestro Urethane Co., Ltd., products of the DAOTAN series available from Daicel-Allnex Ltd., products of the Hydran series available from DIC Corporation, products of the Evafanol series available from Nicca Chemical Co., Ltd., and products of the Adeka Bontighter series available from Adeka Corporation.

For example, acrylic-urethane composite resin particles (C) including a urethane resin component and an acrylic resin component can be produced by impregnating the water-dispersible urethane resin with a polymerizable unsaturated monomer containing a (meth)acrylic monomer as at least one type of the polymerizable unsaturated monomer and then polymerizing the polymerizable unsaturated monomer.

An example of the method for impregnating the water-dispersible urethane resin with the polymerizable unsaturated monomer including a (meth)acrylic monomer as at least one type of the polymerizable unsaturated monomer includes a method in which the urethane resin particles and the polymerizable unsaturated monomer are stirred while being heated as necessary.

The acrylic resin component in the acrylic-urethane composite resin particles (C) can be produced by polymerizing a polymerizable unsaturated monomer including a (meth)acrylic monomer as at least one type of the polymerizable unsaturated monomer.

From viewpoints such as dripping resistance and image clarity of the multilayer coating film that is formed, among these acrylic resin components, the acrylic resin component in the acrylic-urethane composite resin particles (C) is preferably produced by polymerizing, as constituent monomer components, a polymerizable unsaturated monomer (c2-1) having one polymerizable unsaturated group per molecule and an alkyl group having from 4 to 22 carbons, a polymerizable unsaturated monomer (c2-2) having two or more polymerizable unsaturated groups per molecule, and optionally a polymerizable unsaturated monomer (c2-3) other than (c2-1), the polymerizable unsaturated monomer (c2-3) having one polymerizable unsaturated group per molecule.

Note that even if the polymerizable unsaturated monomer having a hydroxyl group is one having an alkyl group having from 4 to 22 carbons, the polymerizable unsaturated monomer does not belong to the polymerizable unsaturated monomer (c2-1), but rather belongs to the polymerizable unsaturated monomer (c2-3).

Examples of the polymerizable unsaturated monomer (c2-1) include the alkyl or cycloalkyl (meth)acrylates exemplified in the description of the “another polymerizable unsaturated monomer (b) that is copolymerizable with the hydroxyl group-containing polymerizable unsaturated monomer (a)”. Among these, one type may be used alone, or two or more types may be used in combination.

As the polymerizable unsaturated monomer (c2-1), a polymerizable unsaturated monomer having an alkyl group having from 6 to 18 carbons is preferable, and a polymerizable unsaturated monomer having an alkyl group having from 6 to 13 carbons is more preferable. From viewpoints such as dripping resistance and image clarity of the resulting coating film, among these polymerizable unsaturated monomers (c2-1), 2-ethylhexyl (meth)acrylate, dodecyl (meth)acrylate, and tridecyl (meth)acrylate are preferable, 2-ethylhexyl acrylate and/or 2-ethylhexyl methacrylate are more preferable, and 2-ethylhexyl acrylate is particularly preferable.

Examples of the polymerizable unsaturated monomer (c2-2) include monomers exemplified in the description of the “polymerizable unsaturated monomer (c) having at least two polymerizable unsaturated groups per molecule”, as well as methylene bisacrylamide, and ethylene bisacrylamide. Among these, one type may be used alone, or two or more types may be used in combination.

Among these polymerizable unsaturated monomers (c2-2), examples that can be suitably used include allyl (meth)acrylates, ethylene glycol di(meth)acrylate, 1,4-butanediol di(meth)acrylate, neopentyl glycol di(meth)acrylate, and 1,6-hexanediol di(meth)acrylate.

Based on the total amount of the polymerizable unsaturated monomer (c2-1), the polymerizable unsaturated monomer (c2-2) and the polymerizable unsaturated monomer (c2-3), the usage proportion of the polymerizable unsaturated monomer (c2-1) is preferably in a range from 30 to 80 mass %, and particularly preferably from 30 to 60 mass % from viewpoints such as the dripping resistance and image clarity of the resulting multilayer coating film.

The usage proportion of the polymerizable unsaturated monomer (c2-2) may be appropriately determined according to the degree of crosslinking of the acrylic-urethane composite resin particles (C), but from viewpoints such as dripping resistance, image clarity, and water resistance of the resulting multilayer coating film, the approximate usage proportion thereof is preferably from 1 to 20 mass %, or from 2 to 15 mass %, and is particularly preferably from 3 to 12 mass %, and more particularly preferably from 3 to 10 mass %.

Examples of the polymerizable unsaturated monomer (c2-3) that is used as necessary include alkyl(meth)acrylates having an alkyl group having from 1 to 3 carbons, such as methyl (meth)acrylate, ethyl (meth)acrylate, n-propyl (meth)acrylate, and isopropyl (meth)acrylate; polymerizable unsaturated monomers exemplified in the description of the “another polymerizable unsaturated monomer (b) that can be copolymerized with the hydroxyl group-containing polymerizable unsaturated monomer (a)” such as (v) aromatic ring-containing polymerizable unsaturated monomers, (vi) alkoxysilyl group-containing polymerizable unsaturated monomers, (vii) fluorinated alkyl group-containing polymerizable unsaturated monomers, (viii) polymerizable unsaturated monomers having a photopolymerizable functional group such as a maleimide group, (ix) vinyl compounds, (x) carboxyl group-containing polymerizable unsaturated monomers, (xi) nitrogen-containing polymerizable unsaturated monomers, (xiii) epoxy group-containing polymerizable unsaturated monomers, (xiv) (meth)acrylates having a polyoxyethylene chain with an alkoxy group at the molecular terminal, and (xix) carbonyl group-containing polymerizable unsaturated monomers; and the hydroxyl group-containing polymerizable unsaturated monomers exemplified in the description of the “hydroxyl group-containing polymerizable unsaturated monomers (a)”. Among these, one type may be used alone, or two or more types may be used in combination.

A hydroxyl group-containing polymerizable unsaturated monomer is preferably included as the polymerizable unsaturated monomer (c2-3) of the acrylic-urethane composite resin particles (C).

The hydroxyl group-containing polymerizable unsaturated monomer causes the resulting acrylic-urethane composite resin particles (C) to contain a hydroxyl group that undergoes a crosslinking reaction with the crosslinking agent (B), and thereby has a function of improving the water resistance and the like of the coating film and of improving the stability of the acrylic-urethane composite resin particles (C) in an aqueous medium.

Examples of the hydroxyl group-containing polymerizable unsaturated monomer include those exemplified in the description of the polymerizable unsaturated monomer (c2-3). Among these, one type may be used alone, or two or more types may be used in combination.

Among these monomers, 2-hydroxyethyl (meth)acrylate, 2-hydroxypropyl (meth)acrylate, 3-hydroxypropyl (meth)acrylate, and 4-hydroxybutyl (meth)acrylate can be suitable used as the hydroxyl group-containing polymerizable unsaturated monomer.

From the viewpoint of achieving excellent stability of the acrylic-urethane composite resin particles (C) in an aqueous medium and excellent water resistance of the resulting coating film, in a case in which the acrylic resin component contains the hydroxyl group-containing polymerizable unsaturated monomer as a constituent monomer component of the acrylic resin component, the usage proportion thereof is preferably from 1 to 30 mass %, more preferably from 2 to 25 mass %, and even more preferably from 3 to 20 mass % based on the total amount of the constituent monomer components of the acrylic resin component.

Moreover, a carboxyl group-containing polymerizable unsaturated monomer can be contained as the polymerizable unsaturated monomer (c2-3) of the acrylic resin component in the acrylic-urethane composite resin particles (C).

Examples of the carboxyl group-containing polymerizable unsaturated monomer include those exemplified for the polymerizable unsaturated monomer (c2-3). Among these, one type may be used alone, or two or more types may be used in combination. Among these monomers, acrylic acid and/or methacrylic acid can be preferably used.

From the viewpoint of achieving excellent dripping resistance and image clarity of the multilayer coating film that is formed and excellent stability of the acrylic-urethane composite resin particles (C) in an aqueous medium, in a case in which the acrylic resin component contains a carboxyl group-containing polymerizable unsaturated monomer as a constituent monomer component of the acrylic resin component, the usage proportion thereof is preferably from 0.1 to 10 mass %, more preferably from 0.2 to 5 mass %, and even more preferably from 0.5 to 4 mass % based on the total amount of the constituent monomer components of the acrylic resin component.

From the viewpoint of improving the image clarity and water resistance of the resulting multilayer coating film, the acrylic resin component in the acrylic-urethane composite resin particles (C) preferably contains a polymerizable unsaturated monomer having an alkyl group having 1 or 2 carbons as the polymerizable unsaturated monomer (c2-3) of the acrylic resin component.

Examples of the polymerizable unsaturated monomer having an alkyl group having 1 or 2 carbons include methyl (meth)acrylate and ethyl (meth)acrylate. Among these, one type may be used alone, or two or more types may be used in combination.

From the viewpoint of improving the image clarity and water resistance of the resulting multilayer coating film, as the polymerizable unsaturated monomer having an alkyl group having 1 or 2 carbons, methyl methacrylate and/or ethyl methacrylate is preferably used, and methyl methacrylate is more preferably used.

In a case in which the acrylic resin component contains the polymerizable unsaturated monomer having an alkyl group having 1 or 2 carbons as a constituent monomer component of the acrylic resin component, from the viewpoint of improving the image clarity and the like of the resulting multilayer coating film, the usage ratio of the polymerizable unsaturated monomer having an alkyl group having 1 or 2 carbons is preferably from 10 to 50 mass %, more preferably from 15 to 50 mass %, and even more preferably from 20 to 40 mass % based on the total amount of the constituent monomer components of the acrylic resin component.

From viewpoints such as improving the dripping resistance and image clarity of the resulting coating film, the acrylic resin component of the acrylic-urethane composite resin particles (C) is preferably one having a core-shell structure in which the central portion (core) and the outer shell portion (shell) have different resin compositions from each other.

In a case in which the acrylic resin component has a core-shell structure, the ratio of the core/shell in terms of the solid content mass ratio is preferably from 5/95 to 95/5, more preferably from 50/50 to 90/10, and still more preferably from 55/35 to 85/15 from viewpoints such as improving the dripping resistance and image clarity of the coating film.

In a case in which a polymerizable unsaturated monomer is further added to the polymerizable unsaturated monomer solution of a urethane prepolymer resulting from production of the urethane prepolymer in polymerizable unsaturated monomers not having reactivity with an isocyanate group, the addition timing is not particularly limited, and the polymerizable unsaturated monomer can be added at any time before or after a below-described step of neutralizing the urethane prepolymer. Moreover, after the neutralized urethane prepolymer has been dispersed in water, the polymerizable unsaturated monomer may be added to the dispersion liquid.

A typical method for producing the acrylic-urethane composite resin particles (C) is described below, but the method is not limited thereto, and a known method for producing acrylic-urethane composite resin particles in the related art can also be used.

The above-described method can be used as the method through production of the urethane prepolymer of the urethane resin component. In this method, the urethane prepolymer is produced in polymerizable unsaturated monomer having no reactivity with an isocyanate group.

Here, the polymerizable unsaturated monomers having no reactivity with an isocyanate group usually become some or all of a constituent monomer component of the acrylic resin component (a central portion (core portion) of the acrylic resin component in a case in which the acrylic resin component has a core-shell structure).

Subsequently, a neutralizing agent is added, after which water is added to cause dispersion in water with a phase inversion between an oil layer and an aqueous layer, resulting in the formation of an aqueous dispersion. A radical polymerization initiator is added to the aqueous dispersion to carry out a polymerization reaction of the polymerizable unsaturated monomers. As necessary, a chain extension reaction of the urethane resin component (urethane prepolymer) (chain extension reaction of isocyanate groups with water) is further performed to complete all polymerization reactions.

As a method for producing the aqueous dispersion described above, the following method can be used as necessary.

When the polymerizable unsaturated monomer solution of the urethane prepolymer is dispersed in water, a polyoxyalkylene group-containing polymerizable unsaturated monomer is added to thereby improve the dispersion in water and produce a uniform and more stable aqueous dispersion. Usable examples of the polyoxyalkylene group-containing polymerizable unsaturated monomer include a polymerizable unsaturated monomer having at a terminal thereof a hydroxy group or an alkyleneoxy group having from 1 to 3 carbons, and having a polyoxyethylene group or a polyoxypropylene group.

In addition, a small amount of a surfactant can also be used in combination from the viewpoints of improving the stability of the aqueous dispersion of the polymerizable unsaturated monomer solution of the urethane prepolymer or the stability during polymerization of the polymerizable unsaturated monomers. Examples of suitable surfactants include anionic surfactants and nonionic surfactants, which may be used in combination. Examples of anionic surfactants include sodium salts and ammonium salts of fatty acid, alkyl sulfates, alkyl benzene sulfonates, naphthalene sulfonates, alkyl sulfosuccinates, and alkyl phosphoric acids. Examples of nonionic surfactants include polyoxyethylene oleyl ether, polyoxyethylene stearyl ether, polyoxyethylene lauryl ether, polyoxyethylene tridecyl ether, polyoxyethylene phenyl ether, polyoxyethylene nonylphenyl ether, polyoxyethylene octylphenyl ether, polyoxyethylene monolaurate, polyoxyethylene monostearate, polyoxyethylene monooleate, sorbitan monolaurate, sorbitan monostearate, sorbitan trioleate, and polyoxyethylene sorbitan monolaurate. Moreover, a polyoxyalkylene group-containing anionic surfactant having, per molecule, an anionic group and a polyoxyalkylene group such as a polyoxyethylene group or a polyoxypropylene group may be used in combination, or from viewpoints such as improving water resistance of the resulting coating film, a reactive anionic surfactant having, per molecule, an anionic group and a reactive group such as a polymerizable unsaturated group may be used in combination.

The usage amount of the surfactant is preferably in a range from 0.1 to 15 mass %, more preferably from 0.5 to 10 mass %, and even more preferably from 1 to 5 mass %, based on the total amount of all polymerizable unsaturated monomers used in the acrylic resin component.

The polymerizable unsaturated monomer solution of the urethane prepolymer can be dispersed in water by dispersion with an ordinary stirrer, but to produce a uniform aqueous dispersion with a finer particle size, a homomixer, a homogenizer, a disperser, a line mixer, or the like can be used.

After the aqueous dispersion of the polymerizable unsaturated monomer solution of the urethane prepolymer is produced as described above, a polymerization initiator is added thereto and the temperature is raised within a range of the polymerization temperature of the polymerizable unsaturated monomer to perform chain extension of the urethane prepolymer with water and polymerization of the polymerizable unsaturated monomer as necessary, and thereby an aqueous dispersion of the acrylic-urethane composite resin particles including the urethane resin component and the acrylic resin component can be produced.

The polymerization reaction in the aqueous dispersion can be carried out by a known radical polymerization reaction. As the polymerization initiator, a water-soluble initiator and/or an oil-soluble initiator can be used. In a case in which an oil-soluble initiator is used, the oil-soluble initiator is preferably added to the polymerizable unsaturated monomer solution of the urethane prepolymer before the aqueous dispersion is prepared.

The polymerization initiator is usually preferably used in a range from 0.05 to 5 mass % per the total amount of the polymerizable unsaturated monomer.

The polymerization can be carried out at a temperature of around 20 to 100° C. In a case in which a redox initiator is used, the reaction can be carried out at a temperature of around 75° C. or lower.

Examples of the polymerization initiator include: azo compounds, such as azobis(isobutyronitrile), azobis(2,4-dimethylvaleronitrile), azobis(2-methylpropionitrile), azobis(2-methylbutyronitrile), 4,4′-azobis(4-cyanobutanoic acid), dimethyl azobis(2-methylproprionate), azobis[2-methyl-N-(2-hydroxyethyl)-propionamide], and azobis{2-methyl-N-[2-(1-hydroxybutyl)]-propionamide}; organic peroxides, such as benzoyl peroxide, octanoyl peroxide, lauroyl peroxide, stearoyl peroxide, cumene hydroperoxide, tert-butyl peroxide, tert-butyl peroxylaurate, tert-butyl-peroxyisopropyl carbonate, tert-butyl-peroxyacetate, and diisopropylbenzene hydroperoxide; and inorganic peroxides such as persulfates including potassium persulfate, ammonium persulfate, and sodium persulfate.

Among these polymerization initiators, one type may be used alone or two or more types may be used in combination.

An organic or inorganic peroxide can also be combined with a reducing agent and used as a redox initiator. Examples of the reducing agent include L-ascorbic acid, L-sorbic acid, sodium metabisulfite, iron(III) sulfate, iron(III) chloride, and Rongalit.

The method for adding the polymerization initiator is not particularly limited, and can be appropriately selected according to the type, amount, and the like of the polymerization initiator. For example, the polymerization initiator may be contained in a polymerizable unsaturated monomer mixture or an aqueous medium in advance, or may be added all at once or added dropwise at the time of polymerization. Alternatively, the addition can be carried out by any method such as a method in which the whole amount is charged all at once at the beginning, a method in which the whole amount is added dropwise over a period of time, or a method in which a part thereof is charged at the beginning and the remainder is added later.

In addition, from the viewpoint of sufficiently carrying out the polymerization reaction and reducing the polymerizable unsaturated monomers that remain, the polymerization reaction can be further carried out by adding a polymerization initiator during the polymerization reaction or after the polymerization has been completed. In this case, the combination of polymerization initiators can be optionally selected.

In general, the usage amount of the polymerization initiator is in an approximate range preferably from 0.1 to 5 mass % and more preferably from 0.2 to 3 mass %, based on the total mass of all polymerizable unsaturated monomers that are used.

In the polymerization of the polymerizable unsaturated monomer, a known chain transfer agent can be used for the purpose of adjusting the molecular weight. Usable examples of the chain transfer agent include compounds having a mercapto group, and specific examples thereof include lauryl mercaptan, t-dodecyl mercaptan, octyl mercaptan, 2-ethylhexyl thioglycolate, 2-methyl-5-tert-butylthiophenol, mercaptoethanol, thioglycerol, mercaptoacetic acid (thioglycolic acid), mercaptopropionate, and n-octyl-3-mercaptopropionate.

In a case in which the chain transfer agent is used, generally the usage amount thereof is preferably in a range from 0.05 to 10 mass %, and is particularly preferably in a range from 0.1 to 5 mass %, based on the total amount of all polymerizable unsaturated monomers that are used.

The polymerizable unsaturated monomer mixture that forms the acrylic resin component can contain, as appropriate and as necessary, components such as the emulsifier, the polymerization initiator, the reducing agent, and the chain transfer agent. In addition, while the polymerizable unsaturated monomer mixture can be added dropwise as is, the mixture thereof is preferably added dropwise as a polymerizable unsaturated monomer emulsion produced by dispersing the polymerizable unsaturated monomer mixture in an aqueous medium. The particle size of the polymerizable unsaturated monomer emulsion in this case is not particularly limited.

In a case in which chain extension of the urethane prepolymer is implemented, a chain extender other than water can be added as necessary to cause a reaction between the urethane prepolymer and the chain extender. As the chain extender, a known chain extender having active hydrogen can be used. Specific examples thereof include diamines such as ethylenediamine, hexamethylenediamine, cyclohexanediamine, cyclohexylmethanediamine, and isophoronediamine; triamines such as diethylenetriamine; and hydrazine.

Also, as described above, the acrylic-urethane composite resin particles (C) can also be produced by a method of impregnating urethane resin particles in an aqueous dispersion of the urethane resin particles with polymerizable unsaturated monomers including a (meth)acrylic monomer as at least one type of the polymerizable unsaturated monomers, and then polymerizing the polymerizable unsaturated monomers to thereby produce an aqueous dispersion of acrylic-urethane composite resin particles including a urethane resin component and an acrylic resin component; or by a method of impregnating urethane resin particles in an aqueous dispersion of the urethane resin particles with polymerizable unsaturated monomers including a (meth)acrylic monomer as at least one type of the polymerizable unsaturated monomers, and polymerizing the polymerizable unsaturated monomers, and then further adding an additional polymerizable unsaturated monomer, and polymerizing these polymerizable unsaturated monomers to thereby obtain an aqueous dispersion of acrylic-urethane composite resin particles including a urethane resin component and an acrylic resin component.

Examples of the method for impregnating the urethane resin particles with the polymerizable unsaturated monomers include a method in which the urethane resin particles and the polymerizable unsaturated monomers are stirred while being heated as necessary.

Compositions of the resin components (acrylic resin component, urethane resin component), reaction conditions, and the like are adjusted in the aqueous dispersion of the acrylic-urethane composite resin particles such that an aqueous dispersion of the acrylic-urethane composite resin particles can be produced with a desired form such as a core-shell structure or a form in which the urethane resin component and the acrylic resin component are partially or entirely mixed.

In a case in which the acrylic resin component has a core-shell structure in which the central portion (core) and the outer shell portion (shell) have different resin compositions from each other as described above, two or more types of polymerizable unsaturated monomers having different compositions are used to carry out a reaction in multiple stages (for example, polymerizable unsaturated monomer mixtures having different compositions are prepared and added and reacted in multiple stages for each polymerizable unsaturated monomer mixture), and thereby an aqueous dispersion of the acrylic-urethane composite resin particles can be produced with a core-shell structure in which the central portion (core) and the outer shell portion (shell) have, as the acrylic resin component, different resin compositions from each other.

In the aqueous dispersion of the acrylic-urethane composite resin particles having a core-shell structure in which the central portion (core) and the outer shell portion (shell) have, as the acrylic resin component, different resin compositions from each other, in particular, the central portion (core) of the acrylic resin component may contain a urethane resin component.

Note that in the present invention, in a case in which the acrylic-urethane composite resin particle (C) has a core-shell multilayer structure, the “shell portion” of the acrylic-urethane composite resin particle (C) refers to the polymer layer present at the outermost layer of the resin particle, the “core portion” refers to the polymer layer of the inner layer of the resin particle excluding the shell portion, and the “core/shell multilayer structure” means a structure having the core portion and the shell portion.

The core-shell multilayer structure described above is typically a layer structure in which the core portion is completely covered by the shell portion. However, depending on a mass ratio and the like of the core portion and the shell portion, the amount of the polymerizable unsaturated monomer of the shell portion may be insufficient for forming a layer structure. In such a case, it is not necessary to have a complete layer structure as described above, and the structure may be a structure in which a portion of the core portion is covered by the shell portion, or a structure in which a polymerizable unsaturated monomer that is a constituent element of the shell portion is graft-polymerized with a portion of the core portion.

Furthermore, the concept of a multilayer structure of the core-shell multilayer structure is also similarly applicable to a case in which a multilayer structure is formed in the core portion of the acrylic-urethane composite resin particles (C) of the present invention.

The acrylic-urethane composite resin particles (C) can have an average particle size within a range generally from 10 to 5000 nm, preferably from 10 to 1000 nm, more preferably from 20 to 500 nm, and even more preferably from 40 to 400 nm.

In the present specification, the average particle size of the acrylic-urethane composite resin particles (C) is a value measured at 20° C. using a particle size distribution measurement device based on a dynamic light scattering method after dilution with deionized water by a common method. As the particle size distribution measurement device based on the dynamic light scattering method, for example, the “ELSZ-2000ZS” (trade name, available from Otsuka Electronics Co., Ltd.) can be used.

In a case in which the acrylic-urethane composite resin particles (C) have an acidic group such as a carboxyl group, the acidic group is preferably neutralized with a neutralizing agent in order to improve the mechanical stability of the particles of the acrylic-urethane composite resin particles (C). The neutralizing agent is not particularly limited as long as it can neutralize the acidic groups, and examples of the neutralizing agent include sodium hydroxide, potassium hydroxide, trimethylamine, 2-(dimethylamino)ethanol, 2-amino-2-methyl-1-propanol, triethylamine, and ammonia water. The neutralizing agent is preferably used at an amount such that the pH of the aqueous dispersion of the acrylic-urethane composite resin particles (C) after neutralization is approximately from 6.0 to 9.0.

The acid value of the acrylic resin component of the acrylic-urethane composite resin particles (C) is preferably less than or equal to 20 mg KOH/g. When the acid value is set to be less than or equal to 20 mg KOH/g, an effect of being able to form a multilayer coating film having excellent dripping resistance, image clarity, and brightness can be achieved. From viewpoints such as dripping resistance, image clarity, brightness, and the like of the multilayer coating film that is formed, the acid value of the acrylic resin component of the acrylic-urethane composite resin particles (C) is more preferably less than or equal to 15 mg KOH/g, and even more preferably less than or equal to 10 mg KOH/g. Moreover, from viewpoints such as stabilization of the acrylic-urethane composite polymer particles (C) in paint, the acid value of the acrylic resin component of the acrylic-urethane composite resin particles (C) is preferably greater than or equal to 2 mg KOH/g, and more preferably greater than or equal to 4 mg KOH/g.

Furthermore, from viewpoints such as dripping resistance and image clarity, brightness, the hydroxyl value of the acrylic resin component of the acrylic-urethane composite resin particles (C) is preferably in a range from 1 to 85 mg KOH/g, and more preferably in a range from 2 to 75 mg KOH/g.

The solid content concentration in the aqueous dispersion of the acrylic-urethane composite resin particles (C) is preferably in a range from 20 to 50 mass %, and more preferably in a range from 30 to 40 mass %. When the solid content concentration exceeds 50 mass %, emulsification becomes difficult, and it may be difficult to produce an aqueous dispersion. When the concentration thereof is less than 20 mass %, the solvent (mainly water) component is increased due to the low concentration, and thus it may be difficult to use the aqueous dispersion of the acrylic-urethane composite resin particles (C) as a constituent component of a water-based paint composition.

From viewpoints such as dripping resistance, image clarity, and brightness of the coating film that is formed, the content of the acrylic-urethane composite resin particles (C) in the first water-based paint (P1) is suitably in a range from 5 to 60 parts by mass, preferably from 10 to 50 parts by mass, and more preferably from 15 to 35 parts by mass per 100 parts by mass of the resin solid content in the first water-based paint (P1).

The first water-based paint (P1) may contain another resin in addition to the hydroxyl group-containing acrylic resin (A), the crosslinking agent (B), and the acrylic-urethane composite resin particles (C) having an acid value of the acrylic resin component less than or equal to 20 mg KOH/g. Examples of such resins include polyester resins, acrylic resins, polyurethane resins, polyether resins, polycarbonate resins, epoxy resins, alkyd resins, and modified resins thereof, except for the hydroxyl group-containing acrylic resin (A), the crosslinking agent (B), and the acrylic-urethane composite resin particles (C) having an acid value of the acrylic resin component less than or equal to 20 mg KOH/g. One type of these resins may be used alone or two or more types thereof may be used in combination. As such a resin, a hydroxyl group-containing polyester resin or an acrylic-modified hydroxyl group-containing polyester resin can be suitably used particularly from viewpoints of improving dripping resistance, image clarity, and brightness.

The hydroxyl group-containing polyester resin can be generally produced by esterification reaction or transesterification reaction between an acid component and an alcohol component.

As the acid component, a compound commonly used as an acid component in the production of a polyester resin can be used. Examples of such an acid component include aliphatic polybasic acids, alicyclic polybasic acids, and aromatic polybasic acids. Among these, an aliphatic polybasic acid is preferably contained from viewpoints such as the dripping resistance, image clarity, and the like of the formed multilayer coating film.

The aliphatic polybasic acid is generally an aliphatic compound having two or more carboxyl groups per molecule, an acid anhydride of the aliphatic compound, or an esterified product of the aliphatic compound. Examples of the aliphatic polybasic acid include aliphatic polybasic carboxylic acids such as succinic acid, glutaric acid, adipic acid, pimelic acid, suberic acid, azelaic acid, sebacic acid, undecanedioic acid, dodecanedioic acid, brassylic acid, octadecanedioic acid, citric acid, and butanetetracarboxylic acid; anhydrides of these aliphatic polybasic carboxylic acids; and esterified products of lower alkyls having from about 1 to about 4 carbons of the aliphatic polybasic carboxylic acids. Among the aliphatic polybasic acids, one type may be used alone, or two or more types may be used in combination.

From viewpoints such as dripping resistance and image clarity of the multilayer coating film that is formed, at least one type of aliphatic polybasic acid selected from the group consisting of succinic acid, succinic anhydride, adipic acid, and adipic anhydride is preferably used as at least one type of the aliphatic polybasic acid.

The alicyclic polybasic acid is generally a compound having one or more alicyclic structures and two or more carboxyl groups per molecule, an acid anhydride of the compound, or an esterified product of the compound. The alicyclic structure is primarily a ring structure of four to six members. Examples of the alicyclic polybasic acid include alicyclic polybasic carboxylic acids such as 1,2-cyclohexane dicarboxylic acid, 1,3-cyclohexane dicarboxylic acid, 1,4-cyclohexane dicarboxylic acid, 4-cyclohexene-1,2-dicarboxylic acid, 3-methyl-1,2-cyclohexane dicarboxylic acid, 4-methyl-1,2-cyclohexane dicarboxylic acid, 1,2,4-cyclohexane tricarboxylic acid, and 1,3,5-cyclohexane tricarboxylic acid; anhydrides of the alicyclic polybasic carboxylic acids; and esterified products of lower alkyls having from about 1 to about 4 carbons of the alicyclic polybasic carboxylic acids. Among the alicyclic polybasic acids, one type may be used alone, or two or more types may be used in combination.

From the viewpoint of smoothness of the multilayer coating film that is formed, at least one alicyclic polybasic acid selected from the group consisting of 1,2-cyclohexane dicarboxylic acid, 1,2-cyclohexane dicarboxylic anhydride, 1,3-cyclohexane dicarboxylic acid, 1,4-cyclohexane dicarboxylic acid, 4-cyclohexene-1,2-dicarboxylic acid, and 4-cyclohexene-1,2-dicarboxylic anhydride is preferably used as at least one type of the alicyclic polybasic acid, and of these, use of 1,2-cyclohexane dicarboxylic acid and/or 1,2-cyclohexane dicarboxylic anhydride is preferable.

The aromatic polybasic acid is generally an aromatic compound having two or more carboxyl groups per molecule, an acid anhydride of the aromatic compound, or an esterified product of the aromatic compound. Examples of the aromatic polybasic acid include aromatic polybasic carboxylic acids, such as phthalic acid, isophthalic acid, terephthalic acid, naphthalene dicarboxylic acid, 4,4′-biphenyl dicarboxylic acid, trimellitic acid, and pyromellitic acid; anhydrides of these aromatic polybasic carboxylic acids; and esterified products of lower alkyls having about 1 to about 4 carbons of these aromatic polybasic carboxylic acids. Among the aromatic polybasic acids, one type may be used alone, or two or more types can be used in combination.

At least one type of aromatic polybasic acid selected from the group consisting of phthalic acid, phthalic anhydride, isophthalic acid, trimellitic acid, and trimellitic anhydride is preferably used as at least one type of the aromatic polybasic acid.

Also, an acid component other than the aliphatic polybasic acid, the alicyclic polybasic acid, and the aromatic polybasic acid can be used. Such an acid component is not particularly limited, and examples thereof include fatty acids, such as coconut oil fatty acid, cotton seed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, dehydrated castor oil fatty acid, and safflower oil fatty acid; monocarboxylic acids such as lauric acid, myristic acid, palmitic acid, stearic acid, oleic acid, linoleic acid, linolenic acid, benzoic acid, p-tert-butylbenzoic acid, cyclohexanoic acid, and 10-phenyloctadecanoic acid; and hydroxycarboxylic acids such as lactic acid, 3-hydroxybutanoic acid, and 3-hydroxy-4-ethoxybenzoic acid. Among these acid components, one type may be used alone or two or more types may be used in combination.

As the alcohol component, a polyhydric alcohol having two or more hydroxyl groups per molecule can be suitably used. Examples of the polyhydric alcohols include dihydric alcohols, such as ethylene glycol, propylene glycol, diethylene glycol, trimethylene glycol, tetraethylene glycol, triethylene glycol, dipropylene glycol, 1,4-butanediol, 1,3-butanediol, 2,3-butanediol, 1,2-butanediol, 2-methyl-1,3-propanediol, 3-methyl-1,2-butanediol, 2-butyl-2-ethyl-1,3-propanediol, 1,2-pentanediol, 1,5-pentanediol, 1,4-pentanediol, 2,4-pentanediol, 2,3-dimethyltrimethylene glycol, tetramethylene glycol, 3-methyl-4,3-pentanediol, 3-methyl-1,5-pentanediol, 2,2,4-trimethyl-1,3-pentanediol, 1,6-hexanediol, 1,5-hexanediol, 1,4-hexanediol, 2,5-hexanediol, neopentyl glycol, 1,4-cyclohexanedimethanol, tricyclodecanedimethanol, neopentyl glycol hydroxypivalate ester, hydrogenated bisphenol A, hydrogenated bisphenol F, and dimethylolpropionic acid; polylactone diols produced by adding a lactone compound such as ε-caprolactone to these dihydric alcohols; ester diol compounds such as bis(hydroxyethyl) terephthalate; polyether diol compounds such as an alkylene oxide adduct of bisphenol A, polyethylene glycol, polypropylene glycol, and polybutylene glycol; tri- or higher-hydric alcohols, such as glycerin, trimethylolethane, trimethylolpropane, diglycerin, triglycerin, 1,2,6-hexanetriol, pentaerythritol, dipentaerythritol, tris(2-hydroxyethyl)isocyanuric acid, sorbitol, and mannitol; polylactone polyol compounds produced by adding a lactone compound such as ε-caprolactone to these tri- or higher-hydric alcohols; and fatty acid ester compounds of glycerin.

Furthermore, an alcohol component other than the polyhydric alcohols described above can be used. Such an alcohol component is not particularly limited, and examples include monoalcohols such as methanol, ethanol, propyl alcohol, butyl alcohol, stearyl alcohol, and 2-phenoxyethanol; and alcohol compounds produced by reacting an acid with a monoepoxy compound such as a propylene oxide, butylene oxide, and “Cardura E10P” (trade name, glycidyl ester of a synthetic highly-branched saturated fatty acid, available from Hexion Inc.).

The method for producing a hydroxyl group-containing polyester resin is not particularly limited, and the hydroxyl group-containing polyester resin can be produced according to a typical method. For example, a method can be used in which the acid component and the alcohol component are heated at approximately 150 to 250° C. in a nitrogen stream for approximately 5 to 10 hours, and the acid component and the alcohol component are subjected to an esterification reaction or a transesterification reaction to thereby produce the hydroxyl group-containing polyester resin.

When the acid component and the alcohol component are to be subjected to the esterification reaction or transesterification reaction, these components may be added all at once into a reaction vessel, or one or both components may be added in multiple batches. Also, first, the hydroxyl group-containing polyester resin may be synthesized, and then an acid anhydride may be reacted with the resulting hydroxyl group-containing polyester resin to form a half-ester and produce a carboxyl group- and hydroxyl group-containing polyester resin. In addition, first, the carboxyl group-containing polyester resin may be synthesized, and then the alcohol component may be added to produce a hydroxyl group-containing polyester resin.

For the esterification or transesterification reaction, a catalyst known per se can be used as a catalyst for promoting the reaction. Examples of such catalysts include dibutyltin oxide, antimony trioxide, zinc acetate, manganese acetate, cobalt acetate, calcium acetate, lead acetate, tetrabutyl titanate, and tetraisopropyl titanate.

Furthermore, the hydroxyl group-containing polyester resin can be modified with a fatty acid, a monoepoxy compound, a polyisocyanate compound, or the like during or after preparation of the resin.

Examples of the fatty acid include coconut oil fatty acid, a cottonseed oil fatty acid, hempseed oil fatty acid, rice bran oil fatty acid, fish oil fatty acid, tall oil fatty acid, soybean oil fatty acid, linseed oil fatty acid, tung oil fatty acid, rapeseed oil fatty acid, castor oil fatty acid, a dehydrated castor oil fatty acid, and safflower oil fatty acid. Further, as the monoepoxy compound, for example, “Cardura E10P” (trade name, glycidyl ester of a synthetic highly-branched saturated fatty acid, available from Hexion Inc.) can be suitably used.

Examples of the polyisocyanate compound include aliphatic diisocyanate compounds, such as lysine diisocyanate, hexamethylene diisocyanate, and trimethylhexane diisocyanate; alicyclic diisocyanate compounds, such as hydrogenated xylylene diisocyanate, isophorone diisocyanate, methylcyclohexane-2,4-diisocyanate, methylcyclohexane-2,6-diisocyanate, 4,4′-methylenebis(cyclohexyl isocyanate), and 1,3-(isocyanatomethyl)cyclohexane; aromatic diisocyanate compounds, such as tolylene diisocyanate, xylylene diisocyanate, and diphenylmethane diisocyanate; polyisocyanates themselves, such as tri- or higher-valent polyisocyanates such as lysine triisocyanate; adducts of each of these polyisocyanates with a polyhydric alcohol, a low molecular weight polyester resin, or water; and cyclized polymers (for example, isocyanurate) and biuret-type adducts of each of these polyisocyanates. Among these polyisocyanate compounds, one type may be used alone or two or more types may be used in combination.

Furthermore, from the viewpoint of achieving excellent smoothness and the like of the multilayer coating film that is formed, the content of the alicyclic polybasic acid in the acid component of the raw materials of the hydroxyl group-containing polyester resin is preferably in a range from 20 to 100 mol %, more preferably in a range from 25 to 95 mol %, and even more preferably in a range from 30 to 90 mol %, based on the total amount of the acid component. In particular, from the viewpoint of achieving excellent smoothness and the like of the multilayer coating film that is formed, the alicyclic polybasic acid is preferably a 1,2-cyclohexane dicarboxylic acid and/or a 1,2-cyclohexane dicarboxylic anhydride.

The hydroxyl value of the hydroxyl group-containing polyester resin is preferably in a range from 1 to 200 mg KOH/g, more preferably in a range from 2 to 180 mg KOH/g, and particularly preferably in a range from 5 to 170 mg KOH/g. Also, in a case in which the hydroxyl group-containing polyester resin further includes a carboxyl group, the acid value thereof is preferably in a range from 5 to 150 mg KOH/g, more preferably in a range from 10 to 100 mg KOH/g, and particularly preferably in a range from 15 to 80 mg KOH/g. Furthermore, the number average molecular weight of the hydroxyl group-containing polyester resin is preferably in a range from 500 to 50000, more preferably in a range from 1000 to 6000, and particularly preferably in a range from 1200 to 4000.

In a case in which the first water-based paint (P1) contains the abovementioned hydroxyl group-containing polyester resin, from viewpoints such as dripping resistance, image clarity, and water resistance of the multilayer coating film that is formed, the content proportion of the hydroxyl group-containing polyester resin in the first water-based paint (P1) is suitably in a range from 1 to 50 parts by mass, preferably from 3 to 35 parts by mass, and more preferably from 5 to 25 parts by mass, per 100 parts by mass of the resin solid content in the first water-based paint (P1).

In the acrylic-modified hydroxyl group-containing polyester resin, the main chain is a polyester portion including a polyester resin and the main chain is modified by an acrylic portion including an acrylic-based (co)polymer. In a case in which the modification is graft modification, the polyester portion is a trunk polymer and the acrylic portion is a branch polymer, and the acrylic portion is bonded to the polyester portion via a graft point.

The method for producing the acrylic-modified hydroxyl group-containing polyester resin is not particularly limited, and the resin thereof can be produced by a typical method. Specifically, the acrylic-modified hydroxyl group-containing polyester resin can be produced by a method of polymerizing a mixture of an unsaturated group-containing polyester resin and an unsaturated monomer, and a method that uses an esterification reaction between a polyester resin and an acrylic resin.

From the viewpoint of the physical properties of the coating film, the proportions of the acrylic portion and the polyester portion of the acrylic-modified hydroxyl group-containing polyester resin are such that in relation to the acrylic-modified hydroxyl group-containing polyester resin (total of the acrylic portion and the polyester portion), the acrylic portion is preferably in a range from 5 to 40 mass %, particularly preferably from 5 to 30 mass %, and more particularly preferably from 5 to 25 mass %, and the polyester portion is preferably in a range from 60 to 95 mass %, particularly preferably from 70 to 95 mass %, and more particularly from 75 to 95 mass %.

From the viewpoints of curability and water resistance, the acrylic-modified hydroxyl group-containing polyester resin preferably has a hydroxyl value in a range from 20 to 200 mg KOH/g, and particularly preferably from 30 to 150 mg KOH/g.

The hydroxyl value of the acrylic portion is preferably in a range from 0 to 70 mg KOH/g, particularly preferably from 0 to 50 mg KOH/g, and more particularly preferably from 0 to 30 mg KOH/g.

The hydroxyl value of the polyester portion is preferably in a range from 20 to 200 mg KOH/g, particularly preferably from 30 to 150 mg KOH/g, and more particularly preferably from 30 to 120 mg KOH/g.

From the viewpoint of water dispersibility, the acrylic-modified hydroxyl group-containing polyester resin preferably has an acid value in a range from 10 to 100 mg KOH/g, particularly preferably from 15 to 80 mg KOH/g, and more particularly preferably from 15 to 60 mg KOH/g.

The acid value of the acrylic portion is preferably in a range from 50 to 500 mg KOH/g, particularly preferably from 80 to 400 mg KOH/g, and more particularly preferably from 100 to 300 mg KOH/g.

The acid value of the polyester portion is preferably in a range from 0 to 20 mg KOH/g, particularly preferably from 0 to 15 mg KOH/g, and more particularly preferably from 0 to 10 mg KOH/g.

From viewpoints such as the appearance of the coating film, the physical properties of the coating film, and the chipping resistance, the weight average molecular weight of the acrylic-modified hydroxyl group-containing polyester resin is preferably in a range from 1000 to 100000, particularly preferably from 2000 to 50000, and more particularly preferably from 2000 to 20000.

In a case in which the first water-based paint (P1) contains the abovementioned acrylic-modified hydroxyl group-containing polyester resin, from viewpoints such as dripping resistance, image clarity, and water resistance of the multilayer coating film that is formed, the content proportion of the acrylic-modified hydroxyl group-containing polyester resin in the first water-based paint (P1) is suitably in a range from 1 to 50 parts by mass, preferably from 5 to 40 parts by mass, and more preferably from 10 to 30 parts by mass, per 100 parts by mass of the resin solid content in the first water-based paint (P1).

In a case in which the first water-based paint (P1) contains the abovementioned hydroxyl group-containing polyester resin and the acrylic-modified hydroxyl group-containing polyester resin, from viewpoints such as dripping resistance, image clarity, and water resistance of the multilayer coating film that is formed, the total content proportion of the hydroxyl group-containing polyester resin and the acrylic-modified hydroxyl group-containing polyester resin in the first water-based paint (P1) is suitably in a range from 2 to 60 parts by mass, preferably from 10 to 50 parts by mass, and more preferably from 15 to 30 parts by mass, per 100 parts by mass of the resin solid content in the first water-based paint (P1).

In a case in which the first water-based paint (P1) contains the abovementioned hydroxyl group-containing polyester resin and the acrylic-modified hydroxyl group-containing polyester resin, from viewpoints such as the dripping resistance, image clarity, and water resistance the multilayer coating film that is formed, in terms of a ratio of the (acrylic-modified hydroxyl group-containing polyester resin)/(hydroxyl group-containing polyester resin), the content ratio of the hydroxyl group-containing polyester resin to the acrylic-modified hydroxyl group-containing polyester resin in the first water-based paint (P1) is suitably in a range from 30/70 to 95/5, preferably from 50/50 to 90/10, and more preferably from 60/40 to 85/15.

The first water-based paint (P1) preferably further contains a pigment. Examples of the pigment include coloring pigments, effect pigments, and extender pigments.

In a case in which the first water-based paint (P1) contains the above-mentioned coloring pigment, the coloring pigment is not particularly limited, and similar to the case of the intermediate coating paint, among known coloring pigments, one type may be used alone, or two or more types may be used in combination. Carbon black is preferably used as at least one type of the coloring pigment from viewpoints of improving the ease of identifying the application site of the first water-based paint (P1) and suppressing the light transmittance of the first coating film formed from the first water-based paint (P1). In a case in which a multilayer coating film having a white pearl color is to be formed, the first water-based paint (P1) preferably contains a titanium dioxide pigment as at least one of the coloring pigments.

In a case in which the first water-based paint (P1) contains the abovementioned coloring pigment, the content of the coloring pigment is preferably in a range from 0.003 to 150 parts by mass, more preferably in a range from 0.005 to 140 parts by mass, and particularly preferably in a range from 0.03 to 130 parts by mass, per 100 parts by mass of the total solid content of the binder component in the first water-based paint (P1).

In a case in which the first water-based paint (P1) contains the effect pigment described above, the effect pigment is not particularly limited, among known effect pigments, one type may be used alone, or two or more types may be used in combination. As the effect pigment, for example, an effect pigment described in the explanation of an effect pigment (B_{P2}) in a second water-based colored paint (P2) described below can be used. From viewpoints such as the brightness, smoothness, and image clarity of the multilayer coating film that is formed, at least one type of effect pigment selected from the group consisting of aluminum flake pigments, vapor-deposited aluminum flake pigments, colored aluminum flake pigments, metal oxide coated mica pigments, and metal oxide coated aluminum oxide flake pigments is preferably used as the effect pigment, and among these, use of an aluminum flake pigment and/or a metal oxide coated aluminum oxide flake pigment is more preferable.

In a case in which the first water-based paint (P1) contains the effect pigment described above, the content of the effect pigment is preferably in a range from 0.1 to 20 parts by mass, more preferably in a range from 0.5 to 18 parts by mass, and particularly preferably in a range from 1 to 16 parts by mass, per 100 parts by mass of the total solid content of the binder component in the first water-based paint (P1).

In a case in which the first water-based paint (P1) contains the extender pigment described above, the extender pigment is not particularly limited, and among known extender pigments, one type may be used alone, or two or more types may be used in combination. Examples of the extender pigment include barium sulfate, barium carbonate, calcium carbonate, talc, and silica. From viewpoints such as the brightness, smoothness, image clarity, and chipping resistance of the multilayer coating film that is formed, barium sulfate and/or talc is preferably used as at least one type of these extender pigments, and from viewpoints such as the brightness, smoothness, and image clarity of the multilayer coating film that is formed, barium sulfate is more preferably used.

In a case in which the first water-based paint (P1) contains the extender pigment described above, the content of the extender pigment is preferably in a range from 0.1 to 30 parts by mass, more preferably in a range from 2.5 to 25 parts by mass, and particularly preferably in a range from 5 to 20 parts by mass, per 100 parts by mass of the total solid content of the binder component in the first water-based paint (P1).

The first water-based paint (P1) preferably further contains a diester compound (D) from viewpoints such as the smoothness, image clarity, and brightness of the multilayer coating film that is formed. The diester compound (D) is represented by the following general formula (1):

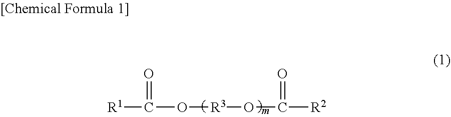

In the above formula (1), R¹ and R² independently represent a hydrocarbon group having from 4 to 18 carbons, R³ represents an alkylene group having from 2 to 4 carbons, m is an integer from 3 to 20, and m pieces of R³ may be mutually the same or different.

In the above formula (1), the hydrocarbon group represented by R¹ or R² is preferably an alkyl group having from 5 to 11 carbons, more preferably an alkyl group having from 5 to 9 carbons, and even more preferably an alkyl group having from 6 to 8 carbons. In particular, in a case in which R¹ and R² are branched alkyl groups having from 6 to 8 carbons, excellent film-formability can be imparted to the coating film that is formed, even when the paint is applied after being stored for a relatively long period of time. R³ is preferably ethylene, and m is particularly preferably an integer of 4 to 10.

The diester compound (D) can be produced, for example, by an esterification reaction of a polyoxyalkylene glycol having two terminal hydroxyl groups and a monocarboxylic acid having a hydrocarbon group having from 4 to 18 carbons.

Examples of the polyoxyalkylene glycol include polyethylene glycol, polypropylene glycol, a block copolymer of polyethylene glycol and polypropylene glycol, and polybutylene glycol. Among these, polyethylene glycol is particularly preferably used. These polyoxyalkylene glycols preferably have a weight average molecular weight in a range generally about 120 to about 800, particularly about 150 to about 600, and further particularly about 200 to about 400, from viewpoints such as water resistance.

Examples of the monocarboxylic acid having a hydrocarbon group having from 4 to 18 carbons include pentanoic acid, hexanoic acid, 2-ethylbutanoic acid, 3-methylpentanoic acid, benzoic acid, cyclohexanecarboxylic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, 4-ethyloctanoic acid, dodecanoic acid, hexadecanoic acid, and octadecanoic acid. Among them, monocarboxylic acids having an alkyl group having from 5 to 9 carbons such as hexanoic acid, heptanoic acid, 2-ethylpentanoic acid, 3-ethylpentanoic acid, octanoic acid, 2-ethylhexanoic acid, 4-ethylhexanoic acid, nonanoic acid, 2-ethylheptanoic acid, decanoic acid, 2-ethyloctanoic acid, and 4-ethyloctanoic acid are preferred, monocarboxylic acids having an alkyl group having from 6 to 8 carbons such as heptanoic acid, 2-ethylpentanoic acid, 3-ethylpentanoic acid, octanoic acid, 2-ethylhexanoic acid, 4-ethylhexanoic acid, nonanoic acid, and 2-ethylheptanoic acid are more preferred, and monocarboxylic acids having a branched alkyl group having from 6 to 8 carbons such as 2-ethylpentanoic acid, 3-ethylpentanoic acid, 2-ethylhexanoic acid, 4-ethylhexanoic acid, and 2-ethylheptanoic acid are even more preferred.

The diesterification reaction between the polyoxyalkylene glycol and the monocarboxylic acid can be carried out by a method known per se. Among the polyoxyalkylene glycols and the monocarboxylic acids, respectively, one type may be used alone or two or more types may be used in combination.

The resulting diester compound (D) generally has a molecular weight in a range preferably from approximately 320 to approximately 1000, particularly preferably from approximately 400 to approximately 800, and more particularly preferably from approximately 500 to approximately 700.

The first water-based paint (P1) preferably further contains a hydrophobic organic solvent from viewpoints such as the smoothness, image clarity, sweating resistance, and brightness of the multilayer coating film that is formed.

The hydrophobic organic solvent is desirably an organic solvent having a mass dissolved in 100 g of water at 20° C. of less than or equal to 10 g, preferably less than or equal to 5 g, and more preferably less than or equal to 1 g. Examples of such hydrophobic organic solvents include alcohol-based hydrophobic organic solvents, such as 1-hexanol, 1-octanol, 2-octanol, 2-ethyl-1-hexanol, 1-decanol, benzyl alcohol, ethylene glycol mono-2-ethylhexyl ether, propylene glycol mono-n-butyl ether, dipropylene glycol mono-n-butyl ether, tripropylene glycol mono-n-butyl ether, propylene glycol mono-2-ethylhexyl ether, and propylene glycol mono-phenyl ether; hydrocarbon-based hydrophobic organic solvents, such as rubber volatile oil, mineral spirits, toluene, xylene, and solvent naphtha; ester-based hydrophobic organic solvents, such as n-butyl acetate, isobutyl acetate, isoamyl acetate, methylamyl acetate, ethylene glycol monobutyl ether acetate; and ketone-based hydrophobic organic solvents, such as methyl isobutyl ketone, cyclohexanone, ethyl n-amyl ketone, and diisobutyl ketone. Among these hydrophobic organic solvents, one type may be used alone or two or more types may be used in a combination.

From the viewpoint of improving the smoothness, image clarity, and brightness of the resulting multilayer coating film, as at least one type of the hydrophobic organic solvent, an alcohol-based hydrophobic organic solvent is preferably contained, and an alcohol-based hydrophobic organic solvent having from 7 to 14 carbons is more preferably contained. Among these hydrophobic organic solvents, at least one type of alcohol-based hydrophobic organic solvent selected from the group consisting of 1-octanol, 2-octanol, 2-ethyl-1-hexanol, ethylene glycol mono-2-ethylhexyl ether, propylene glycol mono-n-butyl ether and dipropylene glycol mono-n-butyl ether is preferably contained, and at least one type of alcohol-based hydrophobic organic solvent selected from the group consisting of 1-octanol, 2-ethyl-1-hexanol and ethylene glycol mono-2-ethylhexyl ether is more preferably contained. Among these, 2-ethyl-1-hexanol and/or ethylene glycol mono-2-ethylhexyl ether is preferably contained, and 2-ethyl-1-hexanol is particularly preferably contained.

When the water-based paint composition of the present invention contains the hydrophobic organic solvent described above, the blended amount of the hydrophobic organic solvent is preferably in a range from 2 to 70 parts by mass, and more preferably in a range from 3 to 60 parts by mass, per 100 parts by mass of the total solid content of the binder component in the first water-based paint (P1). Within this range, the blended amount of the hydrophobic organic solvent is preferably in a range from 4 to 50 parts by mass, and more preferably in a range from 5 to 45 parts by mass.

Various additives and the like can be blended, as appropriate, into the first water-based paint (P1), with examples of the various additives including a thickener, a curing catalyst, a defoaming agent, an antioxidant, a UV absorber, a light stabilizer, a surface conditioner, and a pigment dispersing agent.

Examples of the above-mentioned thickener include acrylic associative thickeners, such as an acrylic resin having a hydrophilic moiety and a hydrophobic moiety, preferably an acrylic resin having a hydrophilic acrylic main chain and a hydrophobic side chain; urethane associative thickeners having a hydrophobic moiety, a urethane bond, and a polyether chain per molecule, and effectively exhibiting, in an aqueous medium, a thickening action through association of the hydrophobic moieties (examples of commercially available urethane associative thickeners include Adeka NOL UH-814N, Adeka NOL UH-462, Adeka NOL UH-420, Adeka NOL UH-472, Adeka NOL UH-540, and Adeka NOL UH-756VF available from Adeka Corporation, and SN Thickener 612, SN Thickener 621N, SN Thickener 625N, and SN Thickener 627N available from San Nopco Ltd.); inorganic thickeners, such as silicates, metal silicates, montmorillonite, organic montmorillonite, and colloidal alumina; polyacrylic acid-based thickeners, such as sodium polyacrylate, and polyacrylic acid-(meth)acrylate copolymers; cellulose derivative-based thickeners, such as carboxymethyl cellulose, methyl cellulose, and hydroxyethyl cellulose; protein-based thickeners, such as casein, sodium caseinate, and ammonium caseinate; alginic acid-based thickeners, such as sodium alginate; polyvinyl-based thickeners, such as polyvinyl alcohol, polyvinylpyrrolidone, and polyvinyl benzyl ether copolymers; polyether-based thickeners, such as pluronic polyether, polyether dialkyl ester, polyether dialkyl ether, and polyether epoxy-modified products; maleic anhydride copolymer-based thickeners, such as partial esters of vinyl methyl ether-maleic anhydride copolymers; and polyamide-based thickeners, such as polyamide amine salts. Of these thickeners, use of an acrylic associative thickener and/or a urethane associative thickener is preferable, and use of an acrylic associative thickener is particularly preferable. Among these thickeners, one type may be used alone, or two or more types may be used in combination.

The first water-based paint (P1) can be prepared by dissolving or dispersing the aforementioned components in water or a medium (aqueous medium) containing water as a main component. From viewpoints such as dripping resistance, image clarity, and brightness, the paint solid content concentration (NV_{P1}) of the first water-based paint (P1) is appropriately in a range from 16 to 60 mass %, preferably in a range from 18 to 55 mass %, and more preferably in a range from 20 to 53 mass %.

The water swelling percentage of the first water-based paint (P1) at a cured film thickness of 20 m of a coating film formed therefrom is less than or equal to 100%. When the coating film formed by the first water-based paint (P1) exhibits a water swelling percentage within this predetermined range, the dripping resistance, image clarity, and brightness of the multilayer coating film that is formed can be improved.

In the present specification, the water swelling percentage at a cured film thickness of 20 μm of the coating film formed from the first water-based paint (P1) refers to the water swelling percentage of the coating film produced by applying the first water-based paint (P1) such that the cured film thickness becomes 20 μm, setting the coating film for 3 minutes under conditions including a temperature of 23° C. and a relative humidity of 68% RH, and then, heating the set coating film at 65° C. for 1 minute, and then further setting at 23° C. and 68% RH such that the temperature of the coated sheet becomes 23° C., and then immersing the coated sheet in deionized water at 23° C. for 30 seconds. More specifically, the water swelling percentage refers to a value that is measured as follows.

First, a 50 mm×90 mm coated sheet coated with an electrodeposition paint composition for an automobile body and degreased using isopropanol is weighed, and the mass thereof is denoted by a. The first water-based paint (P1) is applied by a rotary atomizing method using an automatic coating machine onto the coated sheet coated with the electrodeposition paint composition for an automobile body such that the cured coating thickness becomes 20 μm. The coated sheet is then set for 3 minutes in an air-conditioned booth (23° C., 68% RH) and then preheated for 1 minute at 65° C., and the mass is measured. The measured mass is denoted by b. Subsequently, the coated sheet is immersed in deionized water at 23° C. for 30 seconds. The coated sheet is then removed from the deionized water, after which the deionized water on the coated sheet is wiped off with a rag, and the mass of the coated sheet is measured and denoted by c.

A value calculated by the following equation is then defined to be the water swelling percentage in the present specification.

$$Water swelling percentage ( \% ) = \{ ( c - b ) / ( b - a ) \} \times 100 \qquad ( 1 )$$

When the water swelling percentage at a cured film thickness of 20 m exceeds 100%, the dripping resistance, image clarity, and brightness of the formed multilayer coating film may be reduced. The water swelling percentage at a cured film thickness of 20 m of the coating film formed from the first water-based paint (P1) is preferably less than or equal to 90%, more preferably less than or equal to 80%, and even more preferably less than or equal to 70%.

As necessary, the first water-based paint (P1) can be applied using a known coating method, such as electrostatic coating, air spraying, or air-less spraying.

The film thickness of the first coating film formed from the first water-based paint (P1) is, in terms of a cured film thickness (T_{P1}), in a range from 5 to 20 μm, preferably in a range from 6 to 16 μm, and more preferably in a range from 8 to 14 m. By adjusting the film thickness of the first coating film formed from the first water-based paint (P1) to within the predetermined range, a multilayer coating film having excellent dripping resistance, image clarity, and brightness can be formed.

The first coating film is left uncured and supplied to the formation of the second colored coating film in the next step (2), after which in a step (4) described below, the first coating film, the second colored coating film, and the clear coating film formed in steps (1) to (3) are heated and cured together. Also, if necessary, before the second colored coating film is formed in the next step (2), the first coating film may be directly or indirectly heated through a method such as the preheating or air blowing at a temperature of from approximately 40° C. to approximately 100° C. and preferably from approximately 50° C. to approximately 90° C. for around 30 seconds to 20 minutes. In this process, heating is preferably not implemented between the above-described steps (1) and (2) from viewpoints such as reduction in usage energy, shortening of the coating line, and adhesion of the multilayer coating film that is formed.

### Formation of Second Colored Coating Film

In step (2), a second water-based colored paint (P2) that is a water-based paint is applied onto the uncured first coating film produced in step (1), and a second colored coating film having a cured film thickness (T_{P2}) in a range from 0.5 to 7 μm is formed. Here, the second water-based colored paint (P2) is a water-based colored paint containing a binder component (A_{P2}) and an effect pigment (B_{P2}), and has a specific paint solid content concentration (NV_{P2}).

As the binder component (A_{P2}) used in the second water-based colored paint (P2), a resin composition containing a coating film-forming resin commonly used in paints can be used. As such a resin composition, a thermosetting resin composition can be suitably used, and specifically, for example, a thermosetting resin composition in which a base resin having a crosslinkable functional group such as a hydroxyl group is used in combination with a curing agent can be used. Examples of the base resin having a crosslinkable functional group include an acrylic resin, a polyester resin, an alkyd resin, and a urethane resin, and examples of the curing agent include a melamine resin, a urea resin, and a polyisocyanate compound (including a blocked polyisocyanate compound).

Of these, from the viewpoint of brightness and smoothness of the multilayer coating film that is formed, as at least one type of the base resin, the base resin preferably includes at least one type of resin selected from the group consisting of a hydroxyl group-containing acrylic resin, a hydroxyl group-containing polyester resin, and a urethane resin, more preferably includes at least one type of resin selected from the group consisting of a hydroxyl group-containing acrylic resin and a hydroxyl group-containing polyester resin, and particularly preferably includes a hydroxyl group-containing acrylic resin.

The effect pigment (B_{P2}) blended in the second water-based colored paint (P2) is a pigment that is used for the purpose of imparting brightness to the coating film. The effect pigment (B_{P2}) is preferably a scaly pigment. Such an effect pigment is not particularly limited, and among effect pigments used in the paint field, one type may be used, or two or more types may be used in combination. Specific examples of such effect pigments include aluminum flake pigments, vapor-deposited aluminum flake pigments, metal oxide-coated aluminum flake pigments, colored aluminum flake pigments, metal oxide-coated mica pigments, metal oxide-coated aluminum oxide flake pigments, metal oxide-coated glass flake pigments, and metal oxide-coated silica flake pigments. Also, for example, titanium oxide, iron oxide, and the like can be used as the metal oxide that covers the effect pigment.

Of these, from viewpoints such as brightness and smoothness of the multilayer coating film that is formed, at least one type of effect pigment selected from the group consisting of aluminum flake pigments, vapor-deposited aluminum flake pigments, colored aluminum flake pigments, metal oxide-coated mica pigments, and metal oxide-coated aluminum oxide flake pigments is preferably used as the effect pigment (B_{P2}).

From viewpoints such as brightness, image clarity, and smoothness of the multilayer coating film that is formed, the content proportions of the binder component (A_{P2}) and the effect pigment (B_{P2}) in the second water-based colored paint (P2) are such that per 100 parts by mass of the solid content of the binder component (A_{P2}), the content of the effect pigment (B_{P2}) is preferably in a range from 5 to 550 parts by mass, more preferably in a range from 15 to 400 parts by mass, and particularly preferably in a range from 20 to 350 parts by mass.

Also, for the second water-based colored paint (P2), from viewpoints such as the brightness, image clarity, and smoothness of the multilayer coating film that is formed, the content proportion of the effect pigment (B_{P2}) in the second water-based colored paint (P2) is, based on the paint solid content in the second water-based colored paint (P2), preferably in a range from 4 to 85 mass %, more preferably in a range from 10 to 80 parts by mass, and particularly preferably in a range from 15 to 75 parts by mass.

Various additives such as a curing catalyst, a defoaming agent, an antioxidant, a UV absorber, a light stabilizer, a thickener, a surface conditioner, and a pigment dispersing agent, and pigments besides the effect pigment (B_{P2}), such as a coloring pigment and an extender pigment, can be blended, as appropriate and as necessary into the second water-based colored paint (P2).

The second water-based colored paint (P2) can be prepared by dissolving or dispersing the aforementioned components in water or a medium (aqueous medium) containing water as a main component. Also, in the second water-based colored paint (P2), the paint solid content concentration (NV_{P2}) is in a range greater than or equal to 1 mass % and less than 20 mass %. An effect of enabling formation of a multilayer coating film with excellent dripping resistance, image clarity, brightness, smoothness and the like can be achieved by adjusting the paint solid content concentration (NV_{P2}) to within this range. From viewpoints such as the dripping resistance, image clarity, brightness, and smoothness of the multilayer coating film that is formed, the paint solid content concentration (NV_{P2}) is preferably in a range from 2 to 17 mass %, and more preferably in a range from 3 to 14 mass %. Among these ranges, the paint solid content concentration (NV_{P2}) is preferably in a range from 4 to 10 mass %, and is particularly preferably in a range from 5 to 7 mass %.

As necessary, the second water-based colored paint (P2) can be applied using a known coating method, such as electrostatic coating, air spraying, or air-less spraying.

The film thickness of the second colored coating film formed from the second water-based colored paint (P2) is, in terms of a cured film thickness (T_{P2}), preferably in a range from 0.5 to 7 μm, and more preferably in a range from 0.7 to 5 μm. Within this range, the film thickness thereof is preferably within a range from 0.8 to 4 μm, and more preferably within a range from 0.9 to 3 μm. By adjusting the film thickness of the second colored coating film formed from the second water-based paint (P2) to within this certain range, a multilayer coating film having excellent dripping resistance, image clarity, smoothness, and brightness can be formed along with the first coating film.

The second colored coating film is left uncured and supplied to the formation of a clear coating film in the next step (3). Further, in a step (4) described below, the first coating film, the second colored coating film, and the clear coating film formed in steps (1) to (3) are heated and cured together. In addition, as necessary, before the formation of the clear coating film in the next step (3), the second colored coating film may be dried by a procedure such as preheating or air blowing to an extent of being substantially not cured, or the solid content percentage may be adjusted to such an extent that the second colored coating film is not dried.

The preheating can be implemented by a known heating apparatus, and for example, a drying furnace, such as a hot air furnace, an electric furnace, or an infrared induction heating furnace, may be used. The preheating can ordinarily be implemented by directly or indirectly heating the object coated with the second water-based colored paint (P2) in a drying furnace at a temperature of from 40 to 100° C., preferably from 50 to 90° C., and more preferably from 60 to 80° C. for 30 seconds to 20 minutes, preferably from 1 to 15 minutes, and more preferably from 2 to 10 minutes.

In addition, the air blowing can be normally implemented by blowing air of room temperature or heated to a temperature of from approximately 25° C. to approximately 80° C. onto the coated surface of the coated object for 30 seconds to 15 minutes.

Of these, from viewpoints such as the dripping resistance, image clarity, and brightness of the multilayer coating film that is formed, preheating is preferably implemented between step (2) and step (3).

### Formation of Clear Coating Film

In the present invention, a clear coat paint (P3) is applied onto the uncured second colored coating film formed in step (2), and thereby a clear coating film is formed (step (3)).

As the clear coat paint (P3), for example, a known clear coat paint ordinarily used to paint a vehicle body can be used, and specific examples include organic solvent-based thermosetting paints, water-based thermosetting paints, and thermosetting powdered paints, containing, as vehicle components, a base resin having a crosslinkable functional group such as a hydroxyl group, a carboxyl group, an epoxy group, or a silanol group, and a crosslinking agent. Examples of the base resin include an acrylic resin, a polyester resin, an alkyd resin, a urethane resin, an epoxy resin, and a fluororesin, and examples of the crosslinking agent include melamine resin, urea resin, a polyisocyanate compound that may be blocked, a carboxyl group-containing compound or resin, and an epoxy group-containing compound or resin. Among these, an organic solvent-based thermosetting paint containing a carboxyl group-containing resin and an epoxy group-containing resin, or a thermosetting paint containing a hydroxyl group-containing acrylic resin and a polyisocyanate compound that may be blocked is suitable. The clear coat paint may be a one-component paint or a two-component paint, such as a two-component urethane resin paint.

Furthermore, the clear coat paint (P3) described above may contain, as necessary in a range in which the transparency is not inhibited, a coloring pigment, an effect pigment, a dye, a matting agent, or the like, and may further contain, as appropriate, an extender pigment, a UV absorber, a light stabilizer, a defoaming agent, a thickener, a rust inhibitor, a surface conditioner, and the like.

The clear coat paint (P3) can be applied by a known method, such as by air-less spraying, air spraying, and using a rotary atomizing coater, and electrostatic application may be implemented during coating.

The clear coat paint (P3) can be applied such that the film thickness thereof is typically in a range from 10 to 80 μm, preferably from 15 to 60 m, and more preferably from 20 to 50 μm, based on the cured film thickness. Also, from viewpoints such as preventing the occurrence of coating film defects, after the clear coat paint (P3) has been applied, as necessary, the clear coat paint (P3) may be left at room temperature for an approximate interval of from 1 to 60 minutes, or the clear coat paint (P3) may be preheated at a temperature of from approximately 40° C. to approximately 80° C. for around 1 to 60 minutes.

### Heating and Curing of Coating Film

In step (4), the multilayer coating film including the first coating film formed in step (1), the second colored coating film formed in step (2), and the clear coating film formed in step (3) is heated to thereby cure, all at once, the multilayer coating film containing these three coating films. When an object to be coated on which an uncured intermediate coating film is formed is used as the object to be coated, as already described above, four layers including the intermediate coating film, the first coating film, the second colored coating film, and the clear coating film can be simultaneously cured. The heating can be implemented, for example, by hot air heating, infrared heating, high frequency heating, and the like. The heating temperature is preferably from 60 to 160° C., more preferably from 80 to 150° C., and particularly preferably from 100 to 140° C. Furthermore, the heating time is preferably from 10 to 60 minutes, and more preferably from 15 to 40 minutes.

### Formed Multilayer Coating Film

The multilayer coating film that is formed by the steps described above has a layered structure of three layers including the first coating film formed on an object to be coated, the second colored coating film, and the clear coating film, or of four layers including the intermediate coating film, the first coating film, the second colored coating film, and the clear coating film. The method of the present invention employs a method of simultaneously curing the three layers of the first coating film, the second colored coating film, and the clear coating film, or the four layers of the intermediate coating film, the first coating film, the second colored coating film, and the clear coating film. The method uses the first water-based paint (P1) and the second colored water-based paint (P2) having specific compositions and properties to form the first coating film and the second colored coating film having specific properties, film thicknesses, and the like, enabling the formation of a multilayer coating film having excellent dripping resistance, image clarity, and brightness.

The reasons why the present invention enables the formation of a multilayer coating film having excellent dripping resistance, image clarity, and brightness are not fully obvious, but the following is inferred as one of the reasons thereof. That is, it is presumed that when a paint having a water swelling percentage less than or equal to 100% at a cured film thickness of the coating film of 20 μm is used as the first water-based paint (P1), an uncured first coating film that is relatively impermeable to water is formed, and therefore even if the second water-based colored paint (P2) having a relatively low paint solid content concentration (NV_{P2}) and a relatively high water content is applied onto the uncured first coating film, transfer of water from the second water-based colored paint (P2) to the uncured first coating film is suppressed, the viscosity of the uncured first coating film is less likely to decrease, and the dripping resistance is improved. In addition, it is presumed that the suppressed transfer of water from the second water-based colored paint (P2) to the uncured first coating film also suppresses layer mixing between the uncured first coating film and the uncured second colored coating film, and the interface between the uncured first coating film and the uncured second colored coating film is less likely to be disturbed, and thereby image clarity is improved. Furthermore, since the interface between the uncured first coating film and the uncured second colored coating film is less likely to be disturbed, the effect pigment (B_{P2}) in the second water-based colored paint (P2) is more likely to be oriented in parallel on the uncured first coating film in the drying process, and thus it is presumed that a second colored coating film having excellent brightness is formed. Furthermore, it is presumed that as a result of these, a multilayer coating film excelling in dripping resistance, image clarity, and brightness is formed.

### EXAMPLES

The present invention will next be described in more detail with reference to Production Examples, Examples, and Comparative Examples. However, the present invention is not limited by these examples only. In each example, “parts” and “%” are based on mass unless otherwise specified. Also, the film thickness of the coating film is based on the cured film thickness.

### Production of Intermediate Coating Paint

### Production Example 1: Production of Hydroxyl Group-Containing Polyester Resin

A reaction vessel equipped with a thermometer, a thermostat, a stirrer, a reflux condenser, and a water separator was charged with 174 parts of trimethylolpropane, 327 parts of neopentyl glycol, 352 parts of adipic acid, 109 parts of isophthalic acid, and 101 parts of 1,2-cyclohexane dicarboxylic anhydride, and the temperature was raised from 160° C. to 230° C. over 3 hours. And then, while the resulting condensed water was distilled off using the water separator, the temperature was maintained at 230° C., and the mixture was reacted until the acid value became less than or equal to 3 mg KOH/g. To this reaction product, 59 parts of trimellitic anhydride were added, the mixture was subjected to an addition reaction at 170° C. for 30 minutes, after which the mixture was cooled to less than or equal to 50° C., and 2-(dimethylamino)ethanol was added in an amount equivalent to the acid groups to neutralize the mixture. And then, deionized water was gradually added, resulting in the formation of a hydroxyl group-containing polyester resin (PE-1) solution having a solid content concentration of 45% and a pH of 7.2. The resulting hydroxyl group-containing polyester resin had an acid value of 35 mg KOH/g, a hydroxyl value of 128 mg KOH/g, and a weight average molecular weight of 13000.

### Production Example 2: Production of Hydroxyl Group-Containing Acrylic Resin

A reaction vessel equipped with a thermometer, a thermostat, a stirrer, a reflux condenser, a nitrogen inlet tube, and a dripping device was charged with 35 parts of propylene glycol monopropyl ether, and the temperature was raised to 85° C. Subsequently, a mixture of 30 parts of methyl methacrylate, 20 parts of 2-ethylhexyl acrylate, 29 parts of n-butyl acrylate, 15 parts of 2-hydroxyethyl acrylate, 6 parts of acrylic acid, 15 parts of propylene glycol monopropyl ether, and 2.3 parts of 2,2′-azobis(2,4-dimethylvaleronitrile) was added dropwise over 4 hours, and after completion of the dropwise addition, the mixture was aged for 1 hour. A mixture of 10 parts of propylene glycol monopropyl ether and 1 part of 2,2′-azobis(2,4-dimethylvaleronitrile) was then further added dropwise over 1 hour, and after completion of the dropwise addition, the mixture was aged for 1 hour. Furthermore, 7.4 parts of diethanolamine and 13 parts of propylene glycol monopropyl ether were added, resulting in the formation of a hydroxyl group-containing acrylic resin solution (A-1) having a solid content of 55%. The resulting hydroxyl group-containing acrylic resin had an acid value of 47 mg KOH/g and a hydroxyl value of 72 mg KOH/g.

### Production Example 3: Production of Titanium Dioxide Pigment Dispersion

56 parts (25 parts in terms of resin solid content) of the hydroxyl group-containing polyester resin solution (PE-1) produced in Production Example 1, 90 parts of “JR-806” (trade name, available from Tayca Co., Ltd., rutile titanium dioxide), and 5 parts of deionized water were taken into a stirring and mixing vessel, 2-(dimethylamino)ethanol was further added, and the pH was adjusted to 8.0. The resulting mixed solution was then taken into a wide-mouth glass bottle, glass beads with a diameter of about 1.3 mm were placed there as a dispersion media, and the wide-mouth glass bottle was sealed. The contents were dispersed with a paint shaker for 30 minutes, resulting in the formation of a titanium dioxide pigment dispersion (X-1).

### Production Example 4: Production of Black Pigment Dispersion

18 parts (10 parts in terms of resin solid content) of the hydroxyl group-containing acrylic resin solution (A-1) produced in Production Example 2, 10 parts of “Carbon MA-100” (trade name, available from Mitsubishi Chemical Corporation, carbon black pigment), and 60 parts of deionized water were mixed, and the pH was adjusted to 8.2 using 2-(dimethylamino)ethanol, after which the mixture was dispersed with a paint shaker for 30 minutes, resulting in the formation of a black pigment dispersion (X-2).

### Production Example 5: Production of Extender Pigment Dispersion

18 parts (10 parts in terms of resin solid content) of the hydroxyl group-containing acrylic resin solution (A-1) produced in Production Example 2, 25 parts of “Barifine BF-20” (trade name, available from Sakai Chemical Industry Co., Ltd., barium sulfate pigment), 0.6 parts (0.3 parts in terms of solid content) of “Surfynol 104A” (trade name, available from Evonik Industries AG, defoaming agent, solid content of 50%), and 36 parts of deionized water were mixed and dispersed with a paint shaker for one minute, resulting in the formation of an extender pigment dispersion (X-3).

### Production Example 6: Production of Water-Based Intermediate Coating Paint

54.9 parts (24.7 parts in terms of resin solid content) of the hydroxyl group-containing polyester resin solution (PE-1) produced in Production Example 1, 2.5 parts (1.4 parts in terms of resin solid content) of the hydroxyl group-containing acrylic resin solution (A-1) produced in Production Example 2, 42.9 parts (15 parts in terms of resin solid content) of “Ucoat UX-8100” (trade name, available from Sanyo Chemical Industries, Ltd., urethane emulsion, solid content of 35%), 37.5 parts (30 parts in terms of resin solid content) of “Cymel 325” (trade name, available from Allnex GmbH, melamine resin, solid content of 80%), 26.3 parts (10 parts in terms of resin solid content) of “Bayhydur VP LS 2310” (trade name, available from Sumika Covestro Urethane Co., Ltd., blocked polyisocyanate compound, solid content of 38%), 16.7 parts (10 parts in terms of titanium dioxide pigment, 2.8 parts in terms of solid content of the hydroxyl group-containing polyester resin (PE-1)) of the titanium dioxide pigment dispersion (X-1) produced in Production Example 3, 15 parts (1.7 parts in terms of carbon black pigment, 1.7 parts in terms of solid content of the hydroxyl group-containing acrylic resin (A-1)) of the black pigment dispersion (X-2) produced in Production Example 4, and 115 parts (36 parts in terms of barium sulfate pigment, 14.4 parts in terms of solid content of the hydroxyl group-containing acrylic resin (A-1)) of the extender pigment dispersion (X-3) produced in Production Example 5 were homogeneously mixed. Subsequently, “Primal ASE-60” (trade name, available from The Dow Chemical Company, thickener), 2-(dimethylamino)ethanol and deionized water were added to the resulting mixture, resulting in the formation of a water-based intermediate coating paint (PR-1) with a pH of 8.0, a paint solid content concentration of 48%, and a viscosity of 1300 mPa·sec as measured using a Brookfield viscometer (type B viscometer) under measurement conditions including a temperature of 20° C. and a rotational speed of 6 revolutions per minute (6 rpm). The “LVDV-I” (trade name, available from Brookfield Engineering Co., Ltd.) was used as the Brookfield viscometer (type B viscometer).

### Production Example 7: Production of Water-Dispersible Hydroxyl Group-Containing Acrylic Resin (A1)

A reaction vessel equipped with a thermometer, a thermostat, a stirrer, a reflux condenser, a nitrogen gas inlet tube, and a dripping device was charged with 128 parts of deionized water and 3 parts of “Adeka Reasoap SR-1025” (trade name, available from Adeka Corporation, an emulsifier, active ingredient 25%), the contents were mixed by stirring in a nitrogen stream, and the temperature was raised to 80° C.

Subsequently, an amount of 1% of the total amount of a monomer emulsion for a core portion described below and 5.3 parts of a 6% ammonium persulfate aqueous solution were introduced into the reaction vessel, and the reaction vessel was maintained at 80° C. for 15 minutes. And then, the remaining portion of the emulsion for the core portion was added dropwise over 3 hours into the reaction vessel maintained at the same temperature, and after completion of the dropwise addition, the mixture was aged for 1 hour. A monomer emulsion for a shell portion described below was then added dropwise over 1 hour, and the mixture was aged for 1 hour, after which the mixture was cooled to 30° C. while 40 parts of a 5% 2-(dimethylamino)ethanol aqueous solution was gradually added to the reaction vessel. The mixture was discharged while being filtered with a 100-mesh nylon cloth, resulting in the formation of an aqueous dispersion of a water-dispersible hydroxyl group-containing acrylic resin (A-2) having an average particle size of 100 nm and a solid content of 30%. The resulting water-dispersible hydroxyl group-containing acrylic resin (A-2) had an acid value of 12 mg KOH/g and a hydroxyl value of 69 mg KOH/g. Furthermore, the water-dispersible hydroxyl group-containing acrylic resin (A-2) corresponds to a water-dispersible hydroxyl group-containing acrylic resin (A11′) having an acid value less than or equal to 20 mg KOH/g and having a core/shell multilayer structure with a crosslinked core portion.

Monomer emulsion for core portion: A monomer emulsion for the core portion was produced by mixing and stirring 40 parts of deionized water, 2.8 parts of “Adeka Reasoap SR-1025”, 2 parts of ethylene glycol dimethacrylate, 1 part of allyl methacrylate, 7 parts of n-butyl acrylate, 31 parts of n-butyl methacrylate, 11 parts of styrene, 8 parts of methyl methacrylate, and 10 parts of 2-hydroxyethyl methacrylate.

Monomer emulsion for shell portion: A monomer emulsion for the shell portion was produced by mixing and stirring 17 parts of deionized water, 1.2 parts of “Adeka Reasoap SR-1025”, 0.03 parts of ammonium persulfate, 5.4 parts of 2-hydroxyethyl acrylate, 12 parts of methyl methacrylate, 8 parts of ethyl acrylate, 1.9 parts of methacrylic acid, and 2.7 parts of styrene.

### Production Example 8: Production of Water-Dispersible Hydroxyl Group-Containing Acrylic Resin (A1)

A reaction vessel equipped with a thermometer, a thermostat, a stirrer, a reflux condenser, a nitrogen gas inlet tube, and a dripping device was charged with 128 parts of deionized water and 3 parts of “Adeka Reasoap SR-1025” (trade name, available from Adeka Corporation, an emulsifier, active ingredient 25%), the contents were mixed by stirring in a nitrogen stream, and the temperature was raised to 80° C.

Subsequently, an amount of 1% of the total amount of a monomer emulsion for a core portion described below and 5.3 parts of a 6% ammonium persulfate aqueous solution were introduced into the reaction vessel, and the reaction vessel was maintained at 80° C. for 15 minutes. And then, the remaining portion of the emulsion for the core portion was added dropwise over 3 hours into the reaction vessel maintained at the same temperature, and after completion of the dropwise addition, the mixture was aged for 1 hour. A monomer emulsion for a shell portion described below was then added dropwise over 1 hour, and the mixture was aged for 1 hour, after which the mixture was cooled to 30° C. while 40 parts of a 5% 2-(dimethylamino)ethanol aqueous solution was gradually added to the reaction vessel. The mixture was discharged while being filtered with a 100-mesh nylon cloth, resulting in the formation of an aqueous dispersion of a water-dispersible hydroxyl group-containing acrylic resin (A-3) having an average particle size of 95 nm and a solid content of 30%. The resulting water-dispersible hydroxyl group-containing acrylic resin had an acid value of 33 mg KOH/g and a hydroxyl value of 25 mg KOH/g. Furthermore, the water-dispersible hydroxyl group-containing acrylic resin (A-3) corresponds to a water-dispersible hydroxyl group-containing acrylic resin (A11) having the core/shell multilayer structure with a crosslinked core portion.

Monomer emulsion for core portion: A monomer emulsion for the core portion was produced by mixing and stirring 40 parts of deionized water, 2.8 parts of “Adeka Reasoap SR-1025”, 2.1 parts of methylene bisacrylamide, 21 parts of n-butyl acrylate, 2.8 parts of styrene, 16.1 parts of methyl methacrylate, and 28 parts of ethyl acrylate.

Monomer emulsion for shell portion: A monomer emulsion for the shell portion was produced by mixing and stirring 17 parts of deionized water, 1.2 parts of “Adeka Reasoap SR-1025”, 0.03 parts of ammonium persulfate, 5.1 parts of 2-hydroxyethyl acrylate, 6 parts of methyl methacrylate, 1.8 parts of ethyl acrylate, 5.1 parts of methacrylic acid, 3 parts of styrene, and 9 parts of n-butyl acrylate.

The content proportions of polymerizable unsaturated monomers of the water-dispersible hydroxyl group-containing acrylic resins (A-2) and (A-3) are presented in Table 1 below.

TABLE 1

| Production Examples | | | | | 7 | 8 |
|---|---|---|---|---|---|---|
| Name of water-dispersible hydroxyl group-containing acrylic resin (A1) | | | | | A-2 | A-3 |
| Deionized water | | | | | 128 | 128 |
| “Adeka Reasoap SR-1025” | | | | | 3 | 3 |
| 6% ammonium persulfate aqueous solution | | | | | 5.3 | 5.3 |
| Monomer | Deionized water | | | | 40 | 40 |
| emulsion for | “Adeka Reasoap SR-1025” | | | | 2.8 | 2.8 |
| core portion | Polymerizable unsaturated monomer (c) having at least two | | | Ethylene glycol | 2 | |
| | polymerizable unsaturated groups per molecule | | | dimethacrylate | | |
| | | | | Allyl methacrylate | 1 | |
| | | | | Methylene bisacrylamide | | 2.1 |
| | Polymerizable | Polymerizable unsaturated monomer | butyl | n-butyl acrylate | 7 | 21 |
| | unsaturated | (d1) having one polymerizable | (meth)- | n-butyl methacrylate | 31 | |
| | monomer (d) | unsaturated group per molecule and | acrylate | Styrene | 11 | 2.8 |
| | having one | having a hydrocarbon group | | | | |
| | polymerizable | having from 4 to 22 carbons | | | | |

| | unsaturated group | | Methyl methacrylate | 8 | 16.1 |
|---|---|---|---|---|---|
| | per molecule | | Ethyl acrylate | | 28 |
| | | | 2-hydroxyethyl | 10 | |
| | | | methacrylate | | |
| Monomer | Deionized water | | | 17 | 17 |
| emulsion for | “Adeka Reasoap SR-1025” | | | 1.2 | 1.2 |
| shell portion | Ammonium persulfate | | | 0.03 | 0.03 |
| | Hydroxyl group-containing polymerizable unsaturated | | 2-hydroxyethyl acrylate | 5.4 | 5.1 |
| | monomer (a) | | 2-hydroxyethyl | | |
| | | | methacrylate | | |
| | Polymerizable | Polymerizable unsaturated monomer (e1) | Methyl methacrylate | 12 | 6 |
| | unsaturated | having an alkyl group having 1 or 2 carbons | Ethyl acrylate | 8 | 1.8 |
| | monomer (e) | Carboxyl group-containing polymerizable | Methacrylic acid | 1.9 | 5.1 |
| | other than | unsaturated monomer (e2) | | | |
| | monomer (a) | | Styrene | 2.7 | 3 |
| | | | n-butyl acrylate | | 9 |

| Average particle size [nm] | | 100 | 95 |
|---|---|---|---|
| Solid content [mass %] | | 30 | 30 |
| Acid value [mg KOH/g] | | 12 | 33 |
| Hydroxyl value [mg KOH/g] | | 69 | 25 |
| Content proportion | Polymerizable unsaturated monomer (c) having at least two | 4.3 | 3.0 |
| [mass %] of each | polymerizable unsaturated groups per molecule | | |
| monomer for core | Polymerizable unsaturated monomer (d) having one polymerizable | 95.7 | 97.0 |
| portion based on total | unsaturated group per molecule | | |
| mass of monomer (c) | Polymerizable unsaturated monomer (d1) having one polymerizable | 70.0 | 34.0 |
| and monomer (d) | unsaturated group per molecule and having a hydrocarbon group | | |
| | having from 4 to 22 carbons | | |
| | butyl (meth)acrylate | 54.3 | 30.0 |
| Content proportion | Hydroxyl group-containing polymerizable unsaturated monomer (a) | 18.0 | 17.0 |
| [mass %] of each | Polymerizable unsaturated monomer (e) other than monomer (a) | 82.0 | 83.0 |
| monomer for shell portion | Polymerizable unsaturated monomer (e1) having an alkyl group having | 66.7 | 26.0 |
| based on total mass of | 1 or 2 carbons | | |
| monomers (a) and (e) | Carboxyl group-containing polymerizable unsaturated monomer (e2) | 6.3 | 17.0 |

### Production Example 9: Production of Acrylic Resin Having Hydroxyl Group and Phosphate Group

A reaction vessel equipped with a thermometer, a thermostat, a stiffer, a reflux condenser, a nitrogen gas inlet tube, and a dripping device was charged with a mixed solvent of 27.5 parts of methoxypropanol and 27.5 parts of isobutanol and heated to 110° C. Subsequently, 121.5 parts of a mixture were added over 4 hours to the mixed solvent, the mixture including 25 parts of styrene, 27.5 parts of n-butyl methacrylate, 20 parts of “isostearyl acrylate” (trade name, available from Osaka Organic Chemical Ind. Ltd., branched higher alkyl acrylate), 7.5 parts of 4-hydroxybutyl acrylate, 15 parts of a phosphate group-containing polymerizable monomer described below, 12.5 parts of 2-methacryloyloxyethyl acid phosphate, 10 parts of isobutanol, and 4 parts of tert-butylperoxy octanoate. A mixture of 0.5 parts of tert-butylperoxy octanoate and 20 parts of isopropanol was then added dropwise over one hour. And then, the resulting mixture was stirred and aged for one hour, resulting in the formation of a solution of an acrylic resin (A-4) having a hydroxyl group and a phosphate group and having a solid content concentration of 50%. The resulting resin had an acid value due to the phosphate group of 83 mg KOH/g, the hydroxyl value of 29 mg KOH/g, and the weight average molecular weight of 10000.

Phosphate group-containing polymerizable monomer: A reaction vessel equipped with a thermometer, a thermostat, a stirrer, a reflux condenser, a nitrogen gas inlet tube, and a dripping device was charged with 57.5 parts of monobutyl phosphate and 41 parts of isobutanol and heated to 90° C., after which 42.5 parts of glycidyl methacrylate were added dropwise over 2 hours, and the mixture was further stirred and aged for 1 hour. And then, 59 parts of isopropanol were added, resulting in the formation of a phosphate group-containing polymerizable monomer solution having a solid content concentration of 50%. The resulting monomer had an acid value of 285 mg KOH/g.

### Production Example 10: Production of Hydroxyl Group-Containing Polyester Resin

A reaction vessel equipped with a thermometer, a thermostat, a stirrer, a reflux condenser, a nitrogen gas inlet tube, and a water separator was charged with 109 parts of trimethylolpropane, 141 parts of 1,6-hexanediol, 126 parts of 1,2-cyclohexane dicarboxylic anhydride, and 120 parts of adipic acid. The temperature was raised from 160° C. to 230° C. over 3 hours, and then a condensation reaction was implemented at 230° C. for 4 hours. Subsequently, to introduce carboxyl groups into the resulting condensation reaction product, 38.3 parts of trimellitic anhydride were added and reacted at 170° C. for 30 minutes, after which the mixture was diluted with 2-ethyl-1-hexanol, resulting in the formation of a hydroxyl group-containing polyester resin (PE-2) solution having a solid content of 70%. The resulting hydroxyl group-containing polyester resin (PE-2) had an acid value of 46 mg KOH/g, a hydroxyl value of 150 mg KOH/g, and a number average molecular weight of 1400. In the raw material composition, the total content of the alicyclic polybasic acid in the acid component was 46 mol % based on the total amount of the acid component.

### Production Example 11: Production of Acrylic-Modified Hydroxyl Group-Containing Polyester Resin

A reactor equipped with a thermometer, a thermostat, a stirrer, a heater, and a rectifier was charged with 18.9 parts of isophthalic acid, 32.4 parts of adipic acid, 0.7 parts of maleic anhydride, 40.3 parts of 1,6-hexanediol, and 5.2 parts of trimethylolpropane, and the temperature was raised to 160° C. while being stirred. Then, the temperature of the contents was gradually raised from 160° C. to 230° C. over 3.5 hours, and the produced condensed water was distilled off through the rectifier. After the reaction was continued at 230° C. for 90 minutes, the rectifier was replaced with a water separator, about 4 parts of toluene was added to the contents, and water and toluene were azeotropically distilled to remove condensed water. Measurement of the acid value was started one hour after the addition of toluene, and when it was confirmed that the acid value became less than 6, heating was stopped, toluene was removed under reduced pressure, then 20 parts of dipropylene glycol monomethyl ether was added for dilution, and 2.1 parts of methoxypolyethylene glycol methacrylate (Mw 1000) was added. Then, the reaction solution was cooled to 130° C., and a mixture of 3 parts of styrene, 3.3 parts of acrylic acid, 6.6 parts of n-butyl acrylate, and 0.75 parts of t-butylperoxy-2-ethylhexanoate was added dropwise over 30 minutes. And then, the mixture was aged at 130° C. for 30 minutes, 0.05 parts of t-butylperoxy-2-ethylhexanoate was added as an additional catalyst, and the mixture was further aged for 1 hour. And then, the reaction solution was cooled to 85° C. and neutralized with dimethylethanolamine, and deionized water was added thereto, resulting in the formation of an aqueous dispersion of a hydroxyl group-containing polyester resin (PE-3) modified with an acrylic resin and having a solid content of 40%. The resulting acrylic-modified hydroxyl group-containing polyester resin (PE-3) had an acid value of 30 mg KOH/g, a hydroxyl value of 68 mg KOH/g, and a number average molecular weight of 3000 (number average molecular weight of polyester portion of 1850).

### Production Example 12: Production of Blocked Polyisocyanate Compound

A reaction vessel equipped with a thermometer, a thermostat, a stirrer, a reflux condenser, a nitrogen-introducing tube, a dropping device, and a simple trap for solvent removal was charged with 360 parts of “Sumidur N-3300” (trade name, available from Sumika Covestro Urethane Co., Ltd., isocyanurate product of hexamethylene diisocyanate, solid content of 100%, isocyanurate group content of 21.8%), 60 parts of “UNIOX M-550” (trade name, available from NOF Corporation, polyethylene glycol monomethyl ether, average molecular weight of about 550), and 0.2 parts of 2,6-di-tert-butyl-4-methylphenol, and contents in the reaction vessel were heated at 130° C. for 3 hours under a nitrogen stream while the contents were thoroughly mixed. Subsequently, 110 parts of ethyl acetate and 252 parts of diisopropyl malonate were charged into the reaction vessel, 3 parts of a 28% methanol solution of sodium methoxide was added to the reaction vessel while the contents were stirred under a nitrogen stream, and the contents in the reaction vessel were stirred at 65° C. for 8 hours. An amount of isocyanate in the resulting resin solution was 0.12 mol/kg. To the resin solution, 683 parts of 4-methyl-2-pentanol were added, and the solvent was distilled off over a period of 3 hours under reduced pressure while the temperature of the system was maintained at 80 to 85° C., resulting in the formation of 1010 parts of a blocked polyisocyanate compound (BNCO-1) solution. The simple trap for solvent removal contained 95 parts of isopropanol. The resulting blocked polyisocyanate compound (BNCO-1) had a solid content concentration of about 60%.

### Production Example 13: Production of Acrylic-Urethane Composite Resin Particles (C)

A reaction vessel equipped with a thermometer, a thermostat, a stirrer, a dripping device, and a reflux condenser was charged with 26.1 parts of “Nippollan 4009” (trade name, available from Tosoh Corporation, polyester polyol having a main composition of butylene adipate, average molecular weight of 1000, solid content of 100%), 35 parts of 2-ethylhexyl acrylate, 0.008 parts of butyl hydroxytoluene, and 0.03 parts of dibutyltin laurate. The temperature was then raised to 90° C., after which 3.9 parts of hexamethylene diisocyanate were added dropwise over 30 minutes. Subsequently, the mixture was maintained at 90° C. and allowed to react until the NCO value became less than or equal to 1 mg/g. To this reactant, 3 parts of n-butyl acrylate and 2 parts of allyl methacrylate were added, resulting in the formation of a hydroxyl group-containing polyurethane resin (c1-1) diluted with acrylic monomers. A urethane resin component of the resulting polyurethane resin had a hydroxyl value of 10 mg KOH/g, and a weight-average molecular weight of 30000.

Subsequently, the following components were put into a glass beaker and stirred for 15 minutes using a disperser at 2000 rpm to produce a preliminary emulsion, and then the preliminary emulsion was subjected to a high-pressure treatment at 100 MPa using a high-pressure emulsifying apparatus, resulting in the formation of a polyurethane-containing acrylic monomer emulsion (1).

### Composition of Monomer Emulsion (1)

70 parts of acrylic monomer-diluted hydroxyl group-containing polyurethane resin (c1-1) 4.7 parts of “Newcol 707SF” (trade name, available from Nippon Nyukazai Co., Ltd., anionic emulsifier having a polyoxyethylene chain, active component of 30%) 65.3 parts of deionized water

Subsequently, 140 parts of the monomer emulsion (1) were transferred to a flask and diluted with 42.5 parts of deionized water. The temperature was increased to 70° C. while the diluted monomer emulsion was stirred, an initiator solution prepared by dissolving 0.2 parts of “VA-057” (trade name, available from Fujifilm Wako Pure Chemical Corporation, water-soluble azo polymerization initiator) in 10 parts of deionized water was added dropwise to the flask over 30 minutes, and the mixture was stirred for 2 hours while the temperature at 70° C. was maintained. And then, a solution in which a monomer emulsion (2) having the composition described below and 0.15 parts of “VA-057” in 7.5 parts of deionized water were dissolved was added dropwise over 1.5 hours, and the mixture was stirred for 1 hour while the temperature was maintained, after which an initiator solution of 0.1 parts of “VA-057” dissolved in 5 parts of deionized water was added to the flask, and the mixture was stirred for 2 hours while the temperature was maintained, and then the mixture was cooled, resulting in the formation of an aqueous dispersion of acrylic-urethane composite resin particles (C-1).

### Composition of Monomer Emulsion (2)

8 parts of 2-ethylhexyl acrylate
4 parts of n-butyl acrylate
14 parts of methyl methacrylate
3.5 parts of 2-hydroxyethyl methacrylate
0.5 parts of acrylic acid
2.0 parts of “Newcol 707SF”
18 parts of deionized water

The resulting acrylic-urethane composite resin particles (C-1) had an acid value of the acrylic resin component of 5.6 mg KOH/g, a hydroxyl value of the acrylic resin component of 21.6 mg KOH/g, and a solid content concentration of 40 mass %.

### Production Examples 14 to 17 and 19

Aqueous dispersions of acrylic-urethane composite resin particles (C-2) to (C-5) and (C-7) were produced in the same manner as in Production Example 13 with the exception that the composition of the monomer emulsion was changed as described in Table 2 below. The acid values and the hydroxyl values of the acrylic resin components of the resulting acrylic-urethane composite resin particles (C-2) to (C-5) and (C-7) are also described in Table 2 below. Note that the aqueous dispersion of the acrylic-urethane composite resin particles (C-7) produced in Production Example 19 is used as a comparative example.

### Production Example 18: Production of Acrylic-Urethane Composite Resin Particles (C)

A reaction vessel equipped with a thermometer, a thermostat, a stirrer, a dripping device, and a reflux condenser was charged with 26.1 parts of “Nippollan 4009” (trade name, available from Tosoh Corporation, polyester polyol having a main composition of butylene adipate, average molecular weight of 1000, solid content of 100%), 43 parts of 2-ethylhexyl acrylate, 0.014 parts of butyl hydroxytoluene, and 0.03 parts of dibutyltin laurate. The temperature was then raised to 90° C., after which 3.9 parts of hexamethylene diisocyanate were added dropwise over 30 minutes. Subsequently, the mixture was maintained at 90° C. and allowed to react until the NCO value became less than or equal to 1 mg/g. To the reaction product, 7 parts of n-butyl acrylate, 2 parts of allyl methacrylate, 14 parts of methyl methacrylate, 3.5 parts of 2-hydroxyethyl methacrylate, and 0.5 parts of acrylic acid were added, resulting in the formation of a hydroxyl group-containing polyurethane resin (c6-1) diluted with acrylic monomers. A urethane resin component of the resulting polyurethane resin had a hydroxyl value of 10 mg KOH/g, and a weight-average molecular weight of 30000.

Subsequently, the following components were put into a glass beaker and stirred for 15 minutes using a disperser at 2000 rpm to produce a preliminary emulsion, and then the preliminary emulsion was subjected to a high-pressure treatment at 100 MPa using a high-pressure emulsifying apparatus, resulting in the formation of a polyurethane-containing acrylic monomer emulsion.

### Composition of Monomer Emulsion

100 parts of the acrylic monomer-diluted hydroxyl group-containing polyurethane resin (c6-1)
6.7 parts of “Newcol 707SF”
93.3 parts of deionized water

Subsequently, 200 parts of the above monomer emulsion were transferred to a flask and diluted with 28.8 parts of deionized water. The temperature was increased to 70° C. while the diluted monomer emulsion was stirred, an initiator solution in which 0.35 parts of “VA-057” was dissolved in 17.5 parts of deionized water was added dropwise to the flask over 30 minutes, and the mixture was stirred for 2 hours while the temperature was maintained. Further, an initiator solution in which 0.175 parts of “VA-057” was dissolved in 8.75 parts of deionized water was added to the flask, and the mixture was stirred for 2 hours while the temperature was maintained, and then the mixture was cooled, resulting in the formation of an aqueous dispersion of acrylic-urethane composite resin particles (C-6).

An acrylic resin component of the resulting acrylic-urethane composite resin particles (C-6) had an acid value of 5.6 mg KOH/g, a hydroxyl value of 21.6 mg KOH/g, and a solid content concentration of 40 mass %.

TABLE 2

| Production Examples | | | | 13 | 14 | 15 | 16 | 17 | 18 | 19 |
|---|---|---|---|---|---|---|---|---|---|---|
| Acrylic-urethane composite resin particles (C) | | | | C-1 | C-2 | C-3 | C-4 | C-5 | C-6 | C-7 |
| Monomer | Urethane resin | “Nippollan 4009” | | 26.1 | | | 25.8 | 25 | 26.1 | 26.1 |
| emulsion (1) | component | “ETERNACOLL UH-100” (Note 1) | | | 26.1 | | | | | |
| | | “PTMG 1000” (Note 2) | | | | 26.1 | | | | |
| | | Hexamethylene diisocyanate | | 3.9 | 3.9 | 3.9 | 2.9 | | 3.9 | 3.9 |
| | | Isophorone diisocyanate | | | | | 1.3 | 5.0 | | |
| | | Hydroxyl value (mg KOH/g) of urethane resin component | | 10 | | | | | | |
| | | Weight average molecular weight of urethane resin component | | 30000 | | | | | | |
| | Acrylic resin | Polymerizable unsaturated | 2-Ethylhexyl acrylate | 35 | 35 | 35 | 35 | 35 | 43 | 35 |
| | component (1) | monomer (c2-1) | n-Butyl acrylate | 3 | 3 | 3 | 3 | 3 | 7 | 3 |
| | | Polymerizable unsaturated | Allyl methacrylate | 2 | 2 | 2 | 2 | 2 | 2 | 2 |
| | | monomer (c2-2) | | | | | | | | |
| | | Polymerizable unsaturated | Methyl methacrylate | | | | | | 14 | |
| | | monomer (c2-3) | 2-Hydroxyethyl methacrylate | | | | | | 3.5 | |
| | | | Acrylic acid | | | | | | 0.5 | |
| | “Newcol 707SF” | | | 4.7 | 4.7 | 4.7 | 4.7 | 4.7 | 6.7 | 4.7 |
| | Deionized water | | | 65.3 | 65.3 | 65.3 | 65.3 | 65.3 | 93.3 | 65.3 |
| Monomer | Acrylic resin | Polymerizable unsaturated | 2-Ethylhexyl acrylate | 8 | 8 | 8 | 8 | 8 | | 8 |
| emulsion (2) | component (2) | monomer (c2-1) | n-Butyl acrylate | 4 | 4 | 4 | 4 | 4 | | 4 |
| | | Polymerizable unsaturated | Methyl methacrylate | 14 | 14 | 14 | 14 | 14 | | 12.3 |
| | | monomer (c2-3) | 2-Hydroxyethyl methacrylate | 3.5 | 3.5 | 3.5 | 3.5 | 3.5 | | 3.5 |
| | | | Acrylic acid | 0.5 | 0.5 | 0.5 | 0.5 | 0.5 | | 2.2 |

| | | | | | | |
|---|---|---|---|---|---|---|
| “Newcol 707SF” | 2.0 | 2.0 | 2.0 | 2.0 | 2.0 | 2.0 |
| Deionized water | 18 | 18 | 18 | 18 | 18 | 18 |

| | | | | | | | |
|---|---|---|---|---|---|---|---|
| Acid value (mg KOH/g) of acrylic resin component | 5.6 | 5.6 | 5.6 | 5.6 | 5.6 | 5.6 | 24.5 |
| Hydroxyl value (mg KOH/g) of acrylic resin component | 21.6 | 21.6 | 21.6 | 21.6 | 21.6 | 21.6 | 21.6 |
| Solid content concentration (%) | 40 | 40 | 40 | 40 | 40 | 40 | 40 |

(Note 1) “ETERNACOLL UC-100”: trade name, available from UBE Corporation, 1,6-hexanediol-based polycarbonate diol, molecular weight of approximately 1000, solid content of 100%.
(Note 2) “PTMG 1000”: trade name, available from Mitsubishi Chemical Corporation, polytetramethylene ether glycol, molecular weight of 1000, solid content of 100%.

### Production Example 20: Production of Acrylic-Urethane Composite Resin Particles (C)

A flask equipped with a thermometer, a thermostat, a stirrer, a dripping device and a reflux condenser was charged with a monomer mixture containing 60 parts (30 parts in terms of solid content) of a polyether-based urethane polymer (trade name: Impranil DLE, available from Sumika Covestro Urethane Co., Ltd., solid content of 50%) as a urethane resin component, 115 parts of deionized water, 35 parts of 2-ethylhexyl acrylate, 3 parts of n-butyl acrylate and 2 parts of allyl methacrylate, and the temperature was raised to 70° C. while the mixture was stirred. And then, as a polymerization initiator, an initiator solution in which 0.2 parts of “VA-057” (trade name, available from Fujifilm Wako Pure Chemical Corporation, a water-soluble azo polymerization initiator) was dissolved in 10 parts of deionized water was added dropwise to the flask over 30 minutes, and the mixture was stirred for 2 hours while the temperature was maintained. And then, a solution in which a monomer emulsion (2) having the composition described below and 0.15 parts of “VA-057” in 7.5 parts of deionized water was dissolved was added dropwise over 1.5 hours, and the mixture was stirred for 1 hour while the temperature was maintained, after which an initiator solution in which 0.1 parts of “VA-057” was dissolved in 5 parts of deionized water was added to the flask, and the mixture was stirred for 2 hours while the temperature was maintained, and then the mixture was cooled, resulting in the formation of an aqueous dispersion of acrylic-urethane composite resin particles (C-8).

### Composition of Monomer Emulsion (2)

8 parts of 2-ethylhexyl acrylate
4 parts of n-butyl acrylate
14 parts of methyl methacrylate
3.5 parts of 2-hydroxyethyl methacrylate
0.5 parts of acrylic acid
2.0 parts of “Newcol 707SF”
18 parts of deionized water

The resulting acrylic-urethane composite resin particles (C-8) had an acid value of the acrylic resin component of 5.6 mg KOH/g, a hydroxyl value of the acrylic resin component of 21.6 mg KOH/g, and a solid content concentration of 35 mass %.

### Production Examples 21 to 25

Aqueous dispersions of acrylic-urethane resin composite particles (C-9) to (C-13) were produced in the same manner as in Production Example 20 with the exception that the compositions of the monomer mixtures and the monomer emulsion (2) were changed as described in Table 3 below. The acid values and the hydroxyl values of the acrylic resin components of the resulting acrylic-urethane composite resin particles (C-9) to (C-13) are also described in Table 3 below. Note that the aqueous dispersion of the acrylic-urethane composite resin particles (C-13) produced in Production Example 25 is used as a comparative example.

TABLE 3

| Production Examples | | | | 20 | 21 | 22 | 23 | 24 | 25 |
|---|---|---|---|---|---|---|---|---|---|
| Acrylic-urethane composite resin particles (C) | | | | C-8 | C-9 | C-10 | C-11 | C-12 | C-13 |
| Urethane resin component | | “Impranil DLE” | | 30 | 30 | 30 | 30 | 30 | 30 |
| Monomer | Acrylic resin | Polymerizable unsaturated | 2-Ethylhexyl acrylate | 35 | 35 | 35 | 35 | 35 | 35 |
| mixture | component (1) | monomer (c2-1) | n-Butyl acrylate | 3 | 3 | 3 | 3 | 3 | 3 |
| | | Polymerizable unsaturated | Allyl methacrylate | 2 | | 2 | 2 | 2 | 2 |
| | | monomer (c2-2) | 1,6-Hexanediol diacrylate | | 2 | | | | |
| Deionized water | | | | 115 | 115 | 115 | 115 | 115 | 115 |
| Monomer | Acrylic resin | Polymerizable unsaturated | 2-Ethylhexyl acrylate | 8 | 8 | 8 | 8 | 8 | 8 |
| emulsion (2) | component (2) | monomer (c2-1) | n-Butyl acrylate | 4 | 4 | 4 | 4 | 4 | 4 |
| | | Polymerizable unsaturated | Methyl methacrylate | 14 | 14 | 17.5 | 13.6 | 13 | 12.3 |
| | | monomer (c2-3) | 2-Hydroxyethyl methacrylate | 3.5 | 3.5 | | 3.5 | 3.5 | 3.5 |
| | | | Acrylic acid | 0.5 | 0.5 | 0.5 | 0.9 | 1.4 | 2.2 |

| | | | | | | |
|---|---|---|---|---|---|---|
| “Newcol 707SF” | 2.0 | 2.0 | 2.0 | 2.0 | 2.0 | 2.0 |
| Deionized water | 18 | 18 | 18 | 18 | 18 | 18 |

| | | | | | | |
|---|---|---|---|---|---|---|
| Acid value (mg KOH/g) of acrylic resin component | 5.6 | 5.6 | 5.6 | 10.0 | 15.6 | 24.5 |
| Hydroxyl value (mg KOH/g) of acrylic resin component | 21.6 | 21.6 | 0.0 | 21.6 | 21.6 | 21.6 |
| Solid content concentration (%) | 35 | 35 | 35 | 35 | 35 | 35 |

### Production Example 26: Production of Macromonomer

A reaction vessel equipped with a thermometer, a thermostat, a stirrer, a reflux condenser, a nitrogen gas inlet tube, and a dripping device was charged with 16 parts of ethylene glycol monobutyl ether and 3.5 parts of 2,4-diphenyl-4-methyl-1-pentene (which may be abbreviated as “MSD” hereinafter), nitrogen gas was then introduced into the gas phase, and the temperature was increased to 160° C. while stirring. Once the temperature reached 160° C., a mixed solution consisting of 30 parts of n-butyl methacrylate, 40 parts of 2-ethylhexyl methacrylate, 30 parts of 2-hydroxyethyl methacrylate, and 7 parts of di-tert-amyl peroxide was added dropwise over 3 hours, after which the mixed solution was stirred at the same temperature for 2 hours. The mixture was then cooled to 30° C. and diluted with ethylene glycol monobutyl ether, resulting in the formation of a macromonomer solution (d1-1) having a solid content of 65%. The resulting macromonomer had a hydroxyl value of 125 mg KOH/g, and a number average molecular weight of 2300. Additionally, the resulting macromonomer was analyzed by proton NMR, and the result showed that greater than or equal to 97% of the ethylenically unsaturated groups derived from the MSD were present at the polymer chain ends, and 2% of the groups thereof were eliminated.

Note that in the analysis by proton NMR described above, deuterated chloroform was used as a solvent, peaks (4.8 ppm, 5.1 ppm) based on protons of unsaturated groups of the MSD, peaks (5.0 ppm, 5.2 ppm) based on protons of ethylenically unsaturated groups at the macromonomer chain ends, and peaks (7.2 ppm) of aromatic protons derived from the MSD were measured before and after the polymerization reaction, after which on the basis of the assumption that the aromatic protons (7.2 ppm) derived from the MSD did not change before and after the polymerization reaction, unsaturated groups (unreacted group, group at macromonomer chain end, eliminated group, respectively) were quantitatively determined.

### Production Example 27: Production of Acrylic Associative Thickener

A reaction vessel equipped with a thermometer, a thermostat, a stirrer, a reflux condenser, a nitrogen gas inlet tube, and two dripping devices was charged with 15.4 parts (10 parts in terms of solid content) of the macromonomer solution produced in Production Example 26, 20 parts of ethylene glycol monobutyl ether, and 30 parts of diethylene glycol monoethyl ether acetate, and the temperature was raised to 85° C. while nitrogen gas was introduced into the liquid. Subsequently, with the reaction vessel maintained at the same temperature, a mixed solution consisting of 31.5 parts of N,N-dimethylacrylamide, 31.5 parts of N-isopropyl acrylamide, 27 parts of 2-hydroxyethyl acrylate, 10 parts of ethylene glycol monobutyl ether, and 40 parts of diethylene glycol monoethyl ether acetate, and a mixed solution consisting of 0.15 parts of “Perbutyl O” (trade name, available from NOF Corporation, polymerization initiator, tert-butylperoxy-2-ethylhexanoate) and 20 parts of ethylene glycol monobutyl ether were simultaneously added dropwise into the reaction vessel over 4 hours, and after dropwise addition was completed, the mixture was stirred and aged for 2 hours at the same temperature. Subsequently, with the reaction vessel maintained at the same temperature, a mixed solution consisting of 0.3 parts of 2,2′-azobis (2,4-dimethylvaleronitrile) and 15 parts of ethylene glycol monobutyl ether was added dropwise over one hour into the reaction vessel, and after dropwise addition was completed, the mixture was stirred and aged at the same temperature for 1 hour. Subsequently, the mixture was cooled to 30° C. while ethylene glycol monobutyl ether is added, resulting in the formation of a copolymer solution having a solid content of 35%. The resulting copolymer had a weight average molecular weight of 310000. 215 parts of deionized water was added to the resulting copolymer solution, resulting in the formation of an acrylic associative thickener diluted solution (RC-1) having a solid content of 20%.

### Production Example 28: Production of First Water-Based Paint (P1)

9.1 parts (5 parts in terms of resin solid content) of the hydroxyl group-containing acrylic resin (A-1) solution produced in Production Example 2, 7.1 parts (5 parts in terms of resin solid content) of the hydroxyl group-containing polyester resin solution (PE-2) produced in Production Example 10, 37.5 parts (15 parts in terms of resin solid content) of an aqueous dispersion of the hydroxyl group-containing polyester resin (PE-3) modified by an acrylic resin and produced in Production Example 11, 120 parts of “JR-806” (trade name, available from Tayca Co., Ltd., rutile titanium dioxide), and 0.3 parts of “Carbon MA-100” (trade name, available from Mitsubishi Chemical Corporation, carbon black) were mixed, and the mixture was adjusted to a pH of 8.0 using 2-(dimethylamino)ethanol, after which the mixture was dispersed using a paint shaker for 30 minutes, resulting in the formation of a pigment-dispersed paste. Subsequently, 174 parts of the resulting pigment-dispersed paste, 50 parts (15 parts in terms of resin solid content) of the aqueous dispersion of the water-dispersible hydroxyl group-containing acrylic resin (A-2) produced in Production Example 7, 34.7 parts (25 parts in terms of resin solid content) of a melamine resin (B1-1) (methyl-butyl mixed etherified melamine resin, solid content of 72%, weight average molecular weight of 750, methyl group/butyl group molar ratio of 65/35), 8.3 parts (5 parts in terms of resin solid content) of the blocked polyisocyanate compound (BNCO-1) produced in Production Example 12, and 85.7 parts (30 parts in terms of resin solid content) of an aqueous dispersion of the acrylic-urethane composite resin particles (C-8) produced in Production Example 20 were uniformly mixed. Subsequently, to the resulting mixture, 2 parts (0.4 parts in terms of resin solid content) of the acrylic associative thickener diluted solution (RC-1) produced in Production Example 27, 2-(dimethylamino) ethanol, and deionized water were added, resulting in the formation of a first water-based paint (P1-1) having a pH of 8.0 and a paint solid content concentration (NV_{P1}) of 50%.

### Production Examples 29 to 51

First water-based paints (P1-2) to (P1-24) having a pH of 8.0 and a paint solid content concentration (NV_{P1}) of 50% were produced in the same manner as Production Example 28 with the exception that the formulation composition of Production Example 28 was changed as indicated in Tables 4 to 6 below. The blending amounts shown in the tables represent solid contents except for solvent components.

TABLE 4

| Production Examples | | | 28 | 29 | 30 | 31 | 32 | 33 | 34 | 35 |
|---|---|---|---|---|---|---|---|---|---|---|
| Name of first water-based paint (P1) | | | P1-1 | P1-2 | P1-3 | P1-4 | P1-5 | P1-6 | P1-7 | P1-8 |
| Pigment- | Hydroxyl | Hydroxyl group-containing acrylic | 5 | 5 | 5 | 5 | 5 | 5 | 5 | 5 |
| dispersed | group-containing | resin (A-1) solution | | | | | | | | |
| paste | acrylic resin (A) | | | | | | | | | |
| | Hydroxyl | Hydroxyl group-containing polyester | 5 | 5 | 5 | 5 | 5 | 5 | 5 | 5 |
| | group-containing | resin (PE-2) solution | | | | | | | | |
| | polyester resin | Acrylic resin-modified hydroxyl group- | 15 | 15 | 15 | 15 | 15 | 15 | 15 | 15 |
| | | containing polyester resin (PE-3) solution | | | | | | | | |
| | Coloring pigment | “JR-806” | 120 | 120 | 120 | 120 | 120 | 120 | 120 | 120 |
| | | “MA-100” | 0.3 | 0.3 | 0.3 | 0.3 | 0.3 | 0.3 | 0.3 | 0.3 |
| | Extender pigment | “MICRO ACE S-3” (Note 3) | | | | | | | | |
| Hydroxyl group- | Water-dispersible | Water-dispersible hydroxyl group-containing | 15 | | 15 | 15 | 15 | 15 | 15 | 15 |
| containing acrylic | hydroxyl group- | acrylic resin (A-2) aqueous dispersion | | | | | | | | |
| resin (A) | containing acrylic | Water-dispersible hydroxyl group-containing | | 15 | | | | | | |
| | resin (A1) | acrylic resin (A-3) aqueous dispersion | | | | | | | | |
| Crosslinking | Melamine resin | Melamine resin (B1-1) | 25 | 25 | | | 25 | 25 | 25 | 25 |
| agent (B) | (B1) | Melamine resin (B1-2) (Note 4) | | | 25 | | | | | |
| | | Melamine resin (B1-3) (Note 5) | | | | 25 | | | | |
| | Blocked | Blocked polyisocyanate compound | 5 | 5 | 5 | 5 | 5 | 5 | 5 | 5 |
| | polyisocyanate | (BNCO-1) solution | | | | | | | | |
| | compound | | | | | | | | | |

| | | | | | | | | | |
|---|---|---|---|---|---|---|---|---|---|
| Aqueous dispersion of | Type | C-8 | C-8 | C-8 | C-8 | C-1 | C-2 | C-3 | C-4 |
| acrylic-urethane composite | Amount | 30 | 30 | 30 | 30 | 30 | 30 | 30 | 30 |
| resin particles (C) | | | | | | | | | |
| having acid value of | | | | | | | | | |
| acrylic resin component of | | | | | | | | | |
| 20 mg KOH/g or less | | | | | | | | | |
| Polyurethane resin | “Ucoat UX-8100” (Note 6) | | | | | | | | |
| Diester compound | “Diester compound (D-1)” | | | | | | | | |
| | (Note 7) | | | | | | | | |
| Acrylic associative thickener | Acrylic associative thickener diluted | 0.4 | 0.4 | 0.4 | 0.4 | 0.4 | 0.4 | 0.4 | 0.4 |
| | solution (RC-1) | | | | | | | | |

TABLE 5

| Production Examples | | | 36 | 37 | 38 | 39 | 40 | 41 | 42 | 43 |
|---|---|---|---|---|---|---|---|---|---|---|
| Name of first water-based paint (P1) | | | P1-9 | P1-10 | P1-11 | P1-12 | P1-13 | P1-14 | P1-15 | P1-16 |
| Pigment- | Hydroxyl | Hydroxyl group-containing | 5 | 5 | 5 | 5 | 5 | 5 | 5 | 5 |
| dispersed | group-containing | acrylic resin (A-1) | | | | | | | | |
| paste | acrylic resin (A) | solution | | | | | | | | |
| | Hydroxyl | Hydroxyl group- | 5 | 5 | 5 | 5 | 5 | 5 | 20 | |
| | group-containing | containing polyester | | | | | | | | |
| | polyester resin | resin (PE-2) solution | | | | | | | | |
| | | Acrylic resin-modified | 15 | 15 | 15 | 15 | 15 | 15 | | 20 |
| | | hydroxyl group-containing | | | | | | | | |
| | | polyester resin (PE-3) | | | | | | | | |
| | | solution | | | | | | | | |
| | Coloring pigment | “JR-806” | 120 | 120 | 120 | 120 | 120 | 120 | 120 | 120 |
| | | “MA-100” | 0.3 | 0.3 | 0.3 | 0.3 | 0.3 | 0.3 | 0.3 | 0.3 |
| | Extender pigment | “MICRO ACE S-3” (Note 3) | | | | | | | | |
| Hydroxyl | Water-dispersible | Water-dispersible hydroxyl | 15 | 15 | 15 | 15 | 15 | 15 | 10 | 10 |
| group- | hydroxyl | group-containing acrylic | | | | | | | | |
| containing | group-containing | resin (A-2) aqueous dispersion | | | | | | | | |
| acrylic | acrylic resin (A1) | Water-dispersible hydroxyl | | | | | | | | |
| resin (A) | | group-containing acrylic | | | | | | | | |
| | | resin (A-3) aqueous dispersion | | | | | | | | |
| Crosslinking | Melamine resin | Melamine resin (B1-1) | 25 | 25 | 25 | 25 | 25 | 25 | 25 | 25 |
| agent (B) | (B1) | Melamine resin (B1-2) | | | | | | | | |
| | | (Note 4) | | | | | | | | |
| | | Melamine resin | | | | | | | | |
| | | (B1-3) (Note 5) | | | | | | | | |
| | Blocked | Blocked polyisocyanate | 5 | 5 | 5 | 5 | 5 | 5 | 10 | 10 |
| | polyisocyanate | compound | | | | | | | | |
| | compound | (BNCO-1) solution | | | | | | | | |

| | | | | | | | | | |
|---|---|---|---|---|---|---|---|---|---|
| Aqueous dispersion | Type | C-5 | C-6 | C-9 | C-10 | C-11 | C-12 | C-8 | C-8 |
| of acrylic-urethane | Amount | 30 | 30 | 30 | 30 | 30 | 30 | 30 | 30 |
| composite resin particles | | | | | | | | | |
| (C) having acid value of | | | | | | | | | |
| acrylic resin component | | | | | | | | | |
| of 20 mg KOH/g or less | | | | | | | | | |
| Polyurethane resin | “Ucoat UX-8100” (Note 6) | | | | | | | | |
| Diester compound | “Diester compound (D-1)” | | | | | | | | |
| | (Note 7) | | | | | | | | |
| Acrylic associative thickener | Acrylic associative thickener | 0.4 | 0.4 | 0.4 | 0.4 | 0.4 | 0.4 | 0.4 | 0.4 |
| | diluted solution (RC-1) | | | | | | | | |

TABLE 6

| Production Examples | | | 44 | 45 | 46 | 47 | 48 | 49 | 50 | 51 |
|---|---|---|---|---|---|---|---|---|---|---|
| Name of first water-based paint (P1) | | | P1-17 | P1-18 | P1-19 | P1-20 | P1-21 | P1-22 | P1-23 | P1-24 |
| Pigment- | Hydroxyl | Hydroxyl group-containing | 5 | 5 | 5 | 5 | 5 | 5 | 5 | 5 |
| dispersed paste | group-containing | acrylic resin (A-1) solution | | | | | | | | |
| | acrylic resin (A) | | | | | | | | | |
| | Hydroxyl group- | Hydroxyl group-containing | 5 | 5 | 5 | 5 | 5 | 5 | 5 | 5 |
| | containing | polyester resin | | | | | | | | |
| | polyester resin | (PE-2) solution | | | | | | | | |
| | | Acrylic resin-modified hydroxyl | 15 | 15 | 15 | 15 | 15 | 15 | 15 | 15 |
| | | group-containing polyester resin | | | | | | | | |
| | | (PE-3) solution | | | | | | | | |
| | Coloring pigment | “JR-806” | 120 | 120 | 120 | 120 | 120 | 120 | 120 | 120 |
| | | “MA-100” | 0.3 | 0.3 | 0.3 | 0.3 | 0.3 | 0.3 | 0.3 | 0.3 |
| | Extender pigment | “MICRO ACE S-3” (Note 3) | | | | 3 | | | | |
| Hydroxyl | Water-dispersible | Water-dispersible hydroxyl | 15 | 15 | 15 | 15 | 45 | 15 | 15 | 15 |
| group-containing | hydroxyl group- | group-containing acrylic resin | | | | | | | | |
| acrylic resin (A) | containing acrylic | (A-2) aqueous dispersion | | | | | | | | |
| | resin (A1) | Water-dispersible hydroxyl | | | | | | | | |
| | | group-containing acrylic resin | | | | | | | | |
| | | (A-3) aqueous dispersion | | | | | | | | |
| Crosslinking | Melamine resin (B1) | Melamine resin (B1-1) | 25 | 25 | 30 | 25 | 25 | 25 | 25 | 25 |
| agent (B) | | Melamine resin (B1-2) (Note 4) | | | | | | | | |
| | | Melamine resin (B1-3) (Note 5) | | | | | | | | |
| | Blocked polyisocyanate | Blocked polyisocyanate | 5 | 5 | 0 | 5 | 5 | 5 | 5 | 5 |
| | compound | compound (BNCO-1) solution | | | | | | | | |

| | | | | | | | | | |
|---|---|---|---|---|---|---|---|---|---|
| Aqueous dispersion of acrylic-urethane | Type | C-8 | C-8 | C-8 | C-8 | | | C-7 | C-13 |
| composite resin particles (C) having | Amount | 25 | 25 | 30 | 30 | | | 30 | 30 |
| acid value of acrylic resin component | | | | | | | | | |
| of 20 mg KOH/g or less | | | | | | | | | |
| Polyurethane resin | “Ucoat UX-8100” (Note 6) | 5 | 5 | | | | 30 | | |
| Diester compound | “Diester compound (D-1)” | | 10 | | | | | | |
| | (Note 7) | | | | | | | | |
| Acrylic associative thickener | Acrylic associative thickener | 0.4 | 0.4 | 0.4 | 0.4 | 0.4 | 0.4 | 0.4 | 0.4 |
| | diluted solution (RC-1) | | | | | | | | |

(Note 3) “MICRO ACE S-3”: (trade name, available from Nippon Talc Co., Ltd., talc powder)
(Note 4) “Melamine resin (B1-2)”: methyl-etherified melamine resin, solid content of 80%, weight average molecular weight of 650, methyl group/butyl group molar ratio of 100/0
(Note 5) “Melamine resin (B1-3)”: Methyl-butyl mixed etherified melamine resin, solid content of 75%, weight average molecular weight of 1400, methyl group/butyl group molar ratio of 30/70.
(Note 6) “UCOAT UX-8100” (trade name, available from Sanyo Chemical Industries, Ltd., urethane emulsion, solid content of 35%)
(Note 7) Diester compound (D-1): A diester compound of polyoxyethylene glycol and 2-ethylhexanoic acid was used. The diester compound (D-1) is represented by general formula (1) described above, provided that R1 and R2 are each a 2-ethylpentyl group, R3 is an ethylene group, and m is 7, and the molecular weight is 578.

### Production Example 52: Production of First Water-Based Paint (P1)

In a stirring and mixing vessel, 5.5 parts (4.2 parts in terms of solid content) of “Aluminum Paste GX-3108” (trade name, available from Asahi Kasei Metals Corporation, an aluminum pigment paste, aluminum content of 77%), 2.4 parts (1.8 parts in terms of solid content) of “Aluminum Paste GX-3100” (trade name, available from Asahi Kasei Metals Corporation, an aluminum pigment paste, aluminum content of 74%), 35 parts of 2-ethyl-1-hexanol, 3.6 parts (1.8 parts in terms of solid content) of the solution of the acrylic resin (A-4) having a hydroxyl group and a phosphate group and produced in Production Example 9, and 0.2 parts of 2-(dimethylamino) ethanol were homogeneously mixed, resulting in the formation of an effect pigment dispersion. Subsequently, 46.7 parts of the resulting effect pigment dispersion, 50 parts (15 parts in terms of resin solid content) of an aqueous dispersion of the water-dispersible hydroxyl group-containing acrylic resin (A-2) produced in Production Example 7, 9.1 parts (5 parts in terms of resin solid content) of the hydroxyl group-containing acrylic resin (A-1) solution produced in Production Example 2, 7.1 parts (5 parts in terms of resin solid content) of the hydroxyl group-containing polyester resin solution (PE-2) produced in Production Example 10, 37.5 parts (15 parts in terms of resin solid content) of an aqueous dispersion of the acrylic resin-modified hydroxyl group-containing polyester resin (PE-3) produced in Production Example 11, 34.7 parts (25 parts in terms of resin solid content) of a melamine resin (B1-1) (methyl-butyl mixed etherified melamine resin, solid content of 72%, weight average molecular weight of 750, methyl group/butyl group molar ratio of 65/35), 8.3 parts (5 parts in terms of resin solid content) of the blocked polyisocyanate compound (BNCO-1) solution produced in Production Example 12, and 80.6 parts (28.2 parts in terms of resin solid content) of an aqueous dispersion of the acrylic-urethane composite resin particles (C-8) produced in Production Example 20 were uniformly mixed. Subsequently, 6 parts (1.2 parts in terms of resin solid content) of the acrylic associative thickener diluted solution (RC-1) produced in Production Example 27, 2-(dimethylamino) ethanol, and deionized water were added to the resulting mixture, resulting in the formation of a first water-based paint (P1-25) having a pH of 8.0 and a paint solid content concentration (NV_{P1}) of 25%.

### Production Example 53: Production of First Water-Based Paint (P1)

A first water-based paint (P1-26) having a pH of 8.0 and a paint solid content concentration (NV_{P1}) of 25% was produced in the same manner as in Production Example 52 with the exception that the 80.6 parts (28.2 parts in terms of resin solid content) of the aqueous dispersion of the acrylic-urethane composite resin particles (C-8) produced in Production Example 20 and used in Production Example 52 were changed to 80.6 parts (28.2 parts in terms of resin solid content) of the acrylic-urethane composite resin particles (C-13) produced in Production Example 25. The formulation compositions of the first water-based paints (P1-25) and (P1-26) are described in Table 7 below. The blending amounts shown in the table represent solid contents except for solvent components.

TABLE 7

| | | | Production | |
|---|---|---|---|---|
| | | | Examples | |
| | | | 52 | 53 |
| Name of first water-based paint (P1) | | | P1-25 | P1-26 |
| Effect pigment | Effect pigment | “Aluminum Paste GX-3108” | 4.2 | 4.2 |
| dispersion | | “Aluminum Paste GX-3110” | 1.8 | 1.8 |
| | Hydroxyl group-containing | Acrylic resin (A-4) having a hydroxyl group | 1.8 | 1.8 |
| | acrylic resin (A) | and a phosphate group | | |
| | Organic solvent | 2-ethyl-hexanol | 35 | 35 |
| Hydroxyl group- | Water-dispersible hydroxyl | Water-dispersible hydroxyl group-containing | 15 | 15 |
| containing acrylic | group-containing | acrylic resin (A-2) aqueous dispersion | | |
| resin (A) | acrylic resin (A1) | | | |
| | | Hydroxyl group-containing acrylic resin (A-1) | 5 | 5 |
| | | solution | | |
| Crosslinking | Melamine resin (B1) | Melamine resin (B1-1) | 25 | 25 |
| agent (B) | Blocked polyisocyanate | Blocked polyisocyanate compound (BNCO-1) | 5 | 5 |
| | compound | solution | | |

| | | | |
|---|---|---|---|
| Aqueous dispersion of acrylic-urethane | Type | C-8 | C-13 |
| composite resin particles (C) | Amount | 28.2 | 28.2 |
| having acid value of acrylic resin | | | |
| component of 20 mg KOH/g or less | | | |
| Hydroxyl group-containing polyester resin | Hydroxyl group-containing polyester resin | 5 | 5 |
| | (PE-2) solution | | |
| | Acrylic resin-modified hydroxyl group- | 15 | 15 |
| | containing polyester resin (PE-3) solution | | |
| Acrylic associative thickener | Acrylic associative thickener diluted solution | 1.2 | 1.2 |
| | (RC-1) | | |

### Production Example 54: Production of Effect Pigment Dispersion

In a stirring and mixing vessel, 140 parts of “Xirallic T61-10 WNT Micro Silver” (trade name, available from Merck & Co., Inc., titanium oxide-coated aluminum oxide flake pigments) and 35 parts of ethylene glycol monobutyl ether were uniformly mixed, resulting in the formation of an effect pigment dispersion (X-4).

### Production Example 55: Production of Effect Pigment Dispersion

In a stirring and mixing vessel, 140 parts of “TWINCLEPEARL SXA-SO” (trade name, available from Nihon Koken Kogyo Co., Ltd., titanium oxide-coated mica-flake pigments) and 35 parts of ethylene glycol monobutyl ether were uniformly mixed, resulting in the formation of an effect pigment dispersion (X-5).

### Production Example 56: Production of Effect Pigment Dispersion

In a stirring and mixing vessel, 720 parts (72 parts in terms of solid content) of “Hydroshine WS-3001” (trade name, vapor-deposited aluminum flake pigment for water-based use, available from Eckart GmbH, solid content of 10%, internal solvent: isopropanol, average particle diameter D50 of 13 μm, thickness of 0.05 μm, silica-treated surface), 46.8 parts (22 parts in terms of solid content) of “Alpaste EMR-B6360” (trade name, available from Toyo Aluminum K.K., solid content of 47%, non-leafing aluminum flakes, average particle diameter D50 of 10.3 m, thickness of 0.19 m, silica-treated surface), 500 parts of isopropanol, and 500 parts of deionized water were stirred and mixed, resulting in the formation of an effect pigment dispersion (X-6).

### Production Example 57: Production of Black Pigment Dispersion

25 parts (14 parts in terms of resin solid content) of the hydroxyl group-containing acrylic resin solution (A-1) produced in Production Example 2, 7 parts of “Raven 5000 Ultra III Beads” (trade name, available from Birla Carbon U.S.A., Inc., carbon black pigment), and 68 parts of deionized water were mixed, the pH was adjusted to 7.5 using 2-(dimethylamino)ethanol, after which the mixture was dispersed with a paint shaker for 30 minutes, resulting in the formation of a black pigment dispersion (X-7).

### Production Example 58: Production of Second Water-Based Colored Paint (P2)

In a stirring and mixing vessel, 450 parts of deionized water, 500 parts (10 parts in terms of solid content) of “Aurovisco” (trade name, thickening agent, available from Oji Paper Co., Ltd., phosphate-esterified cellulose nanofibers, solid content of 2%), 15 parts of “Dynol 604” (trade name, acetylenediol-based wetting agent, available from Evonik Industries AG, solid content of 100%), 165 parts of the effect pigment dispersion (X-4) produced in Production Example 54, 2.6 parts (2.5 parts in terms of solid content) of “TINUVIN 384” (trade name, ultraviolet absorber, available from BASF SE, solid content of 95%), 2.5 parts of “TINUVIN 292” (trade name, light stabilizer, available from BASF SE, solid content of 100%), 66.7 parts (20 parts in terms of solid content) of the water-dispersible hydroxyl group-containing acrylic resin aqueous dispersion (A-3) produced in Production Example 8, 45.5 parts (25 parts in terms of solid content) of the hydroxyl group-containing acrylic resin (A-1) produced in Production Example 2, 12.5 parts (10 parts in terms of solid content) of “Cymel 325” (trade name, available from Allnex GMBH, melamine resin, solid content of 80%), 53.6 parts (15 parts in terms of solid content) of “PRIMAL ASE-60” (trade name, available from The Dow Chemical Company, polyacrylic acid-based thickener, solid content of 28%), 3500 parts of deionized water, and 2-(dimethylamino) ethanol were stirred and mixed, resulting in the formation of a second water-based colored paint (P2-1) having a pH of 8.0 and a paint solid content concentration (NV_{P2}) of 5%.

### Production Examples 59 to 64

Third water-based colored paints (P2-2) to (P2-7) were produced in the same manner as Production Example 58 with the exception that the formulation composition and paint solid content concentration (NV_{P2}) of Production Example 58 were changed as indicated in Table 8 below. Note that the blending amounts shown in the table represent solid contents except for the solvent components.

TABLE 8

| Production Examples | | | | 58 | 59 | 60 | 61 | 62 | 63 | 64 |
|---|---|---|---|---|---|---|---|---|---|---|
| Name of second water-based colored paint (P2) | | | | P2-1 | P2-2 | P2-3 | P2-4 | P2-5 | P2-6 | P2-7 |
| Deionized water | | | | 450 | 450 | 450 | 450 | 450 | 450 | 2400 |
| Thickener | Cellulose nanofibers | | “Aurovisco” | 10 | 10 | 15 | 5 | 2.5 | 20 | 30 |
| Wetting agent | | | “Dynol 604” | 15 | 15 | 15 | 15 | 15 | 15 | 15 |
| Effect | Effect | Titanium oxide-coated | “Xirallic T61-10 WNT | 140 | | 140 | 140 | 140 | 140 | |
| pigment | pigment | aluminum oxide flake pigment | Micro Silver” | | | | | | | |
| dispersion | (B_{P2}) | Titanium oxide-coated mica | “TWINCLEPEARL | | 140 | | | | | |
| | | flake pigment | SXA-SO” | | | | | | | |
| | | Vapor-deposited aluminum | “Hydroshine WS3001” | | | | | | | 72 |
| | | flake pigment | | | | | | | | |
| | | Aluminum flake pigment | “Alpaste EMR-B6360” | | | | | | | 22 |

| | Organic solvent | Ethylene glycol | 25 | 25 | 25 | 25 | 25 | 25 | |
|---|---|---|---|---|---|---|---|---|---|
| | | monobutyl ether | | | | | | | |
| | | Isopropanol | | | | | | | 500 |
| | Deionized water | | | | | | | | 500 |
| Black | Carbon black pigment | “RAVEN 5000 ULTRA | | | | | | | 2.0 |
| pigment | | III BEADS” | | | | | | | |
| dispersion | Binder component (A_{P2}) | Hydroxyl | | | | | | | 4.0 |
| | | group-containing | | | | | | | |
| | | acrylic resin (A-1) | | | | | | | |
| | Deionized water | | | | | | | | 19.4 |
| Black pigment dispersion (X-7) total | | | | | | | | | 28.7 |
| Ultraviolet absorber | | “Tinuvin 384” | 2.5 | 2.5 | 2.5 | 2.5 | 2.5 | 2.5 | 8.0 |
| Light stabilizer | | “TINUVIN 292” | 2.5 | 2.5 | 2.5 | 2.5 | 2.5 | 2.5 | 7.0 |
| Binder component (A_{P2}) | | Water-dispersible | 20 | 20 | 20 | 20 | 20 | 20 | 40 |
| | | hydroxyl | | | | | | | |
| | | group-containing | | | | | | | |
| | | acrylic resin (A-3) | | | | | | | |
| | | Hydroxyl | 25 | 25 | 25 | 25 | 25 | 25 | |
| | | group-containing | | | | | | | |
| | | acrylic resin (A-1) | | | | | | | |
| | | “CYMEL 325” | 10 | 10 | 10 | 10 | 10 | 10 | |
| Thickener | Polyacrylic acid-based thickener | “Primal ASE-60” | 15 | 15 | 15 | 15 | 15 | 20 | |

| | | |
|---|---|---|
| Organic solvent | 2-ethyl-1-hexanol | 30 |

| | | | | | | | |
|---|---|---|---|---|---|---|---|
| Deionized water | 3500 | 3500 | 10000 | 2300 | 1700 | 27000 | 300 |
| Paint solid content concentration [mass %] | 5 | 5 | 2 | 7 | 9 | 0.9 | 3 |
| Total solid content [parts by mass] of binder comp onent (A_{P2}) | 55 | 55 | 55 | 55 | 55 | 55 | 44 |
| Paint solid content [parts by mass] in second water-based colored paint (P2) | 240 | 240 | 245 | 235 | 233 | 255 | 200 |
| Total solid content [parts by mass] of effect pigment (B_{P2}) | 140 | 140 | 140 | 140 | 140 | 140 | 94 |
| Content proportion [parts by mass] of effect pigment (B_{P2}) per 100 parts | 255 | 255 | 255 | 255 | 255 | 255 | 214 |
| by mass of solid content of binder component (A_{P2}) | | | | | | | |
| Content proportion [mass %] of effect pigment (B_{P2}) based on paint solid | 58 | 58 | 57 | 60 | 60 | 55 | 47 |

content in second water-based colored paint (P2)

### Production Example 65: Production of Effect Pigment Dispersion

In a stirring and mixing vessel, 50 parts of “Xirallic T61-10 WNT Micro Silver” (trade name, available from Merck & Co., Inc., titanium oxide-coated aluminum oxide flake pigment), 35 parts of 2-ethyl-1-hexanol, and 8 parts (4 parts in terms of solid content) of the solution of the acrylic resin (A-4) having a hydroxyl group and a phosphate group and produced in Production Example 9 were homogeneously mixed, resulting in the formation of an effect pigment dispersion (X-8).

### Production Example 66: Production of Second Water-Based Colored Paint (P2)

A stirring and mixing vessel was charged with 133 parts (40 parts in terms of solid content) of the water-dispersible hydroxyl group-containing acrylic resin aqueous dispersion (A-3) produced in Production Example 8, 20 parts (11 parts in terms of solid content) of the hydroxyl group-containing acrylic resin solution (A-1) produced in Production Example 2, 21.4 parts (15 parts in terms of solid content) of the hydroxyl group-containing polyester resin solution (PE-2) produced in Production Example 10, 93 parts of the effect pigment dispersion (X-8) produced in Production Example 65, and 37.5 parts (30 parts in terms of solid content) of “Cymel 325” (trade name, available from Allnex GmbH, melamine resin, solid content of 80%), and the contents were uniformly mixed, after which 7.5 parts (1.5 parts in terms of solid content) of the acrylic associative thickener diluted solution (RC-1) produced in Production Example 27, 6.3 parts (2.0 parts in terms of solid content) of “Adeka NOL UH-756VF” (trade name, available from Adeka Corporation, urethane associative thickener, solid content of 32%), 10.7 parts (3.0 parts in terms of solid content) of “Primal ASE-60” (trade name, available from The Dow Chemical Company, polyacrylic acid-based thickener, solid content of 28%), 2-(dimethylamino) ethanol and deionized water were further added, resulting in the formation of a second water-based colored paint (P2-8) having a pH of 8.0 and a paint solid content concentration (NV_{P2}) of 12%.

### Production Examples 67 to 69

Third water-based colored paints (P2-9) to (P2-11) having a pH of 8.0 were produced in the same manner as Production Example 66 with the exception that the formulation composition and paint solid content concentration (NV_{P3}) of Production Example 66 were changed as indicated in Table 9 below. The blending amounts shown in the table represent solid contents except for solvent components.

TABLE 9

| Production Examples | | | | 66 | 67 | 68 | 69 |
|---|---|---|---|---|---|---|---|
| Name of second water-based colored paint (P2) | | | | P2-8 | P2-9 | P2-10 | P2-11 |
| Binder component | | Hydroxyl | Water-dispersible hydroxyl | 40 | 40 | 40 | 40 |
| (A_{P2}) | | group-containing | group-containing acrylic resin | | | | |
| | | acrylic resin | (A-3) aqueous dispersion | | | | |
| | | | Hydroxyl group-containing acrylic | 11 | 11 | 11 | 11 |
| | | | resin (A-1) solution | | | | |
| | | Hydroxyl | Hydroxyl group-containing | 15 | 15 | 15 | 15 |
| | | group-containing | polyester resin (PE-2) solution | | | | |
| | | polyester resin | | | | | |
| | | Melamine resin | “CYMEL 325” | 30 | 30 | 30 | 30 |
| Effect | Effect pigment | Titanium oxide-coated | “Xirallic T61-10 WNT | 50 | 50 | 50 | 50 |
| pigment | (B_{P2}) | aluminum oxide | Micro Silver” | | | | |
| dispersion | | flake pigment | | | | | |
| | Binder | Hydroxyl | Acrylic resin (A-4) having a | 4 | 4 | 4 | 4 |
| | component | group-containing | hydroxyl group and a | | | | |
| | (A_{P2}) | acrylic resin | phosphate group | | | | |
| | Organic solvent | | 2-ethyl-hexanol | 35 | 35 | 35 | 35 |
| Thickener | | Acrylic associative | Acrylic associative thickener | 1.5 | 1.5 | 1.5 | 1.5 |
| | | thickener | diluted solution (RC-1) | | | | |
| | | Urethane associative | “Adeka NOL UH-756 VF” | 2 | 2 | 2 | 2 |
| | | thickener | (Note 1) | | | | |
| | | Polyacrylic acid-based | “Primal ASE-60” (Note 2) | 3 | 2.5 | 2.25 | 1.5 |
| | | thickener | | | | | |

| | | | | |
|---|---|---|---|---|
| Paint solid content concentration (NV_{P2}) [%] | 12 | 16 | 18 | 21 |
| Content proportion [parts by mass] of effect pigment (B_{P2}) per 100 parts by mass of | 50 | 50 | 50 | 50 |
| solid content of binder component (A_{P2}) | | | | |
| Content proportion [mass %] of effect pigment (B_{P2}) based on paint solid content in | 32 | 32 | 32 | 32 |
| second water-based colored paint (P2) | | | | |

### Preparation of Test Sheet

### Example 1

A cationic electrodeposition paint (trade name: “Elecron GT-10”, available from Kansai Paint Co., Ltd.) was applied by electrodeposition onto a cold-rolled steel sheet chemically treated with zinc phosphate such that the cured film thickness was 20 μm, the coated steel sheet was heated at 170° C. for 30 minutes to cure the paint, resulting in the formation of an electrodeposited coating film. Subsequently, the water-based intermediate coating paint (PR-1) produced in Production Example 6 was electrostatically applied onto the cured electrodeposited coating film using a rotary atomizing-type electrostatic coater such that the film thickness when cured was 25 μm, after which the resulting product was left standing for six minutes. Subsequently, the first water-based paint (P1-1) produced in Production Example 28 was electrostatically applied onto the uncured intermediate coating film using the rotary atomizing-type electrostatic coater such that the film thickness when cured was 20 μm, and the resulting product was left standing for three minutes. Subsequently, the second water-based colored paint (P2-1) produced in Production Example 58 was electrostatically applied onto the uncured first coating film using the rotary atomizing-type electrostatic coater such that the film thickness when cured was 1 μm, and the resulting product was left standing for 5 minutes and then preheated at 80° C. for 3 minutes. Subsequently, “KINO-6510T” (trade name, available from Kansai Paint Co., Ltd., an acrylic resin-based organic solvent-type clear coat paint containing a hydroxyl group-containing acrylic resin and a polyisocyanate compound, hereinafter, may be referred to as a “clear coat paint (P3-1)”) was electrostatically applied onto the uncured second colored coating film such that the film thickness when cured was 35 μm, the resulting product was left standing for 7 minutes and then preheated at 140° C. for 30 minutes to thereby simultaneously cure the intermediate coating film, the first coating film, the second colored coating film, and the clear coating film, and thereby, a test sheet for evaluating image clarity, a flip-flop property, and graininess was prepared.

In the present example, the film thickness of the cured coating film of the second colored coating film was calculated from the following equation. The same applies to the following examples 2 to 30 and Comparative Examples 1 to 6.

$$x = sc / sg / S * 10000$$

x: Film thickness [μm]
sc: Solid content [g] coated by application
sg: Specific gravity [g/cm³] of the coating film
S: Evaluated surface area [cm²] of the solid content coated by application

### Examples 2 to 30 and Comparative Examples 1 to 6

Test sheets were produced in the same manner as in Example 1 with the exception that the types and cured film thicknesses of the first water-based paint, the second water-based colored paint, and the clear coat paint of Example 1 were changed as indicated in Tables 10 to 13 below.

Among these, in Comparative Examples 1 to 5, the second water-based colored paint was applied such that the cured film thickness was 1 μm, and in Comparative Example 6, the second water-based colored paint was applied such that the cured film thickness was 2 μm. In Comparative Examples 1 to 6, after application of the second water-based colored paint, dripping occurred in a part or all of the test sheet while the test sheet was left to stand for 5 minutes, and therefore the following evaluations of image clarity, the flip-flop property, and the graininess were not performed.

### Example 31

A cationic electrodeposition paint (trade name: “Elecron GT-10”, available from Kansai Paint Co., Ltd.) was applied by electrodeposition onto a cold-rolled steel sheet chemically treated with zinc phosphate such that the cured film thickness was 20 μm, the coated steel sheet was heated at 170° C. for 30 minutes to cure the paint, resulting in the formation of an electrodeposited coating film. Subsequently, the water-based intermediate coating paint (PR-1) produced in Production Example 6 was electrostatically applied onto the cured electrodeposited coating film using a rotary atomizing-type electrostatic coater such that the film thickness when cured was 25 μm, after which the resulting product was left standing for six minutes. Subsequently, the first water-based paint (P1-1) produced in Production Example 28 was electrostatically applied onto the uncured intermediate coating film using the rotary atomizing-type electrostatic coater such that the film thickness when cured was 20 μm, and the resulting product was left standing for three minutes. Subsequently, the second water-based colored paint (P2-8) produced in Production Example 66 was electrostatically applied onto the uncured first coating film using the rotary atomizing-type electrostatic coater such that the film thickness when cured was 4 μm, and the resulting product was left standing for 5 minutes and then preheated at 80° C. for 3 minutes. Subsequently, “KINO-6510T” (trade name, available from Kansai Paint Co., Ltd., an acrylic resin-based organic solvent-type clear coat paint containing a hydroxyl group-containing acrylic resin and a polyisocyanate compound) was electrostatically applied onto the uncured second colored coating film such that the film thickness when cured was 35 μm, the resulting product was left standing for 7 minutes and then preheated at 140° C. for 30 minutes to thereby simultaneously cure the intermediate coating film, the first coating film, the second colored coating film, and the clear coating film, and thereby, a test sheet for evaluating image clarity, the flip-flop property, and the graininess was prepared.

### Examples 32 and 33 and Comparative Example 7

Test sheets were produced in the same manner as in Example 31 with the exception that the types and cured film thicknesses of the first water-based paint, the second water-based colored paint, and the clear coat paint of Example 31 were changed as indicated in Table 13 below.

### Evaluation Testing

The dripping resistance, image clarity, and brightness of the test sheets produced in Examples 1 to 33 and Comparative Examples 1 to 7 described above were evaluated through the following test methods. The dripping resistance was evaluated by the following test method. The evaluation results are indicated in Tables 10 to 13 below.

### Test Methods

Water-swelling percentage of coating film formed from first water-based paint (P1): A 50 mm×90 mm coated sheet coated with the electrodeposition paint composition for an automobile body and degreased using isopropyl alcohol was weighed, and the mass thereof was denoted by a. The first water-based paint (P1) was applied by a rotary atomizing method using an automatic coating machine onto the coated sheet coated with the electrodeposition paint composition for an automobile body such that the cured coating thickness became 20 μm. The coated sheet was then set for 3 minutes in an air-conditioned booth (23° C., 68% RH) and then preheated for 1 minute at 65° C., and the mass was measured. The measured mass was denoted by b. Subsequently, the coated sheet was immersed in deionized water at 23° C. for 30 seconds. The coated sheet was then removed from the deionized water, after which the deionized water on the coated sheet was wiped off with a rag, and the mass of the coated sheet was measured and denoted by c.

The value calculated by the following equation was used as the water swelling percentage of the coating film formed from the first water-based paint (P1).

$$Water swelling percentage ( \% ) = \{ ( c - b ) / ( b - a ) \} \times 100$$

Dripping resistance: An object to be coated was produced by providing four punch holes each having a diameter of 1 cm in a single row at 2 cm intervals in a portion 3 cm from a long side end part of an 11 cm×15 cm coated sheet on which an electrodeposition paint composition for an automobile body was applied. The water-based intermediate paint (PR-1) produced in Production Example 6 was applied to the object to be coated such that when cured, the cured film thickness was 25 μm, and the coated object was allowed to stand for 6 minutes. Subsequently, each first water-based paint was applied onto the uncured intermediate coating film such that the film thickness when cured was 20 μm, and the resulting product was left standing for three minutes. Subsequently, each second water-based colored paint was applied onto the uncured first coating film such that the film thickness when cured was the film thickness described in Tables 10 to 13 below, and the resulting product was left to stand for 5 minutes, and then preheated at 80° C. for 3 minutes. Furthermore, the “KINO-6510T” (trade name, available from Kansai Paint Co., Ltd., an acrylic resin-based organic solvent-type clear coat paint containing a hydroxyl group-containing acrylic resin and a polyisocyanate compound) was applied onto the uncured second colored coating film such that the film thickness when cured was 35 μm, the coated sheet was made to stand nearly vertically for 7 minutes after application of the KINO-6510T and then preheated at 140° C. for 30 minutes to thereby cure the intermediate coating film, the first coating film, the second colored coating film, and the clear coating film, and thereby, a test sheet was prepared. The dripping resistance of each of the resulting test sheets was evaluated according to the following criteria on the basis of the longest dripping length among the dripping of the coating film from the lower ends of the four punch holes. A shorter dripping length indicates higher dripping resistance. Also, evaluations of A, B, and C were considered to be passing.
A: Dripping length less than 1 mm
B: Dripping length greater than or equal to 1 mm and less than 5 mm
C: Dripping length greater than or equal to 5 mm and less than 10 mm
D: Dripping length greater than or equal to 10 mm and less than 50 mm
E: Dripping length greater than or equal to 50 mm

Image clarity: The image clarity of each test sheet was evaluated according to the following criteria on the basis of a Short Wave (SW) value measured using the “Wave Scan” (trade name, available from BYK-Gardner GmbH). Smaller SW values indicate that the coating film surface has higher image clarity. Also, evaluations of A, B, and C were considered to be passing.
A: SW value less than 15
B: SW value greater than or equal to 15 and less than 18
C: SW value greater than or equal to 18 and less than 20
D: SW value greater than or equal to 20 and less than 25
E: SW value greater than or equal to 25

Flip-flop property: The brightness of each test sheet was evaluated according to the following criteria on the basis of a flip-flop value calculated by the following equation from a Y-value (5°) and Y-value (25°) measured using the “3D Gonio-Spectrophotometric Color Measurement System GCMS-4” (trade name, available from Murakami Color Research Laboratory Co., Ltd.). Larger flip-flop values indicate a higher brightness of the coating surface. Also, evaluations of A, B, and C were considered to be passing.

Flip-flop value=Y-value (5°)/Y-value (25°)

Here, the Y-value (5°) described above indicates a Y-value in the XYZ color system based on spectral reflectance measured using the “3D Gonio-Spectrophotometric Color Measurement System GCMS-4” (trade name, available from Murakami Color Research Laboratory Co., Ltd.) with regard to light received at an angle of 5° in a direction of measurement light from the specular reflection angle when the measurement light is irradiated onto a surface to be measured from an angle of 450 in relation to an axis perpendicular to the surface to be measured. In other words, the light received at an angle of 5° from the specular reflection angle in the direction of the measurement light can be described as light received at an angle shifted by 5° to a side closer to the measurement light in relation to the specular reflection angle.

In addition, the Y-value (25°) indicates a Y-value in the XYZ color system based on spectral reflectance measured using the “3D Gonio-Spectrophotometric Color Measurement System GCMS-4” (trade name, available from Murakami Color Research Laboratory Co., Ltd.) with regard to light received at an angle of 250 in the direction of measurement light from the specular reflection angle when the measurement light is irradiated onto a surface to be measured from an angle of 450 in relation to an axis perpendicular to the surface to be measured. In other words, the light received at an angle of 250 from the specular reflection angle in the direction of the measurement light can be described as light received at an angle shifted by 250 to a side closer to the measurement light in relation to the specular reflection angle.
A: Flip-flop value greater than or equal to 3.75
B: Flip-flop value greater than or equal to 3.25 and less than 3.75
C: Flip-flop value greater than or equal to 2.75 and less than 3.25
C: Flip-flop value greater than or equal to 2.25 and less than 2.75
E: Flip-flop value less than 2.25

Graininess: The brightness of each test sheet was evaluated according to the following criteria on the basis of an HG value. The term HG value is an abbreviation for a Hi-light Graininess value. The HG value is one of the measures of micro-brightness in a case in which the coating film surface is microscopically observed, and is an index indicating the graininess in high light. The HG value is calculated in the following manner. First, the coating film surface is photographed with a CCD camera at a light incidence angle of 15 degrees and a light receiving angle of 0 degrees, and the resulting digital image data (two dimensional luminance distribution data) is subjected to two dimensional Fourier transform processing to produce a power spectrum image. Subsequently, a measurement parameter obtained by extracting only the spatial frequency area corresponding to the graininess from the power spectrum image is converted so as to further take on a numerical value from 0 to 100 and maintain a linear relationship with the graininess, and the converted value thereof is used as the HG value. The HG value is set to 0 when there is no graininess of the effect pigment, and is set to 100 when the graininess of the effect pigment is the largest.

A smaller HG value indicates a higher level of brightness of the coating surface. Also, evaluations of A, B, and C were considered to be passing.
A: Less than or equal to 41
B: Greater than 41 and less than or equal to 43
C: Greater than 43 and less than or equal to 45
D: Greater than 45 and less than or equal to 47
E: Greater than 47

TABLE 10

| | | | Examples | | | | | | | | | |
|---|---|---|---|---|---|---|---|---|---|---|---|---|
| | | | 1 | 2 | 3 | 4 | 5 | 6 | 7 | 8 | 9 | 10 |
| Name of water-based intermediate coating paint | | | PR-1 | PR-1 | PR-1 | PR-1 | PR-1 | PR-1 | PR-1 | PR-1 | PR-1 | PR-1 |
| Cured film thickness [μm] | | | 25 | 25 | 25 | 25 | 25 | 25 | 25 | 25 | 25 | 25 |
| Step (1) | First water-based | Paint name | P1-1 | P1-2 | P1-3 | P1-4 | P1-5 | P1-6 | P1-7 | P1-8 | P1-9 | P1-10 |
| | paint (P1) | Paint solid content | 50 | 50 | 50 | 50 | 50 | 50 | 50 | 50 | 50 | 50 |
| | | concentration | | | | | | | | | | |
| | | (NV_{P1}) | | | | | | | | | | |
| | | [mass %] | | | | | | | | | | |
| | Cured film thickness (T_{P1}) [μm] | | 20 | 20 | 20 | 20 | 20 | 20 | 20 | 20 | 20 | 20 |
| Step (2) | Second water-based | Paint name | P2-1 | P2-1 | P2-1 | P2-1 | P2-1 | P2-1 | P2-1 | P2-1 | P2-1 | P2-1 |
| | colored paint (P2) | Paint solid content | 5 | 5 | 5 | 5 | 5 | 5 | 5 | 5 | 5 | 5 |
| | | concentration | | | | | | | | | | |
| | | (NV_{P2}) | | | | | | | | | | |
| | | [mass %] | | | | | | | | | | |
| | Cured film thickness (T_{P2}) [μm] | | 1.0 | 1.0 | 1.0 | 1.0 | 1.0 | 1.0 | 1.0 | 1.0 | 1.0 | 1.0 |
| Step (3) | Clear coat paint (P3) | Paint name | P3-1 | P3-1 | P3-1 | P3-1 | P3-1 | P3-1 | P3-1 | P3-1 | P3-1 | P3-1 |
| | Cured film thickness [μm] | | 35 | 35 | 35 | 35 | 35 | 35 | 35 | 35 | 35 | 35 |
| Step (4) | Heating temperature [° C.] | | 140 | 140 | 140 | 140 | 140 | 140 | 140 | 140 | 140 | 140 |
| | Heating time [min] | | 30 | 30 | 30 | 30 | 30 | 30 | 30 | 30 | 30 | 30 |
| Evaluation | Water swelling percentage [%] at 20 μm | | 61 | 89 | 82 | 65 | 62 | 76 | 83 | 60 | 55 | 70 |
| | cured film thickness of coating film | | | | | | | | | | | |
| | formed from first water-based paint (P1) | | | | | | | | | | | |
| | Dripping resistance | | A | B | C | A | A | B | B | A | A | B |
| | Image clarity | | A | B | A | C | A | B | B | A | C | B |
| | Brightness | Flip-flop property | A | A | A | A | A | A | A | A | A | A |
| | | Graininess | A | A | A | A | A | A | A | A | A | A |

TABLE 11

| | | | Examples | | | | | | | | | |
|---|---|---|---|---|---|---|---|---|---|---|---|---|
| | | | 11 | 12 | 13 | 14 | 15 | 16 | 17 | 18 | 19 | 20 |
| Name of water-based intermediate coating paint | | | PR-1 | PR-1 | PR-1 | PR-1 | PR-1 | PR-1 | PR-1 | PR-1 | PR-1 | PR-1 |
| Cured film thickness [μm] | | | 25 | 25 | 25 | 25 | 25 | 25 | 25 | 25 | 25 | 25 |
| Step (1) | First water-based | Paint name | P1-11 | P1-12 | P1-13 | P1-14 | P1-15 | P1-16 | P1-17 | P1-18 | P1-19 | P1-20 |
| | paint (P1) | Paint solid content | 50 | 50 | 50 | 50 | 50 | 50 | 50 | 50 | 50 | 50 |
| | | concentration | | | | | | | | | | |
| | | (NV_{P1}) | | | | | | | | | | |
| | | [mass %] | | | | | | | | | | |
| | Cured film thickness (T_{P1}) [μm] | | 20 | 20 | 20 | 20 | 20 | 20 | 20 | 20 | 20 | 20 |
| Step (2) | Second water-based | Paint name | P2-1 | P2-1 | P2-1 | P2-1 | P2-1 | P2-1 | P2-1 | P2-1 | P2-1 | P2-1 |
| | colored paint (P2) | Paint solid content | 5 | 5 | 5 | 5 | 5 | 5 | 5 | 5 | 5 | 5 |
| | | concentration | | | | | | | | | | |
| | | (NV_{P2}) | | | | | | | | | | |
| | | [mass %] | | | | | | | | | | |
| | Cured film thickness (T_{P2}) [μm] | | 1.0 | 1.0 | 1.0 | 1.0 | 1.0 | 1.0 | 1.0 | 1.0 | 1.0 | 1.0 |
| Step (3) | Clear coat paint (P3) | Paint name | P3-1 | P3-1 | P3-1 | P3-1 | P3-1 | P3-1 | P3-1 | P3-1 | P3-1 | P3-1 |
| | Cured film thickness [μm] | | 35 | 35 | 35 | 35 | 35 | 35 | 35 | 35 | 35 | 35 |
| Step (4) | Heating temperature [° C.] | | 140 | 140 | 140 | 140 | 140 | 140 | 140 | 140 | 140 | 140 |
| | Heating time [min] | | 30 | 30 | 30 | 30 | 30 | 30 | 30 | 30 | 30 | 30 |
| Evaluation | Water swelling percentage [%] at 20 μm | | 54 | 58 | 69 | 81 | 77 | 65 | 62 | 63 | 71 | 68 |
| | cured film thickness of coating film | | | | | | | | | | | |
| | formed from first water-based paint (P1) | | | | | | | | | | | |
| | Dripping resistance | | A | A | A | B | C | A | A | A | B | B |
| | Image clarity | | B | A | A | B | B | A | A | A | B | B |
| | Brightness | Flip-flop property | A | A | A | A | A | A | A | A | A | A |
| | | Graininess | A | A | A | A | A | A | A | A | A | A |

TABLE 12

| | | | Examples | | | | | | | | | |
|---|---|---|---|---|---|---|---|---|---|---|---|---|
| | | | 21 | 22 | 23 | 24 | 25 | 26 | 27 | 28 | 29 | 30 |
| Name of water-based intermediate coating paint | | | PR-1 | PR-1 | PR-1 | PR-1 | PR-1 | PR-1 | PR-1 | PR-1 | PR-1 | PR-1 |
| Cured film thickness [μm] | | | 30 | 25 | 25 | 25 | 25 | 25 | 25 | 25 | 25 | 25 |
| Step (1) | First water-based | Paint name | P1-1 | P1-1 | P1-1 | P1-1 | P1-1 | P1-1 | P1-1 | P1-1 | P1-25 | P1-1 |
| | paint (P1) | Paint solid content | 50 | 50 | 50 | 50 | 50 | 50 | 50 | 50 | 25 | 50 |
| | | concentration | | | | | | | | | | |
| | | (NV_{P1}) | | | | | | | | | | |
| | | [mass %] | | | | | | | | | | |
| | Cured film thickness (T_{P1}) [μm] | | 20 | 7 | 14 | 17 | 20 | 20 | 20 | 20 | 20 | 20 |
| Step (2) | Second water-based | Paint name | P2-1 | P2-1 | P2-1 | P2-1 | P2-2 | P2-3 | P2-4 | P2-5 | P2-7 | P3-1 |
| | colored paint (P2) | Paint solid content | 5 | 5 | 5 | 5 | 5 | 2 | 7 | 9 | 3 | 5 |
| | | concentration | | | | | | | | | | |
| | | (NV_{P2}) | | | | | | | | | | |
| | | [mass %] | | | | | | | | | | |
| | Cured film thickness (T_{P2}) [μm] | | 1.0 | 1.0 | 1.0 | 1.0 | 1.0 | 1.0 | 1.0 | 1.5 | 2.0 | 1.0 |
| Step (3) | Clear coat paint (P3) | Paint name | P3-1 | P3-1 | P3-1 | P3-1 | P3-1 | P3-1 | P3-1 | P3-1 | P3-1 | P3-2 |
| | | | | | | | | | | | | (Note 8) |
| | Cured film thickness [μm] | | 35 | 35 | 35 | 35 | 35 | 35 | 35 | 35 | 35 | 35 |
| Step (4) | Heating temperature [° C.] | | 140 | 140 | 140 | 140 | 140 | 140 | 140 | 140 | 140 | 140 |
| | Heating time [min] | | 30 | 30 | 30 | 30 | 30 | 30 | 30 | 30 | 30 | 30 |
| Evaluation | Water swelling percentage [%] at 20 μm | | 61 | 61 | 61 | 61 | 61 | 61 | 61 | 61 | 61 | 61 |
| | cured film thickness of coating film | | | | | | | | | | | |
| | formed from first water-based paint (P1) | | | | | | | | | | | |
| | Dripping resistance | | B | A | A | A | A | C | A | A | A | A |
| | Image clarity | | B | B | A | A | A | B | A | A | A | A |
| | Brightness | Flip-flop property | A | A | A | A | A | B | A | B | A | A |
| | | Graininess | A | A | A | A | A | A | A | A | A | A |

TABLE 13

| | | | Examples | | | Comparative Examples | | | | | | |
|---|---|---|---|---|---|---|---|---|---|---|---|---|
| | | | 31 | 32 | 33 | 1 | 2 | 3 | 4 | 5 | 6 | 7 |
| Name of water-based intermediate | | | PR-1 | PR-1 | PR-1 | PR-1 | PR-1 | PR-1 | PR-1 | PR-1 | PR-1 | PR-1 |
| coating paint | | | | | | | | | | | | |
| Cured film thickness [μm] | | | 25 | 25 | 25 | 25 | 25 | 25 | 25 | 25 | 25 | 25 |
| Step (1) | First water- | Paint name | P1-1 | P1-1 | P1-1 | P1-21 | P1-22 | P1-23 | P1-24 | P1-1 | P1-26 | P1-1 |
| | based paint | concentration | 50 | 50 | 50 | 50 | 50 | 50 | 50 | 50 | 25 | 50 |
| | (P1) | (NV_{P1}) | | | | | | | | | | |
| | | Paint solid | | | | | | | | | | |
| | | content | | | | | | | | | | |
| | | [mass %] | | | | | | | | | | |
| | Cured film thickness | | 20 | 20 | 20 | 20 | 20 | 20 | 20 | 20 | 20 | 20 |
| | (T_{P1}) [μm] | | | | | | | | | | | |
| Step (2) | Second water- | Paint name | P2-8 | P2-9 | P2-10 | P2-1 | P2-1 | P2-1 | P2-1 | P2-6 | P2-7 | P2-11 |
| | based colored | Paint solid | 12 | 16 | 18 | 5 | 5 | 5 | 5 | 0.9 | 3 | 21 |
| | paint (P2) | content | | | | | | | | | | |
| | | concentration | | | | | | | | | | |
| | | (NV_{P2}) | | | | | | | | | | |
| | | [mass %] | | | | | | | | | | |
| | Cured film thickness | | 4.0 | 4.0 | 6.0 | Not | Not | Not | Not | Not due | Not | 6.0 |
| | (T_{P2}) [μm] | | | | | evaluable | evaluable | evaluable | evaluable | evaluable | evaluable | |
| | | | | | | due to | due to | due to | due to | to | due to | |
| | | | | | | dripping | dripping | dripping | dripping | dripping | dripping | |
| Step (3) | Clear coat | Paint name | P3-1 | P3-1 | P3-1 | P3-1 | P3-1 | P3-1 | P3-1 | P3-1 | P3-1 | P3-1 |
| | paint (P3) | | | | | | | | | | | |
| | Cured film thickness [μm] | | 35 | 35 | 35 | 35 | 35 | 35 | 35 | 35 | 35 | 35 |
| Step (4) | Heating temperature [° C.] | | 140 | 140 | 140 | 140 | 140 | 140 | 140 | 140 | 140 | 140 |
| | Heating time [min] | | 30 | 30 | 30 | 30 | 30 | 30 | 30 | 30 | 30 | 30 |
| Evaluation | Water swelling percentage | | 61 | 61 | 61 | 122 | 135 | 215 | 208 | 61 | 208 | 61 |
| | [%] at 20 μm cured film | | | | | | | | | | | |
| | thickness of coating film | | | | | | | | | | | |
| | formed from first water- | | | | | | | | | | | |
| | based paint (P1) | | | | | | | | | | | |
| | Dripping | | A | A | A | E | E | E | E | D | E | A |
| | resistance | | | | | | | | | | | |
| | Image clarity | | A | A | A | Not | Not | Not | Not | Not | Not | A |
| | Brightness | Flip-flop | C | C | C | evaluable | evaluable | evaluable | evaluable | evaluable | evaluable | D |
| | | property | | | | due to | due to | due to | due to | due to | due to | |
| | | Graininess | B | B | C | dripping | dripping | dripping | dripping | dripping | dripping | C |

(Note 8) “Magicron KINO-1210TW”: trade name, available from Kansai Paint Co., Ltd., an acrylic resin-based organic solvent-type clear coat paint containing a carboxyl group-containing resin and an epoxy group-containing resin, hereinafter, may be referred to as the “clear coat paint (P3-2)”.

1. A method for forming a multilayer coating film, the method comprising:
(1) applying a first water-based paint (P1) onto an object to be coated to form a first coating film having a cured film thickness (T_{P1}) in a range from 5 to 20 μm;
(2) applying a second water-based colored paint (P2) onto the first coating film formed in (1) to form a second colored coating film having a cured film thickness (T_{P2}) in a range from 0.5 to 7 μm, the second water-based colored paint (P2) comprising a binder component (A_{P2}) and an effect pigment (B_{P2}) and having a paint solid content concentration (NV_{P2}) in a range greater than or equal to 1 mass % and less than 20 mass %;
(3) applying a clear coat paint (P3) onto the second colored coating film formed in (2) to form a clear coating film; and
(4) heating a multilayer coating film including the first coating film formed in (1), the second colored coating film formed in (2), and the clear coating film formed in (3), and thereby simultaneously curing the multilayer coating film,
wherein a water swelling percentage at a cured film thickness of 20 μm of a coating film formed from the first water-based paint (P1) is less than or equal to 100%.

2. The method for forming the multilayer coating film according to claim 1, wherein the object to be coated is a steel sheet on which a cured electrodeposited coating film is formed, on which an intermediate coating paint is applied to form an intermediate coating film.

3. The method for forming the multilayer coating film according to claim 2, wherein the intermediate coating paint is a water-based paint.

4. The method for forming the multilayer coating film according to claim 2, wherein a cured film thickness of the intermediate coating paint is in a range from 10 to 40 μm.

5. The method for forming the multilayer coating film according claim 1, wherein the first water-based paint (P1) comprises a hydroxyl group-containing acrylic resin (A), a crosslinking agent (B), and acrylic-urethane composite resin particles (C).

6. The method for forming the multilayer coating film according to claim 5, wherein the hydroxyl group-containing acrylic resin (A) contains a water-dispersible hydroxyl group-containing acrylic resin (A1).

7. The method for forming the multilayer coating film according to claim 6, wherein the water-dispersible hydroxyl group-containing acrylic resin (A1) contains a water-dispersible hydroxyl group-containing acrylic resin (A1′) having an acid value less than or equal to 20 mg KOH/g.

8. The method for forming the multilayer coating film according to claim 5, wherein an acrylic resin component of the acrylic-urethane composite resin particles (C) has an acid value less than or equal to 20 mg KOH/g.

9. The method for forming the multilayer coating film according to claim 5, wherein a polyisocyanate compound component contained in a urethane resin component of the acrylic-urethane composite resin particles (C) comprises, as at least one type of the polyisocyanate compound component, an aliphatic polyisocyanate compound (c1-1).

10. The method for forming the multilayer coating film according to claim 5, wherein a monomer component contained in an acrylic resin component of the acrylic-urethane composite resin particles (C) comprises, as at least one type of the monomer component, a polymerizable unsaturated monomer (c2-1) having one polymerizable unsaturated group per molecule and an alkyl group having from 4 to 22 carbons.

11. The method for forming the multilayer coating film according to claim 5, wherein a monomer component contained in an acrylic resin component of the acrylic-urethane composite resin particles (C) comprises, as at least one type of the monomer component, a polymerizable unsaturated monomer (c2-2) having two or more polymerizable unsaturated groups per molecule.

12. The method for forming the multilayer coating film according to claim 1, wherein a content proportion of the binder component (A_{P2}) and the effect pigment (B_{P2}) in the second water-based colored paint (P2) is such that a content of the effect pigment (B_{P2}) is in a range from 5 to 550 parts by mass per 100 parts by mass of a solid content of the binder component (A_{P2}).

13. The method for forming the multilayer coating film according to claim 1, wherein a content proportion of the effect pigment (B_{P2}) in the second water-based colored paint (P2) is in a range from 4 to 85 mass % based on a paint solid content in the second water-based colored paint (P2).
